(19) United States
(12) Patent Application Publication
(10) Pub. No.: US 2026/0234415 A1
(43) Pub. Date: Aug. 13, 2026

(54) COMPOSITION, SURFACE TREATMENT AGENT, ARTICLE, AND METHOD FOR PRODUCING ARTICLE

(71) Applicant: AGC Inc., Tokyo (JP)

(72) Inventors: Motoshi AOYAMA, Tokyo (JP); Toyokazu ENTA, Tokyo (JP)

(73) Assignee: AGC Inc., Tokyo (JP)

(21) Appl. No.: 19/638,205

(22) Filed: Apr. 3, 2026

Related U.S. Application Data
(63) Continuation of application No. PCT/JP2024/035858, filed on Oct. 7, 2024.

(30) Foreign Application Priority Data
Oct. 6, 2023 (JP) 2023-174761

(51) Int. Cl. C09D 5/16; C08G 77/54; C09D 183/14

(52) U.S. Cl. CPC C09D 5/1675; C08G 77/54; C09D 183/14

(57) ABSTRACT

Provided are a composition and a surface treatment agent containing: a compound having a chain group and a reactive silyl group; and a metal atom, in which the amount of the metal atom is from 10 to 10,000 ppm by mass with respect to the amount of the compound having a chain group and a reactive silyl group; and an article having a surface treatment layer formed using the surface treatment agent and a method for producing the article.

### CROSS-REFERENCE TO RELATED APPLICATIONS

This application is a continuation of International Application No. PCT/JP2024/035858, filed on Oct. 7, 2024, which claims priority from Japanese Patent Application No. 2023-174761, filed on Oct. 6, 2023. The entire disclosure of each of the above applications is incorporated herein by reference.

### BACKGROUND

### Technical Field

The present disclosure relates to a composition, a surface treatment agent, an article, and a method for producing the article.

### Background Art

In recent years, in order to improve performance such as appearance and visibility, there has been a demand for technology that makes fingerprints less likely to adhere to the surface of an article, and technology that facilitates removal of dirt. As a specific method, a method of performing surface treatment on the surface of an article using a surface treatment agent is known.

For example, Patent Literature 1 describes the use of a siloxane group-containing silane compound having a specific structure as a surface treatment agent.

### PATENT LITERATURE

[Patent Literature 1] International Publication No. 2023/017830

### SUMMARY OF INVENTION

### Technical Problem

In a surface treatment layer formed by a surface treatment agent, excellent appearance and abrasion resistance are desired. In view of such circumstances, an embodiment of the present disclosure relates to providing a composition and a surface treatment agent capable of forming a surface treatment layer excellent in appearance and abrasion resistance, as well as an article having a surface treatment layer excellent in appearance and abrasion resistance and a method for producing the same.

### Solution to Problem

Means for solving the foregoing problem include the following aspects.

<1> A composition, containing:
a compound having a chain group and a reactive silyl group; and
a metal atom,
wherein an amount of the metal atom is from 10 to 10,000 ppm by mass with respect to an amount of the compound having a chain group and a reactive silyl group.

<2> The composition according to <1>, wherein the compound having a chain group and a reactive silyl group is a compound having a chain organo(poly)siloxane residue and a reactive silyl group.

<3> The composition according to <1> or <2>, containing two or more kinds of the metal atom.

<4> The composition according to any one of <1> to <3>, wherein the metal atom includes Pt and a metal atom other than Pt.

<5> The composition according to any one of <1> to <4>, wherein the metal atom includes a transition metal.

<6> The composition according to any one of <1> to <5>, wherein the metal atom includes at least one selected from the group consisting of Al, Ti, V, Cr, Mn, Fe, Co, Ni, Zr, Nb, Mo, Ru, Rh, Pd, Sn, Hf, Ta, W, Ir, Pt, Zn, and Cu.

<7> The composition according to any one of <1> to <6>, wherein the metal atom includes at least one selected from the group consisting of Ti, Cr, Mn, Fe, Co, Ni, Zr, Ru, Rh, Pd, Ir, Pt, Zn, and Cu.

The composition according to any one of <1> to <7>, wherein the reactive silyl group is represented by the following formula (S1) or (S3):

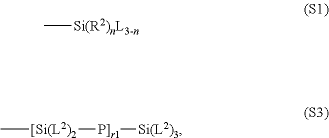

wherein, in formula (S1),
each R² independently represents a hydrocarbon group,
each L independently represents a hydrolyzable group, a group having a hydrolyzable group, or a hydroxy group, and
n represents an integer from 0 to 2; and
wherein, in formula (S3),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
r1 represents an integer from 1 to 3.

<9> The composition according to <2>, or any one of <3> to <8> that depend from <2>, wherein the chain organo(poly)siloxane residue is represented by the following formula (B1) or (B2):

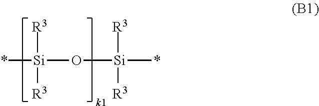

wherein, in formula (B1),
each R³ independently represents a hydrocarbon group,
k1 represents a number that is 1 or higher,
* indicates a bonding site with an adjacent atom:

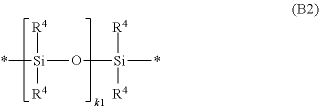

wherein, in formula (B2),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher, and
* indicates a bonding site with an adjacent atom.

<10> The composition according to <9>, wherein k1 in formulae (B1) and (B2) represents an integer from 1 to 600.

<11> The composition according to <1> or any one of <3> to <8>, wherein the compound having a chain group and a reactive silyl group is represented by the following formula (C), (C2), (D), (D2), (E), or (E2):

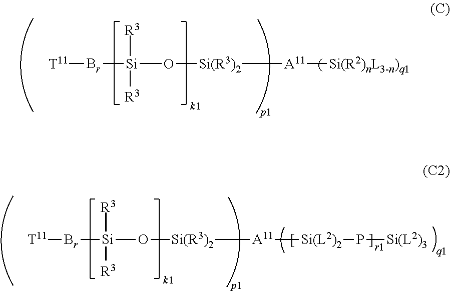

wherein, in formula (C),
T¹¹ represents a monovalent group free of a reactive silyl group,
each B independently represents —O— or —C(═O)—,
each r independently represents 0 or 1,
each R³ independently represents a hydrocarbon group,
each k1 independently represents a number that is 1 or higher,
p1 represents an integer that is 1 or higher,
A¹¹ represents a (p1+q1)-valent linking group,
q1 represents an integer that is I or higher,
each R² independently represents a hydrocarbon group,
each L independently represents a hydrolyzable group, a group having a hydrolyzable group, or a hydroxy group, and
each n independently represents an integer from 0 to 2; and wherein, in formula (C2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
r1 represents an integer from 1 to 3,
T¹¹, B, r, R³, k1, p1, A¹¹, and q1 are as defined in formula (C):

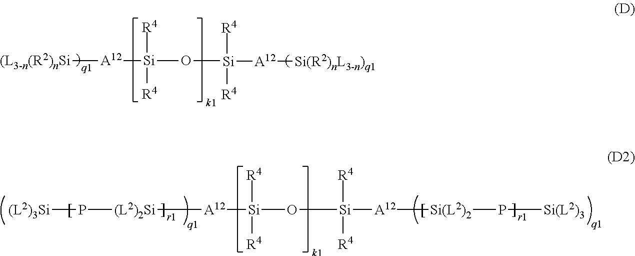

wherein, in formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher,
each A¹² independently represents a (q1+1)-valent linking group,
each q1 independently represents an integer that is 1 or higher,
each R² independently represents a hydrocarbon group,
each L independently represents a hydrolyzable group, a group having a hydrolyzable group, or a hydroxy group, and
each n independently represents an integer from 0 to 2; and
wherein, in formula (D2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
each r1 independently represents an integer from 1 to 3, and
R⁴, k1, A¹², and q1 are as defined in formula (D):

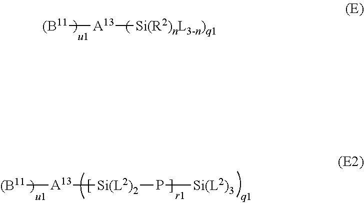

wherein, in formula (E),
B11 represents a monovalent group having at least one selected from the group consisting of Si, Ge, and Sn to which a hydroxy group or a hydrolyzable group is not directly bonded, or a monovalent group having a branched alkyl group,
u1 represents an integer that is 1 or higher,
A¹³ represents a (q1+u1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2; and
wherein, in formula (E2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
each r1 independently represents an integer from 1 to 3, and
B¹¹, u1, A¹³, and q1 are as defined in formula (E).

<12> The composition according to <11>, wherein:
q1 in formulae (C), (C2), (E), and (E2) represents an integer from 1 to 4, and
each q1 in formulae (D) and (D2) independently represents an integer from 1 to 4.

<13> The composition of any one of <1> to <12>, further containing a liquid medium.

<14> A surface treatment agent, consisting of the composition according to any one of <1> to <13>.

<15> A method for producing an article, the method including: subjecting a substrate to surface treatment using the surface treatment agent according to <14>, to manufacture an article having the substrate and a surface treatment layer formed thereon.

<16> An article, including: a substrate; and a surface treatment layer disposed on the substrate and having been surface-treated using the surface treatment agent according to <14>.

<17> The article of <16>, wherein the article is an optical component.

<18> The article according to <16> or <17>, wherein the article is a display or a touch panel.

### Advantageous Effects of Invention

According to an embodiment of the present disclosure, a composition and a surface treatment agent capable of forming a surface treatment layer excellent in appearance and abrasion resistance, as well as an article having a surface treatment layer excellent in appearance and abrasion resistance and a method for producing the same are provided.

### DESCRIPTION OF EMBODIMENTS

Hereinafter, aspects for carrying out the embodiments of the present disclosure will be described in detail. The embodiments of the present disclosure are however not limited to the following embodiments. In the following embodiments, the components (including element steps and the like) are not essential unless otherwise specified. The same applies to numerical values and ranges thereof, and the numerical values and ranges do not limit the embodiments of the present disclosure.

In the present disclosure, the term “step” encompasses not only a step independent from any other step, but also a step that cannot be clearly distinguished from any other step, as long as the intended purpose of the step is achieved.

In the present disclosure, each numerical range indicated using “to” includes numerical values described before and after “to”, as a minimum value and a maximum value, respectively.

With respect to the numerical ranges described stepwise in the present disclosure, the upper limit value or the lower limit value described in one numerical range may be replaced with the upper limit value or the lower limit value of another numerical range described stepwise. With respect to the numerical ranges described in the present disclosure, the upper limit value or the lower limit value of such numerical ranges may be replaced with values described in the Examples.

In the present disclosure, each component may contain multiple corresponding substances. In a case in which multiple substances that correspond to each component are present in the composition, the content or the amount of each component means the total content or the total amount of such multiple substances present in the composition, unless otherwise specified.

In the present disclosure, the “surface treatment layer” means a layer formed by surface treatment on a surface of a substrate.

In the present disclosure, when a compound or a group is represented by a specific formula (X), the compound or group represented by the formula (X) may be referred to as Compound (X) or Compound X, and Group (X) or Group X, respectively.

In the present disclosure, an organo(poly)siloxane residue means an organosiloxane residue or an organopolysiloxane residue.

In the present disclosure, “Me” may mean a methyl group, and “Et” may mean an ethyl group.

### [Composition]

The composition of the present disclosure contains: a compound having a chain group and a reactive silyl group; and a metal atom, wherein the amount of the metal atom is from 10 to 10,000 ppm by mass with respect to the amount of the compound having a chain organo(poly)siloxane residue and a reactive silyl group.

In an aspect, the composition according to the present disclosure contains a compound having a chain organo(poly)siloxane residue and a reactive silyl group, and a metal atom, wherein the amount of the metal atom is from 10 to 10,000 ppm by mass with respect to the amount of the compound having the chain organo(poly)siloxane residue and the reactive silyl group.

Hereinafter, the compound having a chain group and a reactive silyl group is also referred to as a “specific silane compound,” and among these, the compound having a chain organo(poly)siloxane residue and a reactive silyl group is also referred to as a “specific silane compound A.” In the present disclosure, the description regarding the specific silane compound also applies to a case in which the “specific silane compound” is replaced with the “specific silane compound A” as long as no contradiction arises.

The composition according to the present disclosure can form a surface treatment layer excellent in appearance and abrasion resistance when applied to a substrate as a surface treatment agent. Although the reason for this is not entirely clear, it is believed that, by the composition containing the specific silane compound being mixed with a specific amount of a metal atom, hydrolyzability of the surface of the substrate is facilitated, whereby the effect of abrasion resistance by the specific silane compound can be particularly favorably exhibited. Further, it is believed that this effect can be exhibited without impairing the appearance when the amount of the metal atom with respect to the specific silane compound is from 10 to 10,000 ppm by mass. The “amount of the metal atom” in the composition according to the present disclosure represents the total amount of metal atoms contained in the composition.

Hereinafter, each component contained in the composition will be described in detail.

### <Specific Silane Compound>

The specific silane compound has a chain group and a reactive silyl group. The specific silane compound A has a chain organo(poly)siloxane residue and a reactive silyl group. The composition according to the present disclosure may contain only one kind of the specific silane compound, or two or more kinds thereof.

### (Chain Group)

The specific silane compound contains a chain group. The chain group may be linear without any branches or may be branched. The specific silane compound may or may not have any other structure, such as a cyclic structure, as long as a chain group is contained.

The chain group is not particularly limited as long as it has a chain structure in which two or more atoms are linked, and examples thereof include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal or between carbon atoms in a chain hydrocarbon group; and combinations thereof. R^{d} represents a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group, and more preferably an alkylene group having the aforementioned number of carbon atoms. From the viewpoint of forming a surface treatment layer having excellent acid resistance, hot water resistance, friction resistance, and the like, the chain hydrocarbon group is preferably an alkylene group having 13 or more carbon atoms.

The same applies to the number of carbon atoms in the group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group, at a terminal or between carbon atoms in a chain hydrocarbon group. R^{d} represents a hydrogen atom or an alkyl group (preferably having from 1 to 10 carbon atoms).

In an aspect, the chain group is preferably a chain organo(poly)siloxane residue. Hereinafter, the chain organo(poly)siloxane residue will be described in detail.

### (Chain Organo (Poly) Siloxane Residue)

The specific silane compound may contain one, or two or more chain organo(poly)siloxane residues. When the specific silane compound contains two or more chain organo(poly)siloxane residues, the two or more chain organo(poly)siloxane residues may be the same or different.

Examples of the chain organo(poly)siloxane residue include a chain organo(poly)siloxane residue represented by the following formula (B1) or (B2).

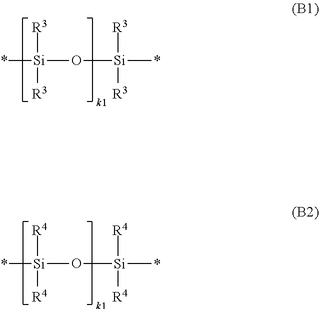

In formula (B1),
each R³ independently represents a hydrocarbon group,
k1 represents a number that is 1 or higher, and
indicates a bonding site with an adjacent atom.

In formula (B2),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher, and
* indicates a bonding site with an adjacent atom.

In formulae (B1) and (B2), examples of the hydrocarbon group represented by R³ include an aliphatic hydrocarbon group and an aromatic hydrocarbon group. In particular, the hydrocarbon group is preferably an aliphatic hydrocarbon group, and more preferably an alkyl group. The alkyl group may be any of a linear alkyl group, a branched alkyl group, or a cyclic alkyl group. A linear alkyl group is preferred; a methyl group, an ethyl group, an n-propyl group, or an n-butyl group is more preferred; and a methyl group is still more preferred. The aromatic hydrocarbon group is preferably a phenyl group.

In formulae (B1) and (B2), k1 is a number that is 1 or higher, preferably a number from 1 to 600, more preferably a number from 1 to 500, still more preferably a number from 3 to 500, particularly preferably a number from 9 to 50, highly preferably a number from 11 to 30, and most preferably a number from 11 to 25.

In formula (B2), each R⁴ is independently a hydrocarbon group or T¹¹-Bᵣ—(SiR³₂—O)ₖ₁—, and is preferably a hydrocarbon group. Details of the hydrocarbon group are the same as those of the hydrocarbon group represented by R³.

Each T¹¹ independently represents a monovalent group, and specific aspects thereof are the same as those of T¹¹ in formula (C) described later.

Specific aspects of B and r are the same as those of B and r in formula (C) described later.

### (Reactive Silyl Group)

The number of the reactive silyl groups contained in the specific silane compound is 1 or more. From the viewpoint of further improving the abrasion resistance of the surface treatment layer, the number is preferably from 1 to 18, more preferably from 1 to 12, still more preferably from 1 to 8, particularly preferably from 1 to 6, and highly preferably from 1 to 4. In an aspect, the number of the reactive silyl groups contained in the specific silane compound is preferably from 2 to 18, more preferably from 2 to 12, still more preferably from 2 to 8, and particularly preferably from 2 to 6. The number of the reactive silyl groups may be 1.

The reactive silyl group means a group having a reactive group bonded to an Si atom. The reactive group is preferably a hydrolyzable group, a group having a hydrolyzable group, or a hydroxy group.

The hydrolyzable group is a group that can be converted by a hydrolysis reaction into a hydroxy group. That is, the hydrolyzable silyl group represented by Si-L¹ (L¹ represents a hydrolyzable group) is converted by the hydrolysis reaction into a silanol group represented by Si—OH. The silanol groups further react with each other to form an Si—O—Si bond. A silanol group can also undergo a dehydration condensation reaction with a silanol group derived from an oxide present on the surface of the substrate to form an Si—O—Si bond.

Examples of the hydrolyzable group include an alkoxy group, an aryloxy group, a halogen atom, an acyl group, an acyloxy group, an amino group, —O—N—CR^{r}₂, and an isocyanato group (—NCO). The alkoxy group preferably has from 1 to 4 carbon atoms. The aryloxy group preferably has from 3 to 10 carbon atoms. Here, the aryl group of the aryloxy group encompasses a heteroaryl group. The halogen atom is preferably a chlorine atom. The acyl group preferably has from 1 to 6 carbon atoms. The acyloxy group preferably has from 1 to 6 carbon atoms. Each R^{r} independently represents an alkyl group having from 1 to 10 carbon atoms.

Examples of the group having a hydrolyzable group include groups having a hydrolyzable group exemplified above. The group having a hydrolyzable group is preferably —O-L^{A}-L^{B}. L^{A} represents an alkylene group, and L^{B} represents a hydrolyzable group. The number of carbon atoms in the alkylene group is preferably from 1 to 10. The hydrolyzable group represented by L^{B} is the same as the aforementioned hydrolyzable group. The same applies to the preferred aspects.

The reactive silyl group is preferably a group represented by the following formula (S1):

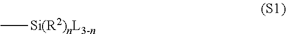

In formula (S1),
each R² independently represents a monovalent hydrocarbon group,
each L independently represents a hydrolyzable group, a group having a hydrolyzable group, or a hydroxy group, and
n represents an integer from 0 to 2.

When multiple reactive silyl groups are present in a molecule, the multiple reactive silyl groups may be the same or different. The multiple reactive silyl groups are preferably the same, from the viewpoint of availability of raw materials and ease of production of the compound.

Each R² independently represents a monovalent hydrocarbon group, and is preferably a monovalent saturated hydrocarbon group. The number of carbon atoms in R² is preferably from 1 to 6, more preferably from 1 to 3, and still more preferably 1 or 2.

Each L independently represents a hydrolyzable group, a group having a hydrolyzable group, or a hydroxy group. Details of the hydrolyzable group and the group having a hydrolyzable group are as described above.

In particular, Lis preferably an alkoxy group having from 1 to 4 carbon atoms, or a halogen atom, from the viewpoint of ease of production of the compound. From the viewpoint of low outgassing during coating and superior shelf stability of the compound, Lis preferably an alkoxy group having from 1 to 4 carbon atoms, and more preferably an ethoxy group or a methoxy group.

n is an integer from 0 to 2, preferably 0 or 1, and more preferably 0. The presence of multiple Ls makes the surface treatment layer more tightly adherable to the substrate.

When n is 1 or less, the multiple Ls present in one molecule may be the same or different. From the viewpoint of availability of raw materials and ease of production of the compound, the multiple Ls are preferably the same. When n is 2, the multiple R²s present in one molecule may be the same or different. From the viewpoint of availability of raw materials and ease of production of the compound, the multiple R²s are preferably the same.

From the viewpoint of excellence in the uniformity and durability of the surface treatment layer, the reactive silyl group is preferably an alkoxysilyl group or a trichlorosilyl group. From the viewpoint of ease of handling of byproducts produced in the reaction with the substrate, the reactive silyl group is more preferably an alkoxysilyl group. The alkoxysilyl group is preferably a dialkoxysilyl group or a trialkoxysilyl group, and more preferably a trialkoxysilyl group.

The reactive silyl group may also be a group represented by the following formula (S2):

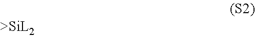

L is the same as L in formula (S1).

The reactive silyl group is also preferably a group represented by the following formula (S3):

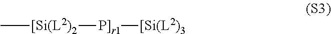

In formula (S3),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
r1 represents an integer from 1 to 3.

When multiple groups (S3) are present in one molecule, the multiple groups (S3) may be the same or different. The multiple groups (S3) are preferably the same, from the viewpoint of availability of raw materials and case of production of the compound.

Each L² independently represents a hydrolyzable group, a group having a hydrolyzable group, a hydroxy group, or a hydrocarbon group.

Details of the hydrolyzable group and the group having a hydrolyzable group are as described above.

In particular, the hydrolyzable group or the group having a hydrolyzable group represented by L² is preferably an alkoxy group having from 1 to 4 carbon atoms, an alkylene oxide-modified alkoxy group, or a halogen atom, from the viewpoint of ease of production of the compound. From the viewpoint of low outgassing during coating and superior shelf stability of the compound, L² is preferably an alkoxy group having from 1 to 4 carbon atoms, and more preferably an ethoxy group or a methoxy group.

Examples of the hydrocarbon group represented by L² include an alkyl group, a cycloalkyl group, an alkenyl group, and an allyl group. From the viewpoint of ease of synthesis and the like, a saturated hydrocarbon group is preferred, and an alkyl group is more preferred. The number of carbon atoms in the hydrocarbon group is preferably from 1 to 6, more preferably from 1 to 3, and still more preferably 1 or 2.
r1 represents an integer from 1 to 3. From the viewpoint of ease of synthesis, r1 is preferably 1 or 2, and more preferably 1.

Among the multiple L²s present in one group (S3), at least four represent a hydrolyzable group, a group having a hydrolyzable group, or a hydroxy group. This allows group (S3) and the substrate to be more tightly bonded, whereby the surface treatment layer having excellent durability can be obtained. From this point of view, the number of the hydrolyzable groups, the groups having a hydrolyzable group, and the hydroxy groups in group (S3) is preferably from 4 to 9, more preferably from 4 to 7, and still more preferably 4 or 5.

Here, the multiple L²s present in one molecule may be the same or different. For example, the multiple L²s may be the same hydrolyzable group.

Each P independently represents an oxygen atom, or an organic group having one carbon atom bonded to both adjacent Si atoms. The “organic group having one carbon atom bonded to both adjacent Si atoms” means that Si atoms are connected via one carbon atom. Examples of P include a hydrocarbon group, which may be —CH₂—, —C(CH₃)₂—, or the like, for example. From the viewpoint of durability of the surface treatment layer, P is preferably an oxygen atom, —CH₂—, or —C(CH₃)₂—, more preferably an oxygen atom or —CH₂—, and still more preferably an oxygen atom.

From the viewpoint of excellence in durability of the surface treatment layer, group (S3) is preferably —[Si(OR¹²)₂—O]ᵣ₁—Si(OR¹²)₃, In particular, —Si(OR¹²)₂—O—Si(OR¹²)₃ in the case of r1=1 is preferred. Here, each R¹² independently represents a hydrocarbon group. Examples of the hydrocarbon group include an alkyl group, a cycloalkyl group, an alkenyl group, and an allyl group. From the viewpoint of ease of synthesis, a saturated hydrocarbon group is preferred, and an alkyl group is more preferred. The number of carbon atoms in R¹² is preferably from 1 to 6, more preferably from 1 to 3, and still more preferably 1 or 2.

Specific examples of group (S3) include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

The number average molecular weight (Mn) of the specific silane compound is preferably from 500 to 20,000, more preferably from 600 to 18,000, and still more preferably from 700 to 15,000.

When the Mn is 500 or more, the surface treatment layer has superior abrasion resistance. When the Mn is 20,000 or less, the viscosity can be easily adjusted within an appropriate range, and the solubility is improved, thereby achieving excellent ease of handling during film formation.

The composition according to the present disclosure may contain impurities such as byproducts produced during the production process of the specific silane compound.

The content of the specific silane compound with respect to the total amount of the composition according to the present disclosure is preferably from 0.001% to 50% by mass, more preferably from 0.01% to 20% by mass, and still more preferably from 0.1% to 10% by mass. For the composition according to the present disclosure intended for use in wet coating, the content of the specific silane compound with respect to the total amount of the composition according to the present disclosure may also be from 0.01% to 10% by mass, from 0.02% to 5% by mass, from 0.03% to 3% by mass, or from 0.05% to 2% by mass.

Examples of the specific silane compound include a compound having a chain organo(poly)siloxane residue and a reactive silyl group connected to only one terminal of the chain organo(poly)siloxane residue (hereinafter also referred to as a “first compound”); and a compound having a chain organo(poly)siloxane residue and a reactive silyl group connected to each of the respective terminals of the chain organo(poly)siloxane residue (hereinafter also referred to as a “second compound”).

As the specific silane compound, the first compound may be used singly, the second compound may be used singly, or the first compound and the second compound may be used in combination. In all cases, one kind of the first compound may be used singly, or two or more kinds thereof may be used in combination, and one kind of the second compound may be used singly, or two or more kinds thereof may be used in combination.

### [First Compound]

The first compound has a chain organo(poly)siloxane residue and a reactive silyl group connected to only one terminal of the chain organo(poly)siloxane residue. In the present disclosure, the “reactive silyl group connected to only one terminal of the chain organo(poly)siloxane residue” means a reactive silyl group that is connected, directly or indirectly via another chemical structure, to only one terminal of the chain organo(poly)siloxane residue.

### (Chain Organo(poly)siloxane Residue)

The first compound contains a chain organo(poly)siloxane residue. The first compound may contain one, or two or more chain organo(poly)siloxane residues. When the first compound contains two or more chain organo(poly)siloxane residues, such two or more chain organo(poly)siloxane residues may be the same or different. When the first compound contains two or more chain organo(poly)siloxane residues, it suffices that there is no chain organo(poly)siloxane residue having a reactive silyl group connected to both terminals, and that at least one chain organo(poly)siloxane residue has a reactive silyl group connected to one terminal thereof.

Details of the chain organo(poly)siloxane residue are as described above in the section regarding the chain organo(poly)siloxane residue contained in the specific silane compound. In particular, the chain organo(poly)siloxane residue is preferably represented by formula (B1) or (B2), and more preferably represented by formula (B1).

### (Reactive Silyl Group)

Details of the reactive silyl group are as described above in the section regarding the reactive silyl group contained in the specific silane compound.

The number of the reactive silyl groups contained in the first compound is 1 or more, and from the viewpoint of further improving the abrasion resistance of the surface treatment layer, the number is preferably from 1 to 18, more preferably from 1 to 12, still more preferably from 1 to 8, particularly preferably from 1 to 6, and highly preferably from 1 to 4. In an aspect, the number of the reactive silyl groups contained in the first compound is preferably from 2 to 18, more preferably from 2 to 12, still more preferably from 2 to 8, and particularly preferably from 2 to 6. The number of the reactive silyl groups may be 1.

### (Compound (C))

In an aspect, the first compound is preferably represented by the following formula (C).

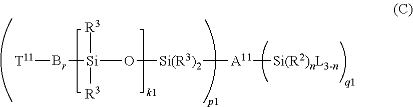

In formula (C),
T¹¹ represents a monovalent group free of a reactive silyl group,
each B independently represents —O— or —C(═O)—,
each r independently represents 0 or 1,
each R³ independently represents a hydrocarbon group,
each k1 independently represents a number that is 1 or higher,
p1 represents an integer that is 1 or higher,
A¹¹ represents a (p1+q1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2.

In formula (C), specific aspects of R³ and k1 are the same as those of R³ and k1 in formula (B1).

Specific aspects of R², L, and n are the same as those of R², L, and n in formula (S1). In formula (C), T¹¹ represents a monovalent group.

Examples of T¹¹ include an alkyl group, T¹₃M¹- (wherein M¹ represents Si, Sn, or Ge, and each T′ independently represents a hydrocarbon group or a trialkylsilyloxy group); T¹₃M¹-R¹— (wherein M¹ represents Si, Sn or Ge, each T¹ independently represents a hydrocarbon group or a trialkylsilyloxy group, and R¹ represents an alkylene group); a monovalent cyclic polysiloxane residue or a monovalent cage-structured polysiloxane residue; and a combination of a monovalent cyclic polysiloxane residue or a monovalent cage-structured polysiloxane residue with a divalent hydrocarbon group.

The alkyl group represented by T¹¹ may be any of a linear alkyl group, a branched alkyl group, or a cyclic alkyl group, and a linear alkyl group or a branched alkyl group is preferred. The number of carbon atoms in the alkyl group may be 1, or 2 or more. When the alkyl group has two or more carbon atoms, the number of carbon atoms is preferably from 2 to 30, more preferably from 3 to 28, and still more preferably from 4 to 22.
M¹ in T¹₃M¹- and T¹₃M¹-R¹— is preferably Si.
T¹ in T¹₃M¹- and T¹₃M¹-R¹— is preferably an alkyl group or a trialkylsilyloxy group, and more preferably a methyl group, a butyldimethylsilyloxy group, a trimethylsilyloxy group, or a triethylsilyloxy group.
R¹ is preferably an alkylene group having from 1 to 20 carbon atoms, more preferably an alkylene group having from 1 to 10 carbon atoms, and still more preferably an alkylene group having from 1 to 5 carbon atoms, and an ethylene group is particularly preferred.

In an aspect, T¹¹ is preferably an alkyl group or a trialkylsilyl group, and more preferably a methyl group or a trimethylsilyl group.

The monovalent cyclic polysiloxane residue is preferably a group represented by the following formula (T1).

In formula (T1),
each R^{T} independently represents a hydrocarbon group, or a hydrocarbon group having a substituent, and
s represents an integer from 1 to 4.

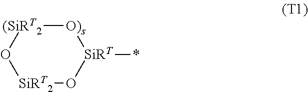

Examples of the hydrocarbon group represented by R^{T} include an aliphatic hydrocarbon group and an aromatic hydrocarbon group. In particular, the hydrocarbon group is preferably an aliphatic hydrocarbon group, and more preferably an alkyl group.

Among the hydrocarbon groups represented by R^{T}, the alkyl group may be any of a linear alkyl group, a branched alkyl group, or a cyclic alkyl group, and a linear alkyl group is preferred. The number of carbon atoms in the alkyl group is preferably from 1 to 10, more preferably from 1 to 8, and still more preferably from 1 to 4. More specifically, the alkyl group is preferably a methyl group, an ethyl group, an n-propyl group, or an n-butyl group, and more preferably a methyl group.

Examples of the hydrocarbon group contained in the hydrocarbon group having a substituent represented by R^{T} include an aliphatic hydrocarbon group and an aromatic hydrocarbon group. In particular, the hydrocarbon group is preferably an aliphatic hydrocarbon group, and more preferably an alkyl group. The alkyl group may be any of a linear alkyl group, a branched alkyl group, or a cyclic alkyl group, and a linear alkyl group is preferred. The number of carbon atoms in the alkyl group contained in the substituted alkyl group is preferably from 1 to 10, more preferably from 1 to 8, and still more preferably from 2 to 4.

Examples of the substituent in the hydrocarbon group having a substituent represented by R^{T} include a halogen atom, a hydroxy group, an alkoxy group, a trialkylsilyl ether group, a trialkylsilyl group, an amino group, a nitro group, a cyano group, a sulfonyl group, and a trifluoromethyl group.

The multiple RTs may be the same or different, and are preferably the same, from the viewpoint of ease of production.

Examples of the monovalent cyclic polysiloxane residue include the following groups.

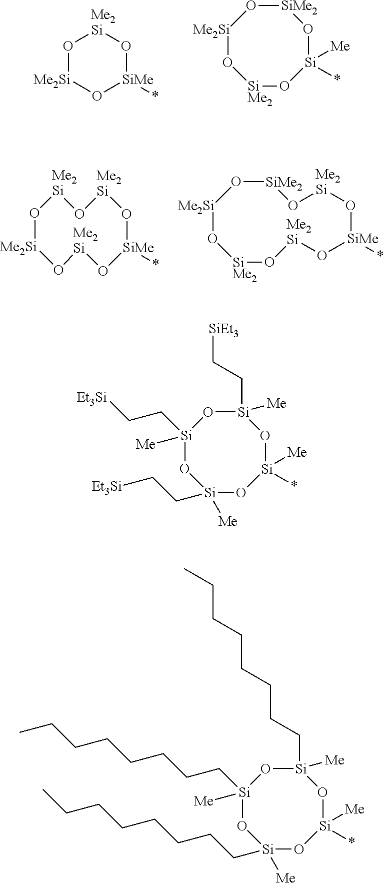

The monovalent cage-structured polysiloxane residue is preferably a group represented by the following formula (T²).

In formula (T²),
each R⁵ independently represents a hydrocarbon group or a trialkylsilyloxy group.

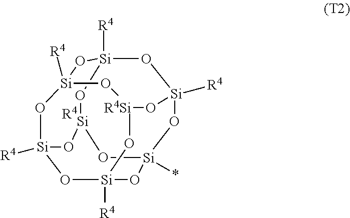

Examples of the hydrocarbon group represented by R⁵ include an aliphatic hydrocarbon group and an aromatic hydrocarbon group. In particular, the hydrocarbon group is preferably an aliphatic hydrocarbon group, and more preferably an alkyl group. The alkyl group may be any of a linear alkyl group, a branched alkyl group, or a cyclic alkyl group, and a linear alkyl group or a branched alkyl group is preferred; a methyl group, an ethyl group, an n-propyl group, an n-butyl group, or an isobutyl group is more preferred; and an isobutyl group is still more preferred.

The alkyl group contained in the trialkylsilyloxy group represented by R⁵ may be any of a linear alkyl group, a branched alkyl group, or a cyclic alkyl group. A linear alkyl group is preferred; a methyl group, an ethyl group, an n-propyl group, or an n-butyl group is more preferred; and a methyl group is still more preferred. When R⁵ is a trialkylsilyloxy group, the three alkylsilyloxy groups may be the same or different, and are preferably the same, from the viewpoint of ease of production.

Examples of the monovalent cage-structured polysiloxane residue include the following groups.

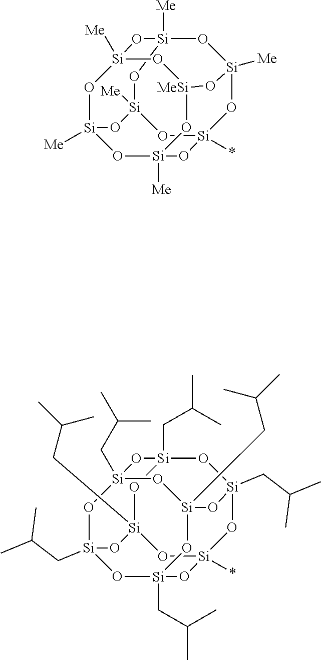

Examples of the divalent hydrocarbon group in the combination of a monovalent cyclic polysiloxane residue or a monovalent cage-structured polysiloxane residue with a divalent hydrocarbon group include an alkylene group. The number of carbon atoms in the alkylene group is preferably from 1 to 20, more preferably from 1 to 10, and still more preferably from 1 to 5.

In formula (C), each B independently represents —O— or —C(═O)—, and —O— is preferred.

In formula (C), p1 represents an integer that is 1 or higher, preferably an integer from 1 to 3, more preferably 1 or 2, and still more preferably 1.

When p1 represents 2 or 3, the multiple instances of T¹¹-Bᵣ—[Si(R³)₂—O]ₖ₁—Si(R³)₂— may be the same or different.

In formula (C), A¹¹ represents a (p1+q1)-valent linking group. Examples of A¹¹ include an alkylene group, an organo(poly)siloxane residue, a polyalkylene oxide group, and combinations thereof; as well as a combination of any of these groups with a (p1+1)-valent group and/or a (q1+1)-valent group.

Examples of the alkylene group include an alkylene group having from 1 to 30 carbon atoms, preferably an alkylene group having from 1 to 20 carbon atoms, containing or not containing at least one selected from the group consisting of an etheric oxygen atom, a sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group.

Examples of the organo(poly)siloxane residue include the group represented by the aforementioned formula (B1) or (B2).

Examples of the polyalkylene oxide group include a group represented by formula (XO)ₘ. Here, each X independently represents an alkylene group having from 1 to 5 carbon atoms, and m represents an integer that is 1 or higher. The number of carbon atoms in X is preferably from 1 to 4, and more preferably 2 or 3. m is preferably 1 to 200, more preferably 1 to 20, and still more preferably 1 to 10.

Examples of A¹¹ include A in formula A(Si(R²)ₙL₃₋ₙ)_{q1} described later.

In formula (C), q1 represents an integer that is 1 or higher, and is preferably from 1 to 18, more preferably from 1 to 12, still more preferably from 1 to 8, particularly preferably from 1 to 6, and highly preferably from 1 to 4. In an aspect, q1 is preferably from 2 to 18, more preferably from 2 to 12, still more preferably from 2 to 8, particularly preferably from 2 to 6, and highly preferably from 2 to 4. q1 may be 1.

When q1 is an integer that is 2 or higher, the multiple instances of [Si(R²)ₙL₃₋ₙ] may be the same or different.

In an aspect, T¹¹ in formula (C) is preferably a trialkylsilyl group or an alkyl group, and more preferably a trimethylsilyl group or a methyl group.
B is preferably O, and r is 0 or 1.
R³ is preferably a methyl group.
k1 is preferably from 1 to 100.
p1 is preferably 1.
A¹¹ is preferably an alkylene group having from 1 to 30 carbon atoms, or a group that remains after removing Si(R²)ₙL₃₋ₙ from group (3-1A) described later, and more preferably an alkylene group having from 1 to 30 carbon atoms, or a group that remains after removing Si(R²)ₙL₃₋ₙ from group (3-1A-4) described later.
q1 is preferably an integer from 1 to 4.

### (Compound (C2))

In another aspect, the first compound is preferably represented by the following formula (C2).

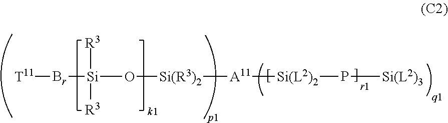

In formula (C2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
r1 represents an integer from 1 to 3.
T¹¹, B, r, R³, k1, p1, A¹¹, and q1 are as defined in formula (C).

Specific aspects of T¹¹, B, r, R³, k1, p1, A¹¹, and q1 in formula (C2) are the same as the specific aspects in formula (C).

Specific aspects of L², P, and r1 in formula (C2) are the same as the specific aspects of L², P, and r1 in formula (S3).

The number average molecular weight (Mn) of the first compound is preferably from 500 to 20,000, more preferably from 600 to 18,000, and still more preferably from 700 to 15,000. In an aspect, the Mn of the first compound may be from 500 to 5,000, or from 500 to 3,000.

When Mn is 500 or more, the surface treatment layer has superior abrasion resistance. When Mn is 20,000 or less, the viscosity can be easily adjusted within an appropriate range, and the solubility is improved, thereby achieving excellent ease of handling during film formation.

The composition according to the present disclosure may contain only one kind of the first compound, or two or more kinds thereof.

The composition according to the present disclosure may contain impurities such as byproducts produced during the production process of the first compound.

The content of the first compound with respect to the total amount of the composition according to the present disclosure is preferably from 0.001% to 50% by mass, more preferably from 0.01% to 20% by mass, and still more preferably from 0.1% to 10% by mass. For the composition according to the present disclosure intended for use in wet coating, the content of the first compound with respect to the total amount of the composition according to the present disclosure may be from 0.01% to 10% by mass, from 0.02% to 5% by mass, from 0.03% to 3% by mass, or from 0.05% to 2% by mass.

The content of the first compound with respect to the total solid content of the composition according to the present disclosure is preferably from 50.000% to 99.999% by mass, which is more preferably from 90.000% to 99.999% by mass.

### [Second Compound]

The second compound has a chain organo(poly)siloxane residue and a reactive silyl group connected to each of the respective terminals of the chain organo(poly)siloxane residue. In the present disclosure, the “reactive silyl group connected to each of the respective terminals of the chain organo(poly)siloxane residue” means a reactive silyl group that is connected, directly or indirectly via another chemical structure, to each of respective terminals of the chain organo(poly)siloxane residue.

### (Chain Organo(poly)siloxane Residue)

The second compound contains a chain organo(poly)siloxane residue. The second compound may contain one, or two or more chain organo(poly)siloxane residues. When the second compound contains two or more chain organo(poly)siloxane residues, the two or more chain organo(poly)siloxane residues may be the same or different. When the second compound contains two or more chain organo(poly)siloxane residues, it suffices that at least one chain organo(poly)siloxane residue has a reactive silyl group connected to each terminal thereof.

Details of the chain organo(poly)siloxane residue are as described above in the section regarding the chain organo(poly)siloxane residue contained in the specific silane compound. In particular, the chain organo(poly)siloxane residue is preferably represented by formula (B1) or (B2), and more preferably represented by formula (B1).

### (Reactive Silyl Group)

Details of the reactive silyl group are as described above in the section regarding the reactive silyl group contained in the specific silane compound.

The number of the reactive silyl groups contained in the second compound is 2 or more. From the viewpoint of further improving the abrasion resistance of the surface treatment layer, the number, per terminal of the chain organo(poly)siloxane residue, is preferably from 1 to 18, more preferably from 1 to 12, still more preferably from 1 to 8, particularly preferably from 1 to 6, and highly preferably from 1 to 4. In an aspect, the number of the reactive silyl groups contained in the second compound per terminal of the chain organo(poly)siloxane residue is preferably from 2 to 18, more preferably from 2 to 12, still more preferably from 2 to 8, and particularly preferably from 2 to 6. The number of the reactive silyl groups per terminal of the chain organo(poly)siloxane residue may be 1.

### (Compound (D))

In an aspect, the second compound is preferably represented by the following formula (D).

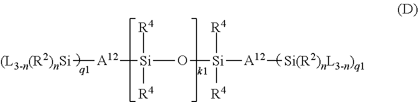

In formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher,
each A¹² independently represents a (q1+1)-valent linking group,
each q1 independently represents an integer that is 1 or higher,
each R² independently represents a hydrocarbon group,
each L independently represents a hydrolyzable group, a group having a hydrolyzable group, or a hydroxy group, and
each n independently represents an integer from 0 to 2.

In formula (D), specific aspects of R⁴ and k1 are the same as those of R⁴ and k1 in formula (B2).

Specific aspects of R², L, and n are the same as those of R², L, and n in formula (S1).

Examples of A¹² include an alkylene group, an organo(poly)siloxane residue, a polyalkylene oxide group, and combinations thereof; as well as combinations of any of these groups with a (q1+1)-valent group.

Examples of the alkylene group include an alkylene group having from 1 to 30 carbon atoms, preferably an alkylene group having from 1 to 20 carbon atoms, having or not having an etheric oxygen atom, a sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group.

Examples of the organo(poly)siloxane residue include a group represented by the aforementioned formula (B1) or (B2).

Examples of the polyalkylene oxide group include a group represented by formula (XO)ₘ. Here, each X independently represents an alkylene group having from 1 to 5 carbon atoms, and m represents an integer that is 1 or higher. The number of carbon atoms in X is preferably from 1 to 4, and more preferably 2 or 3. m is preferably from 1 to 100, more preferably from 1 to 10, and still more preferably from 1 to 5.

Examples of A¹² include the (q1+1)-valent group represented by A in formula A(Si(R²)ₙL₃₋ₙ)_{q1} described later.

Each q1 independently represents an integer that is 1 or higher, and is independently preferably from 1 to 18, more preferably from 1 to 12, still more preferably from 1 to 8, particularly preferably from 1 to 6, and highly preferably from 1 to 4. In an aspect, q1 is preferably from 2 to 18, more preferably from 2 to 12, still more preferably from 2 to 8, particularly preferably from 2 to 6, and highly preferably from 2 to 4. q1 may be 1.

When q1 represents an integer that is 2 or higher, the multiple instances of [Si(R²)ₙL₃₋ₙ] may be the same or different.

In an aspect, R⁴ is preferably a methyl group.
k1 is preferably a number from 1 to 100.
A¹² is preferably an alkylene group having from 1 to 30 carbon atoms, or a group that remains after removing Si(R²)ₙL₃₋ₙ from group (3-1A) described later, and more preferably an alkylene group having from 1 to 30 carbon atoms, or a group that remains after removing Si(R²)ₙL₃₋ₙ from group (3-1A-4) described later.

q1 is preferably an integer from 1 to 4.

### (Compound (D2))

In another aspect, the second compound is preferably represented by the following formula (D2)

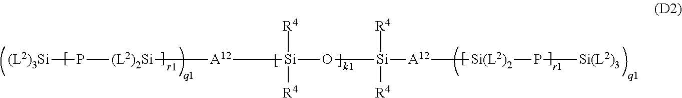

In formula (D2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
each r1 independently represents an integer from 1 to 3.
R⁴, k1, A¹², and q1 are as defined in formula (D).

Specific aspects of R⁴, k1, A¹², and q1 in formula (D2) are the same as the specific aspects in formula (D).

Specific aspects of L², P, and r1 in formula (D2) are the same as the specific aspects of L², P, and r1 in formula (S3).

The number average molecular weight (Mn) of the second compound is preferably from 500 to 20,000, more preferably from 600 to 18,000, and still more preferably from 700 to 15,000. In an aspect, the Mn of the second compound may also be from 500 to 5,000, and may be from 500 to 3,000.

When Mn is 500 or more, the surface treatment layer has superior abrasion resistance. When Mn is 20,000 or less, the viscosity can be easily adjusted within an appropriate range, and the solubility is improved, thereby achieving excellent ease of handling during film formation.

The composition according to the present disclosure may contain only one kind of the second compound, or two or more kinds thereof.

The composition according to the present disclosure may contain impurities such as byproducts produced during the production process of the second compound.

The content of the second compound with respect to the total amount of the composition according to the present disclosure is preferably from 0.001% to 50% by mass, more preferably from 0.01% to 20% by mass, and still more preferably from 0.1% to 10% by mass. For the composition according to the present disclosure intended for use in wet coating, the content of the second compound with respect to the total amount of the composition according to the present disclosure may be from 0.01% to 10% by mass, from 0.02% to 5% by mass, from 0.03% to 3% by mass, or from 0.05% to 2% by mass.

The content of the second compound with respect to the total solid content of the composition according to the present disclosure is preferably from 50.000% to 99.999% by mass, and more preferably from 90.000% to 99.999% by mass.

### [Compound (E) or (E2)]

In an aspect, the specific silane compound may be a compound represented by formula (E).

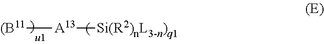

In formula (E),
B¹¹ represents a monovalent group having at least one selected from the group consisting of Si, Ge, and Sn to which a hydroxy group or a hydrolyzable group is not directly bonded, or a monovalent group having a branched alkyl group,
u1 represents an integer that is 1 or higher,
A¹³ represents a (q1+u1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2.

In formula (E), R², L, and n are the same as R², L, and n in formula (S1).
q1 is the same as q1 in formula (C).

B11 represents a monovalent group having at least one selected from the group consisting of Si, Ge, and Sn to which a hydroxy group or a hydrolyzable group is not directly bonded; or a monovalent group having a branched alkyl group. The monovalent group having at least one selected from the group consisting of Si, Ge, and Sn to which a hydroxy group or a hydrolyzable group is not directly bonded may or may not contain Si, Ge, or Sn to which a hydroxy group or a hydrolyzable group is directly bonded.

In an aspect, B11 may represent a group having a group (a) or a group (b).

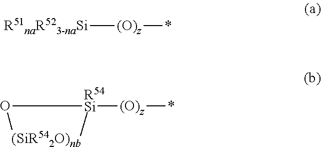

In formula (a),
R⁵¹ is a group represented by —(R⁶¹—SiR⁵³₂)ₘₐ—R⁵³, wherein each R⁶¹ independently represents an oxygen atom or an alkylene group having from 1 to 6 carbon atoms, each R⁵³ independently represents a hydrocarbon group or R^{51′}, wherein R^{51′} has the same meaning as R⁵¹; and ma represents an integer from 1 to 5; with the proviso that the number of R^{51′} in R⁵¹ is 20 or less,
R⁵² represents a hydrocarbon group,
na represents an integer from 1 to 3,
z represents 0 or 1, and
* indicates a bonding site with an adjacent atom.

In formula (b),
each R⁵⁴ independently represents a hydrocarbon group,
nb represents an integer from 1 to 5,
z represents 0 or 1, and
* indicates a bonding site with an adjacent atom.

The alkylene group having from 1 to 6 carbon atoms represented by R⁶¹ may be linear or branched. The alkylene group having from 1 to 6 carbon atoms is preferably an alkylene group having from 1 to 4 carbon atoms, and more preferably an alkylene group having from 2 to 4 carbon atoms.

The hydrocarbon group represented by R⁵³ is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, an n-propyl group, an isopropyl group, or a tert-butyl group.

The hydrocarbon group represented by R⁵² is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, an n-propyl group, an isopropyl group, or a tert-butyl group.

The hydrocarbon group represented by R⁵⁴ is preferably an alkyl group or an aryl group. The alkyl group may be linear or branched. The alkyl group is preferably an alkyl group having from 1 to 6 carbon atoms, more preferably an alkyl group having from 1 to 4 carbon atoms, and still more preferably a methyl group, an ethyl group, an n-propyl group, an isopropyl group, or a tert-butyl group.
nb represents an integer from 1 to 5, and is preferably 2 or 3.

Examples of the group having a group (a) or a group (b) include group (a) or group (b) alone, and a group composed of group (a) or group (b) to which a chain group is bonded.

Examples of the chain group include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group, at a terminal or between carbon atoms in a chain hydrocarbon group; and combinations thereof. R^{d} represents a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group. From the viewpoint of forming the surface treatment layer having excellent acid resistance, hot water resistance, abrasion resistance, and the like, the chain hydrocarbon group is preferably an alkylene group having 13 or more carbon atoms.

The same applies to the number of carbon atoms in the group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal or between carbon atoms in a chain hydrocarbon group. R^{d} represents a hydrogen atom or an alkyl group (preferably having from 1 to 10 carbon atoms).

Examples of the chain organo(poly)siloxane residue include the examples of the chain organo(poly)siloxane residue in the specific silane compound described above.

In an aspect, B¹¹ may represent a group having a group (c):

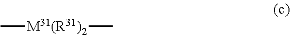

In formula (c),
M³¹ represents Sn or Ge, and
each R³¹ independently represents a hydrocarbon group or a trialkylsilyloxy group.
M³¹ represents Sn or Ge. Ge has an atomic size larger than that of Sn and therefore can lower the surface free energy of the surface treatment layer. From the viewpoint of forming a surface treatment layer having superior removability of fingerprints, M³¹ is preferably Ge.
R³¹ represents a hydrocarbon group or a trialkylsilyloxy group.

Examples of the hydrocarbon group include an alkyl group, a cycloalkyl group, an alkenyl group, and an allyl group. From the viewpoint of ease of synthesis or the like, a saturated hydrocarbon group is preferred, and an alkyl group is more preferred. The number of carbon atoms in R³¹ is preferably from 1 to 6, and more preferably from 1 to 3. In particular, —CH₃ or —CH₂CH₃ is preferred.

The trialkylsilyloxy group is preferably a group represented by —O—SiR⁴⁰₃. Here, each R⁴⁰ independently represents a hydrocarbon group. The hydrocarbon group represented by R⁴⁰ is preferably an alkyl group or an aryl group, and more preferably an alkyl group. The number of carbon atoms in R⁴⁰ is preferably from 1 to 6, more preferably from 1 to 4, and still more preferably 1 or 2. Specific examples of the hydrocarbon group represented by R⁴⁰ include —CH₃, —CH₂CH₃, and —C(CH₃)₃.

Examples of the group having a group (c) include group (c) alone, and a group composed of group (c) and an organic group bonded to either or both sides of M³¹. Examples of the organic group include a monovalent organic group, a divalent organic group, and combinations thereof. However, monovalent organic groups are not bonded to both sides.

Examples of the monovalent organic group include a hydrocarbon group, a trialkylsilyloxy group, or an organopolysiloxane group. Group (c) may be M³¹(R³¹)₃—.

Examples of the divalent organic group include a chain hydrocarbon group; a chain organo(poly)siloxane residue; a group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of or between carbon atoms of a chain hydrocarbon group; and combinations thereof. R^{d} represents a hydrogen atom or an alkyl group (preferably having from 1 to 10 carbon atoms).

Examples of the chain hydrocarbon group include a linear or branched chain hydrocarbon group having from 2 to 100, preferably from 5 to 90, and more preferably from 10 to 80 carbon atoms. Examples of the chain hydrocarbon group include an alkyl group and an alkylene group. From the viewpoint of forming the surface treatment layer having excellent acid resistance, hot water resistance, abrasion resistance, and the like, the chain hydrocarbon group is preferably an alkylene group having 13 or more carbon atoms.

The same applies to the number of carbon atoms in the group having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of or between carbon atoms of a chain hydrocarbon group. R^{d} represents a hydrogen atom or an alkyl group (preferably having from 1 to 10 carbon atoms).

Examples of the chain organo(poly)siloxane residue include the examples of the chain organo(poly)siloxane residue in the specific silane compound described above.

In an aspect, B11 may represent a monovalent group having a branched alkyl group. The branched alkyl group is preferably unsubstituted. The branched alkyl group is preferably a tert-butyl group, or contains a tert-butyl group. The branched alkyl group may contain a single branch or multiple branches. The number of branches in the branched alkyl group may be from 1 to 30, may be from 1 to 20, may be from 1 to 10, or may be from 1 to 5.

Examples of the branched alkyl group include a group represented by the following formula:

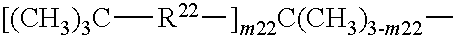

In the formula,
each R²² independently represents an alkylene group having from 1 to 6 carbon atoms, and
m22 represents an integer from 0 to 3.

Examples of the monovalent group having a branched alkyl group include a group having a chain group bonded to a carbon atom at the branching point of the branched alkyl group.

Examples of the chain group include a chain hydrocarbon group; a chain organo(poly)siloxane residue; a group having at least one selected from the group consisting of —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group at a terminal of or between carbon atoms of a chain hydrocarbon group; and combinations thereof.

Examples of the chain hydrocarbon group include a linear or branched chain hydrocarbon group having from 2 to 100, preferably from 5 to 90, and more preferably from 10 to 80 carbon atoms. The chain hydrocarbon group is preferably an alkylene group. From the viewpoint of forming a surface treatment layer having excellent acid resistance, hot water resistance, abrasion resistance, and the like, the chain hydrocarbon group is preferably an alkylene group having 13 or more carbon atoms.

The same applies to the number of carbon atoms in the group having at least one selected from the group consisting of —O—, —S—, —C(═O)NH—, —NHC(═O)—, —N(R)—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group at a terminal of or between carbon atoms of a chain hydrocarbon group. R^{d} represents a hydrogen atom or an alkyl group (preferably having from 1 to 10 carbon atoms).

Examples of the chain organo(poly)siloxane residue include the examples of the chain organo(poly)siloxane residue in the specific silane compound described above.

In formula (E), u1 represents an integer that is 1 or higher. From the viewpoint of ease of production and the like, u1 is preferably from 1 to 6, and more preferably from 1 to 4.

In formula (E), A¹³ represents a (q1+u1)-valent linking group. Examples of A¹³ include the specific examples of A¹¹ in formula (C).

The compound (E) may be a compound in which B11 represents group (a) or M³¹(R³¹)₃—; u1 represents 1; A¹³ represents an alkylene group having from 1 to 30 carbon atoms, and having or not having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group between carbon atoms; and q1 represents 1.

The compound (E) may also be a compound in which B11 represents group (a) or M³¹(R³¹)₃—; u1 represents 1; A¹³ represents a chain hydrocarbon group having from 1 to 30 carbon atoms, and having or not having at least one selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and a phenylene group between carbon atoms; and q1 represents 2 or 3.
R^{d} represents a hydrogen atom or an alkyl group (preferably having from 1 to 10 carbon atoms).

Specific examples of the compound (E) include the following compounds. In the following formulae, sa is preferably from 1 to 30, more preferably from 4 to 20, and still more preferably from 5 to 15.

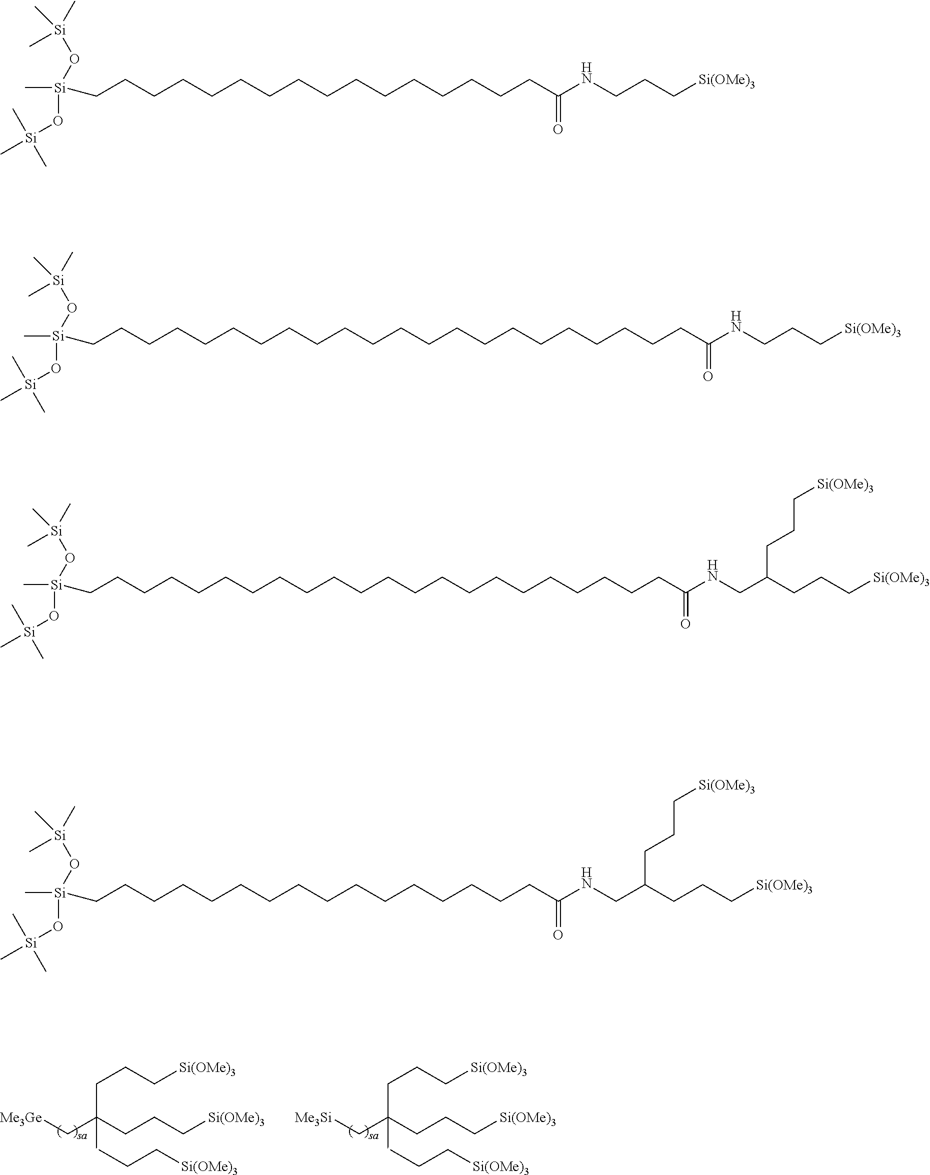

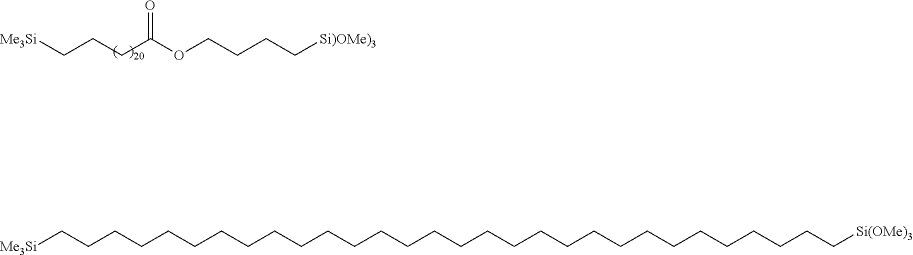

In an aspect, the specific silane compound may also be a compound represented by formula (E2).

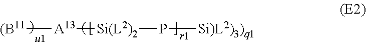

In formula (E2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
each r1 independently represents an integer from 1 to 3.
B¹¹, u1, A¹³, and q1 are as defined in formula (E).

Specific aspects of B¹¹, u1, A¹³, and q1 are the same as the specific aspects of those in formula (E).

Specific aspects of L², P, and r1 are the same as the specific aspects of those in formula (S3).

### [Partial Structures of First Compound, Second Compound, and Compound (E)]

Hereinafter, preferred aspects of A¹¹(Si(R²)ₙL₃₋ₙ)_{q1} in formula (C), A¹²(Si(R²)ₙL₃₋ₙ)_{q1} in formula (D), and A¹³(Si(R²)ₙL₃₋ₙ)_{q1} in formula (E) will be described in detail. Hereinafter, A¹¹(Si(R²)ₙL₃₋ₙ)_{q1} in formula (C), A¹²(Si(R²)ₙL₃₋ₙ)_{q1} in formula (D), and A¹³(Si(R²)ₙL₃₋ₙ)_{q1} in formula (E) will collectively be denoted as A(Si(R²)ₙL₃₋ₙ)_{q1}.

Here, A represents a (p1+q1)-valent group for formula (C), a (q1+1)-valent group for formula (D), and a (q1+u1)-valent group for formula (E).

The group represented by A(Si(R²)ₙL₃₋ₙ)_{q1} is preferably group (3-1A) or group (3-1B). Group (3-1A) is more preferred.

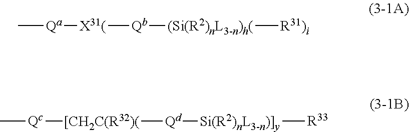

Note that the definitions of R², L, and n in formulae (3-1A) and (3-1B) are as described above.

In formula (3-1A), Q^{a} represents a single bond or a divalent linking group.

Examples of the divalent linking group include a divalent hydrocarbon group, a divalent heterocyclic group, —O—, —S—, —SO₂—, —N(R^{d})—, —C(O)—, —Si(R^{a})₂—, and a group combining two or more of these groups.

The divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms in the alkylene group is preferably from 1 to 30, more preferably from 1 to 20, still more preferably from 4 to 20, and particularly preferably from 5 to 15. The divalent aromatic hydrocarbon group preferably has from 5 to 20 carbon atoms, and examples thereof include a phenylene group. Other examples include an alkenylene group having from 2 to 20 carbon atoms, and an alkynylene group having from 2 to 20 carbon atoms.

The aforementioned R^{a} represents an alkyl group (preferably having from 1 to 10 carbon atoms), or a phenyl group. The aforementioned R^{d} represents a hydrogen atom or an alkyl group (preferably having from 1 to 10 carbon atoms).

Examples of the group having two or more of the aforementioned groups include-OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and alkylene group-Si(R^{a})₂-phenylene group-Si(R^{a})₂.

In formula (3-1A), X³¹ represents a single bond, an alkylene group, a carbon atom, a nitrogen atom, a silicon atom, a 2- to 8-valent organo(poly)siloxane residue, or a group having a (h+i+1)-valent ring.

The alkylene group may have —O—, a silphenylene skeleton group, a divalent organo(poly)siloxane residue, or a dialkylsilylene group. The alkylene group may also have multiple groups selected from the group consisting of —O—, a silphenylene skeleton group, a divalent organo(poly)siloxane residue, and a dialkylsilylene group.

The number of carbon atoms in the alkylene group represented by X³¹ is preferably from 1 to 20, and more preferably from 1 to 10.

Examples of the 2- to 8-valent organo(poly)siloxane residue include a divalent organo(poly)siloxane residue, and a (w2+1)-valent organo(poly)siloxane residue described later.

When X³¹ in formula (3-1A) represents a group having a (h+i+1)-valent ring, Q^{a}, (-Q^{b}-Si(R²)ₙL₃₋ₙ), and R³¹ are directly bonded to atoms that constitute the ring. Here, the ring is a ring other than an organopolysiloxane ring.

The ring represented by X³¹ may be any of a monocyclic ring, a fused polycyclic ring, a bridged ring, a spiro ring, or an assembled polycyclic ring. Regarding the atoms that constitute the ring, the ring may be a carbon ring composed only of carbon atoms, or a heterocyclic ring composed of carbon atoms and a heteroatom having a valence of two or more. The bonds between the atoms that constitute the ring may be single bonds or multiple bonds. Further, the ring may be an aromatic ring or a non-aromatic ring.

The monocyclic ring is preferably a 4- to 8-membered ring, and more preferably a 5- or 6-membered ring. The fused polycyclic ring is preferably a fused polycyclic ring having two or more 4- to 8-membered rings fused therein, and more preferably a fused polycyclic ring having two or three 5- or 6-membered rings fused therein, or a fused polycyclic ring having one or two 5- or 6-membered rings fused with one 4-membered ring. The bridged ring is preferably a bridged ring having a 5- or 6-membered ring as the largest ring. The spiro ring is preferably a spiro ring composed of two 4- to 6-membered rings. The assembled polycyclic ring is preferably an assembled polycyclic ring having two or three 5- or 6-membered rings assembled via a single bond, 1 to 3 carbon atoms, or one hetero atom having a valence of 2 or 3. In the assembled polycyclic ring, it is preferable that each of the rings has any of Q^{a}, (-Q^{b}-Si(R²)ₙL₃₋ₙ) or R³¹ (when i=1 or more) bonded thereto.

The heteroatom contained in the ring is preferably a nitrogen atom, an oxygen atom, or a sulfur atom, and more preferably a nitrogen atom or an oxygen atom. The number of heteroatoms contained in the ring is preferably three or less. When the number of heteroatoms contained in the ring is two or more, the heteroatoms may be different.

The ring represented by X³¹ is preferably one selected from the group consisting of a 3- to 8-membered aliphatic ring, a benzene ring, a 3- to 8-membered heterocyclic ring, a fused ring having two or three of these rings fused therein, a bridged ring having a 5- or 6-membered ring as the largest ring, and an assembled polycyclic ring having two or more of these rings and having a linking group selected from a single bond, an alkylene group having 3 or less carbon atoms, an oxygen atom, and a sulfur atom, from the viewpoint of ease of production of the compound and superior abrasion resistance of the surface treatment layer.

Preferred rings include a benzene ring, a 5-membered or 6-membered aliphatic ring, a 5-membered or 6-membered heterocyclic ring having a nitrogen atom or an oxygen atom, and a fused ring having a 5- or 6-membered carbon ring fused with a 4- to 6-membered heterocyclic ring.

Specific examples of the ring include the rings listed below, as well as a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. The following also include rings having an oxo group (═O).

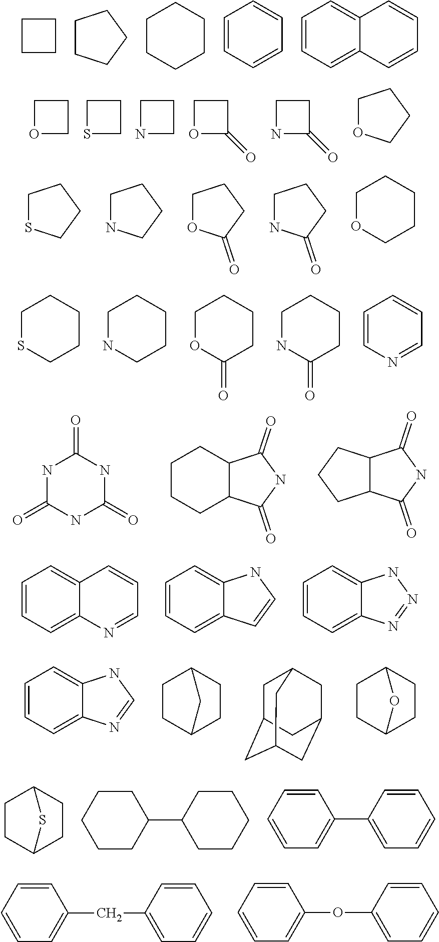

The bonds of the ring-constituting atoms, that do not constitute the ring represented by X³¹, are bonds bonded to Q^{a}, (-Q^{b}-Si(R²)ₙL₃₋ₙ), or R³¹. When a remaining bond is present, the remaining bond is bonded to a hydrogen atom or a substituent. Examples of the substituent include a halogen atom, an alkyl group (in which an etheric oxygen atom may be contained between carbon atoms), a cycloalkyl group, an alkenyl group, an allyl group, an alkoxy group, and an oxo group (═O).

When one of the carbon atoms that constitute the ring has two bonds that can be bonded to Q^{a}, (-Q^{b}-Si(R²)ₙL₃₋ₙ), or R³¹, such a carbon atom may be bonded to Q^{a} and (-Q^{b}-Si(R²)ₙL₃₋ₙ), or may be bonded to two (-Q^{b}-Si(R²)ₙL₃₋ₙ) groups. Q^{a} is preferably bonded to a ring member atom different from the ring member atom to which the (-Q^{b}-Si(R²)ₙL₃₋ₙ) group or R³¹ is bonded. The h instances of (-Q^{b}-Si(R²)ₙL₃₋ₙ) may be bonded to different ring member atoms; two instances thereof may be bonded to one ring-constituting carbon atom; and two or more ring-constituting atoms to which the two instances of (-Q^{b}-Si(R²)ₙL₃₋ₙ) are bonded may be present. The i instances of R³¹ may be bonded to different ring-constituting atoms; two instances thereof may be bonded to one ring-constituting carbon atom; and two or more ring-constituting atoms to which the two instances of R³¹ are bonded may be present.

In particular, from the viewpoint of improving the abrasion resistance of the surface treatment layer, X³¹ is preferably a carbon atom, a nitrogen atom, a silicon atom, a 4- to 8-valent organo(poly)siloxane residue, or a group having a (h+i+1)-valent ring, and more preferably a carbon atom.

In formula (3-1A), Q^{b} represents a single bond or a divalent linking group.

The definition of the divalent linking group is the same as the definition discussed above in relation to Q^{a}.

In particular, Q^{b} is preferably an alkylene group optionally having an etheric oxygen atom. The number of carbon atoms in the alkylene group is preferably from 1 to 30, more preferably from 1 to 20, still more preferably from 2 to 20, and may be from 2 to 10, may be from 2 to 6, and may be from 2 to 5. The number may be, for example, 2, 3, 8, 9, or 11. The number of carbon atoms may also be from 1 to 10.

In formula (3-1A), R³¹ represents a hydrogen atom, a hydroxy group, or an alkyl group.

The number of carbon atoms in the alkyl group is preferably from 1 to 5, more preferably from 1 to 3, and still more preferably 1.

When X³¹ represents a single bond or an alkylene group, h represents 1, and i represents 0;
when X³¹ represents a nitrogen atom, h represents an integer of 1 or 2, i represents an integer of 0 or 1, and h+i=2 is satisfied;
when X³¹ represents a carbon atom or a silicon atom, h represents an integer from 1 to 3, i represents an integer from 0 to 2, and h+i=3 is satisfied; and
when X³¹ represents a 2- to 8-valent organo(poly)siloxane residue, h represents an integer from 1 to 7, i represents an integer from 0 to 6, and h+i=1 to 7 is satisfied.

When X³¹ represents a group having a (h+i+1)-valent ring, h represents an integer from 1 to 7, i represents an integer from 0 to 6, and h+i=1 to 7 is satisfied.

When two or more instances of (-Q^{b}-Si(R)ₙL₃₋ₙ) are present, the two or more instances of (-Q^{b}-Si(R)ₙL₃₋ₙ) may be the same or different. When two or more instances of R³¹ are present, the two or more instances of (—R³¹) may be the same or different.

In particular, i is preferably 0, from the viewpoint of improving the abrasion resistance of the surface treatment layer.

In formula (3-1B), Q^{c} represents a single bond or a divalent linking group.

The definition of the divalent linking group is the same as the definition discussed above in relation to Q^{a}.

In formula (3-1B), R³² is a hydrogen atom or an alkyl group having from 1 to 10 carbon atoms, and is preferably a hydrogen atom, from the viewpoint of ease of production of the compound.

The alkyl group is preferably a methyl group.

In formula (3-1B), Q^{d} represents a single bond or an alkylene group. The number of carbon atoms in the alkylene group is preferably from 1 to 10, and more preferably from 1 to 6. From the viewpoint of ease of production of the compound, Q^{d} is preferably a single bond or CH₂—.

In formula (3-1B), R³³ is a hydrogen atom or a halogen atom, and is preferably a hydrogen atom, from the viewpoint of ease of production of the compound.
y represents an integer from 1 to 10, and is preferably an integer from 1 to 6.

Two or more instances of [CH₂C(R³²) (-Q^{d}-Si(R²)ₙL₃₋ₙ)] may be the same or different.

Group (3-1A) is preferably any of groups (3-1A-1) to (3-1A-7).

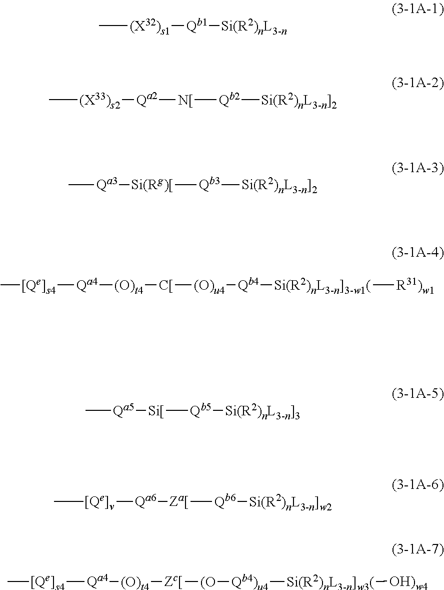

The definitions of R², L, and n in formulae (3-1A-1) to (3-1A-7) are as described above.

In particular, group (3-1A) is preferably group (3-1A-4).

In group (3-1A-1), X³² represents-O—, —S—, —N(R)—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; or a combination of any of these groups with a divalent linking group (here, N is bonded to Q^{b1}).

The definition of R^{d} is as described above.
s1 represents 0 or 1.

When X³² is a combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, with a divalent linking group, the divalent linking group is bonded to Si(R³)₂ in formula (C), Si(R^{d})₂ in formula (D), or B¹¹ in formula (E).

Examples of the divalent linking group include an alkylene group, an organo(poly)siloxane residue, a polyalkylene oxide group, and any combinations thereof.

Q^{b1} represents a single bond or an alkylene group. The alkylene group may have —O—, a silphenylene skeleton group, or a dialkylsilylene group. The alkylene group may have multiple groups selected from the group consisting of —O—, a silphenylene skeleton group, a divalent organo(poly)siloxane residue, and a dialkylsilylene group.

When the alkylene group has —O—, a silphenylene skeleton group, a divalent organo(poly)siloxane residue or a dialkylsilylene group, the alkylene group preferably has such a group between carbon atoms.

The number of carbon atoms in the alkylene group represented by Q^{b1} is preferably from 1 to 30, more preferably from 1 to 20, still more preferably from 2 to 20, and particularly preferably from 2 to 6. The number of carbon atoms may be from 1 to 10.

In group (3-1A-2), X³³ represents-O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; or a combination of any of these groups with a divalent linking group.

The definition of R^{d} is as described above.
s2 represents 0 or 1. s2 is preferably 0, from the viewpoint of ease of production of the compound.

When X³³ is a combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, with a divalent linking group, the divalent linking group is bonded to Si(R³)₂ in formula (C), Si(R^{d})₂ in formula (D), or B¹¹ in formula (E).

Examples of the divalent linking group include an alkylene group, an organo(poly)siloxane residue, a polyalkylene oxide group, and any combinations thereof.
Q^{a2} represents a single bond, an alkylene group, —C(O)—, or a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH—, between carbon atoms of an alkylene group having two or more carbon atoms.

The number of carbon atoms in the alkylene group represented by Q^{a2} is preferably from 1 to 20, more preferably from 1 to 10, still more preferably from 1 to 6, and particularly preferably from 1 to 3.

The number of carbon atoms in the group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms of an alkylene group having two or more carbon atoms represented by Q82 is preferably from 2 to 10, and more preferably from 2 to 6,
Q^{a2} is preferably a single bond, from the viewpoint of ease of production of the compound.
Q^{b2} represents an alkylene group, or a group having a divalent organo(poly)siloxane residue, an etheric oxygen atom, or —NH—, between carbon atoms of an alkylene group having two or more carbon atoms.

The number of carbon atoms in the alkylene group represented by Q^{b2} is preferably from 1 to 30, more preferably from 1 to 20, still more preferably from 2 to 20, and may be from 2 to 10, and may be from 2 to 6. The number may be, for example, 2, 3, 8, 9, or 11. The number of carbon atoms may also be from 1 to 10.

The number of carbon atoms in the group having a divalent organo(poly)siloxane residue, an etheric oxygen atom, or —NH— between carbon atoms of the alkylene group having two or more carbon atoms represented by Q^{b2} is preferably from 2 to 10, and more preferably from 2 to 6.
Q^{b2} is preferably —CH₂CH₂CH₂— or —CH₂CH₂OCH₂CH₂CH₂—, from the viewpoint of ease of production of the compound (here, the right side is bonded to Si).

The two instances of [-Q^{b2}-Si(R²)ₙL₃₋ₙ] may be the same or different.

In group (3-1A-3), Q^{a3} represents a single bond, or an alkylene group optionally having an etheric oxygen atom. From the viewpoint of ease of production of the compound, Q^{a3} is preferably a single bond.

The number of carbon atoms in the alkylene group optionally having an etheric oxygen atom is preferably from 1 to 10, and particularly preferably from 2 to 6.
R^{g} represents a hydrogen atom, a hydroxy group, or an alkyl group.
R^{g} is preferably a hydrogen atom or an alkyl group, from the viewpoint of ease of production of the compound. The number of carbon atoms in the alkyl group is preferably from 1 to 10, and more preferably from 1 to 4. A methyl group is further preferred.
Q^{b3} represents an alkylene group, or a group having an etheric oxygen atom or a divalent organo(poly)siloxane residue between carbon atoms of an alkylene group having two or more carbon atoms.

The number of carbon atoms in the alkylene group represented by Q^{b3} is preferably from 1 to 30, more preferably from 1 to 20, still more preferably from 2 to 20, and may be from 2 to 10, and may be from 2 to 6. The number may be, for example, 2, 3, 8, 9, or 11. The number of carbon atoms may also be from 1 to 10.

The number of carbon atoms in the group having an etheric oxygen atom or a divalent organo(poly)siloxane residue between carbon atoms of an alkylene group having two or more carbon atoms represented by Q^{b3} is preferably from 2 to 20, more preferably from 2 to 10, and still more preferably from 2 to 6.
Q^{b3} is preferably —CH₂CH₂—, —CH₂CH₂CH₂—, or —CH₂CH₂CH₂CH₂CH₂CH₂CH₂CH₂—, from the viewpoint of ease of production of the compound.

The two instances of [-Q^{b3}-Si(R²)ₙL₃₋ₙ] may be the same or different.

In group (3-1A-4), Q^{e} represents —C(O)O—, —SO₂N(R^{d})—, —N(R^{d})SO₂—, —N(R^{d})C(O)—, or —C(O)N(R^{d})—; or a combination of any of these groups with a divalent linking group.

When Q^{e} is a combination of —C(O)O—, —SO₂N(R^{d})—, —N(R^{d})SO₂—, —N(R^{d})C(O)—, or —C(O)N(R^{d})— with a divalent linking group, the divalent linking group is bonded to Si(R³)₂ in formula (C), Si(R^{d})₂ in formula (D), or B¹¹ in formula (E).

Examples of the divalent linking group include an alkylene group, an organo(poly)siloxane residue, a polyalkylene oxide group, and any combinations thereof.

The definition of R³¹ is as described above. When w1 is 1 or 2, R³¹ is preferably a hydrogen atom.
s4 represents 0 or 1.
Q^{a4} represents a single bond, or an alkylene group optionally having an etheric oxygen atom.

The number of carbon atoms in the alkylene group optionally having an etheric oxygen atom is preferably from 1 to 20, more preferably from 1 to 10, still more preferably from 1 to 6, and particularly preferably from 1 to 3.
t4 represents 0 or 1 (when Q^{a4} is a single bond, t4 is 0).

From the viewpoint of ease of production of the compound, when s4 is 0, -Q^{a4}-(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂—; and when s4 is 1, -Q24-(O)ₜ₄— is preferably a single bond, —CH₂—, or —CH₂CH₂—.
Q^{b4} represents an alkylene group. The alkylene group may have —O—, —C(O)N(R^{d})— (the definition of R^{d} is as described above), a silphenylene skeleton group, a divalent organo(poly)siloxane residue, or a dialkylsilylene group.

When the alkylene group has —O— or a silphenylene skeleton group, the alkylene group preferably has the —O— or the silphenylene skeleton group between carbon atoms. When the alkylene group has —C(O)N(R^{d})—, a dialkylsilylene group, or a divalent organo(poly)siloxane residue, the alkylene group preferably has any of these groups between carbon atoms or at the terminal on the side bonded to (O)ᵤ₄.

The number of carbon atoms in the alkylene group represented by Q^{b4} is preferably from 1 to 30, more preferably from 1 to 20, still more preferably from 2 to 20, and may be from 2 to 10, and may be from 2 to 6. The number may be, for example, 2, 3, 8, 9, or 11. The number of carbon atoms may also be from 1 to 10.
u4 represents 0 or 1.

From the viewpoint of ease of production of the compound, —(O)ᵤ₄-Q^{b4}- is preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, or —CH₂CH₂CH₂Si(CH₃)₂PhSi(CH₃)₂CH₂CH₂— (here, the right side is bonded to Si).
w1 represents an integer from 0 to 2, preferably 0 or 1, and more preferably 0.

When two or more instances of [—(O)ᵤ₄-Q^{b4}-Si(R²)ₙL₃₋ₙ] are present, the two or more instances of [—(O)ᵤ₄-Q^{b4}-Si(R²)ₙL₃₋ₙ] may be the same or different.

When two or more instances of R³¹ are present, the two or more instances of (—R³¹) may be the same or different.

In group (3-1A-5), Q^{a5} represents an alkylene group optionally having an etheric oxygen atom.

The number of carbon atoms in the alkylene group optionally having an etheric oxygen atom is preferably from 1 to 10, and particularly preferably from 2 to 6.

From the viewpoint of ease of production of the compound, Q^{a5} is preferably-OCH₂CH₂CH₂—, —OCH₂CH₂OCH₂CH₂CH₂—, —CH₂CH₂—, or —CH₂CH₂CH₂— (here, the right side is bonded to Si).

Q^{b5} represents an alkylene group, or a group having an etheric oxygen atom or a divalent organo(poly)siloxane residue between carbon atoms of an alkylene group having two or more carbon atoms.

The number of carbon atoms in the alkylene group represented by Q35 is preferably from 1 to 30, more preferably from 1 to 20, still more preferably from 2 to 20, and may be from 2 to 10, and may be from 2 to 6. The number may be, for example, 2, 3, 8, 9, or 11. The number of carbon atoms may also be from 1 to 10.

The number of carbon atoms in the group having an etheric oxygen atom or a divalent organo(poly)siloxane residue between the carbon atoms of an alkylene group having two or more carbon atoms represented by Q^{b5} is preferably from 2 to 20, more preferably from 2 to 10, and still more preferably from 2 to 6.

From the viewpoint of ease of production of the compound, Q^{b5} is preferably —CH₂CH₂CH₂— or —CH₂CH₂OCH₂CH₂CH₂— (here, the right side is bonded to Si(R²)ₙL₃₋ₙ).

Three instances of [-Q^{b5}-Si(R²)ₙL₃₋ₙ] may be the same or different.

The definition of Q^{e} in group (3-1A-6) is as defined in relation to the aforementioned group (3-1A-4).
v represents 0 or 1.
Q^{a6} represents an alkylene group optionally having an etheric oxygen atom.

The number of carbon atoms in the alkylene group optionally having an etheric oxygen atom is preferably from 1 to 10, and particularly preferably from 2 to 6.

From the viewpoint of ease of production of the compound, Q^{a6} is preferably —CH₂OCH₂CH₂CH₂—, —CH₂OCH₂CH₂OCH₂CH₂CH₂—, —CH₂CH₂—, or —CH₂CH₂CH₂— (here, the right side is bonded to Z^{a}).
Z^{a} represents a (w2+1)-valent organo(poly)siloxane residue, or a group having a valence of (w2+1) and having an alkylene group between an organo(poly)siloxane residue and an organo(poly)siloxane residue.
w2 represents an integer from 2 to 7.

Examples of the (w2+1)-valent organo(poly)siloxane residue, and the group having a valence of (w2+1) and having an alkylene group between an organo(poly)siloxane residue and an organo(poly)siloxane residue include the following groups. Here, R^{a} in the following formulae is as described above. * indicates a bonding site.

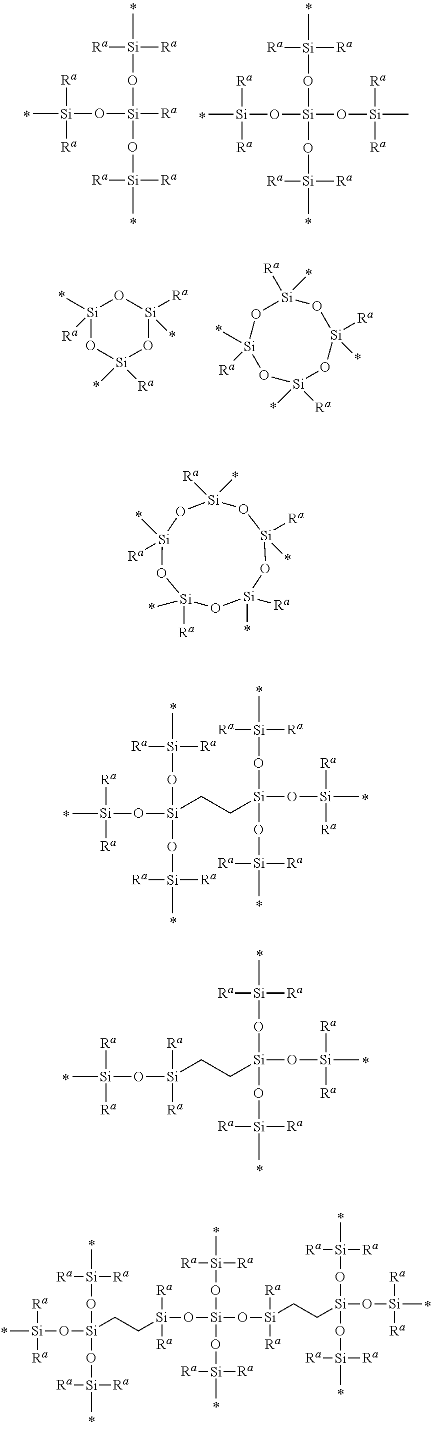

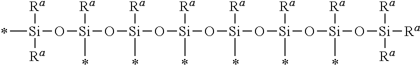

Q^{b6} represents an alkylene group, or a group having an etheric oxygen atom or a divalent organo(poly)siloxane residue between carbon atoms of an alkylene group having two or more carbon atoms.

The number of carbon atoms in the alkylene group represented by Q^{b6} is preferably from 1 to 30, more preferably from 1 to 20, still more preferably from 2 to 20, and may be from 2 to 10, and may be from 2 to 6. The number may be, for example, 2, 3, 8, 9, or 11. The number of carbon atoms may also be from 1 to 10.

The number of carbon atoms in the group having an etheric oxygen atom or a divalent organo(poly)siloxane residue between carbon atoms of the alkylene group having two or more carbon atoms represented by Q^{b6} is preferably from 2 to 20, more preferably from 2 to 10, and still more preferably from 2 to 6.

From the viewpoint of ease of production of the compound, Q^{b6} is preferably —CH₂CH₂— or —CH₂CH₂CH₂—.
w2 instances of [-Q^{b6}-Si(R²)ₙL₃₋ₙ] may be the same or different.

In group (3-1A-7), Z^{c} represents a (w3+w4+1)-valent hydrocarbon group.
w3 represents an integer that is 4 or higher.
w4 represents an integer that is 0 or higher.

The definitions and preferred ranges of Q^{e}, s4, Q^{a4}, t4, Q^{b4}, and u4 are the same as the definitions of the respective reference signs in group (3-1A-4).

Z^{c} may be composed of a hydrocarbon chain, or may have an etheric oxygen atom between carbon atoms of a hydrocarbon chain, and is preferably composed of a hydrocarbon chain.

The valence of Z^{c} is preferably from 5 to 20, more preferably from 5 to 10, still more preferably from 5 to 8, and particularly preferably from 5 to 6.

The number of carbon atoms in Z^{c} is preferably from 3 to 50, more preferably from 4 to 40, and still more preferably from 5 to 30.
w3 is preferably from 4 to 20, more preferably from 4 to 16, still more preferably from 4 to 8, and particularly preferably 4 or 5.
w4 is preferably from 0 to 10, more preferably from 0 to 8, still more preferably from 0 to 6, particularly preferably from 0 to 3, and most preferably from 0 to 1.

When two or more instances of [—(O-Q^{b4})ᵤ₄-Si(R²)ₙL₃₋ₙ] are present, the two or more instances of [—(O-Q^{b4})ᵤ₄-Si(R²)ₙL₃₋ₙ] may be the same or different.

A in formula A(Si(R²)ₙL₃₋ₙ)_{q1} may be any of groups (g2-1) to (g2-7).

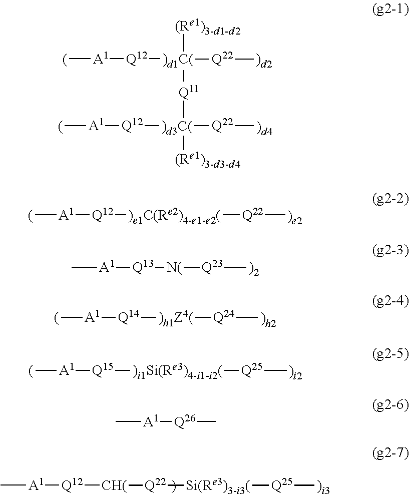

In the formulae (g2-1) to (g2-7), the A¹ side is bonded to Si(R³)₂, Si(R^{d})₂, or B¹¹, and the Q²², Q²³, Q²⁴, Q²⁵, or Q²⁶ side is bonded to [—Si(R²)ₙL₃₋ₙ].
A¹ represents a single bond, —C(O)NR⁶—, —C(O)—, —OC(O)O—, —NHC(O)O—, —NHC(O)NR⁶—, —O— or SO₂NR⁶—.
Q¹¹ represents a single bond, —O—, an alkylene group, or a group having —C(O)NR⁶—, —C(O)—, —NR⁶—, or —O— between carbon atoms of an alkylene group having two or more carbon atoms.
Q¹² represents a single bond, an alkylene group, or a group having —C(O)NR⁶—, —C(O)—, —NR⁶—, or —O— between carbon atoms of an alkylene group having two or more carbon atoms. When A has two or more Q¹²s, the two or more instances of Q¹²s may be the same or different.
Q¹³ represents a single bond (when A¹ represents —C(O)—), an alkylene group, a group having —C(O)NR⁶—, —C(O)—, —NR⁶—, or —O— between carbon atoms of an alkylene group having two or more carbon atoms, or a group having —C(O)— at the N-side terminal of an alkylene group.
Q¹⁴ is the same as Q¹² when the atom in Z⁴ to which Q¹⁴ is bonded is a carbon atom, and is the same as Q¹³ when the atom in Z⁴ to which Q¹⁴ is bonded is a nitrogen atom. When A has two or more Q¹⁴s, the two or more Q¹⁴s may be the same or different.
Q¹⁵ represents an alkylene group, or a group having —C(O)NR⁶—, —C(O)—, —NR⁶—, or —O— between carbon atoms of an alkylene group having two or more carbon atoms. When A has two or more Q¹⁵s, the two or more Q¹⁵s may be the same or different.
Q²² represents an alkylene group; a group having —C(O)NR⁶—, —C(O)—, —NR⁶—, or —O— between carbon atoms of an alkylene group having two or more carbon atoms; a group having —C(O)NR⁶—, —C(O)—, —NR⁶—, or —O— at the terminal of an alkylene group on the side not bonded to Si; or a group having —C(O)NR⁶—, —C(O)—, —NR⁶—, or —O— between carbon atoms of an alkylene group having two or more carbon atoms, as well as having —C(O)NR⁶—, —C(O)—, —NR⁶—, or —O— at the terminal on the side not bonded to Si. When A has two or more Q²²s, the two or more Q²²s may be the same or different.
Q²³ represents an alkylene group, or a group having —C(O)NR⁶—, —C(O)—, —NR⁶—, or —O— between carbon atoms of an alkylene group having two or more carbon atoms, wherein two Q²³s may be the same or different.
Q²⁴ is the same as Q²² when the atom in Z⁴ to which Q²⁴ is bonded is a carbon atom, and is the same as Q²³ when the atom in Z⁴ to which Q²⁴ is bonded is a nitrogen atom. When A has two or more Q²⁴s, the two or more Q²⁴s may be the same or different.
Q²⁵ represents an alkylene group, or a group having —C(O)NR⁶—, —C(O)—, —NR⁶—, or —O— between carbon atoms of an alkylene group having two or more carbon atoms. When A has two or more Q²⁵s, the two or more Q²⁵s may be the same or different.
Q²⁶ represents an alkylene group, or a group having —C(O)NR⁶—, —C(O)—, —NR⁶—, or —O— between carbon atoms of an alkylene group having two or more carbon atoms.

When Q²², Q²³, Q²⁴, Q²⁵, or Q²⁶ represents an alkylene group, the number of carbon atoms thereof is preferably from 1 to 20, more preferably from 1 to 10, and still more preferably from 1 to 6.
Z⁴ represents a group having a (h1+h2)-valent ring structure that has a carbon atom or a nitrogen atom to which Q¹⁴ is directly bonded and that has a carbon atom or a nitrogen atom to which Q²⁴ is directly bonded.
R^{e1} represents a hydrogen atom or an alkyl group. When A has two or more R^{e1}s, the two or more R^{e1}s may be the same or different.
R^{e2} represents a hydrogen atom, a hydroxy group, an alkyl group, or an acyloxy group.
R^{e3} represents an alkyl group. R⁶ represents a hydrogen atom, an alkyl group having from 1 to 6 carbon atoms, or a phenyl group.
d1 represents an integer from 0 to 3, which is preferably 1 or 2.
d2 represents an integer from 0 to 3, which is preferably 1 or 2.
d1+d2 is an integer from 1 to 3.
d3 represents an integer from 0 to 3, which is preferably 0 or 1.
d4 represents an integer from 0 to 3, which is preferably 2 or 3.
d3+d4 is an integer from 1 to 3.
d1+d3 is an integer from 1 to 5, which is preferably 1 or 2.
d2+d4 is an integer from 1 to 5, which is preferably 4 or 5.
e1+e2 is 3 or 4.
e1 represents an integer from 1 to 3, which is preferably 1 or 2.
e2 represents an integer from 1 to 3, which is preferably 2 or 3.
h1 represents an integer that is 1 or more, which is preferably 1 or 2.
h2 represents an integer that is 1 or more, which is preferably 2 or 3.
i1+i2 represents 3 or 4.
i1 represents an integer from 1 to 3, which is preferably 1 or 2.
i2 represents an integer from 1 to 3, which is preferably 2 or 3.
i3 represents 2 or 3.

The number of carbon atoms in the alkylene groups represented by Q¹¹, Q¹², Q¹³, Q¹⁴, Q¹⁵, Q²², Q²³, Q²⁴, Q²⁵, and Q²⁶ is preferably from 1 to 30, more preferably from 1 to 20, still more preferably from 2 to 20, and may be from 2 to 10, and may be from 2 to 6, from the viewpoint of ease of production of the compound, and superior abrasion resistance of the surface treatment layer. The number may be, for example, 2, 3, 8, 9, or 11. The number of carbon atoms may also be from 1 to 10, may be from 1 to 6, or may be from 1 to 4. Here, when a specific linkage is present between carbon atoms, the lower limit value of the number of carbon atoms in the alkylene group is 2.

Examples of the ring structure in Z⁴ include the ring structures described above. The same applies to the preferred aspects. Since Q¹⁴ and Q²⁴ are directly bonded to the ring structure in Z⁴, the ring structure cannot be bonded to, for example, an alkylene group, to which Q¹⁴ or Q²⁴ is bonded.

The number of carbon atoms in the alkyl group represented by Rel, R^{e2}, or R^{e3} is preferably from 1 to 6, more preferably from 1 to 3, and particularly preferably 1 or 2, from the viewpoint of ease of production of the compound.

The number of carbon atoms in the alkyl group moiety of the acyloxy group represented by R^{e2} is preferably from 1 to 6, more preferably from 1 to 3, and particularly preferably 1 or 2, from the viewpoint of ease of production of the compound.

From the viewpoint of ease of production of the compound and superior abrasion resistance of the surface treatment layer, h1 is preferably from 1 to 6, more preferably from 1 to 4, still more preferably 1 or 2, and particularly preferably 1.

From the viewpoint of ease of production of the compound and superior abrasion resistance of the surface treatment layer, h2 is preferably from 2 to 6, more preferably from 2 to 4, and particularly preferably 2 or 3.

Examples of other aspects of A in formula A(Si(R²)ₙL₃₋ₙ)_{q1} include groups (g2-8) to (g2-14).

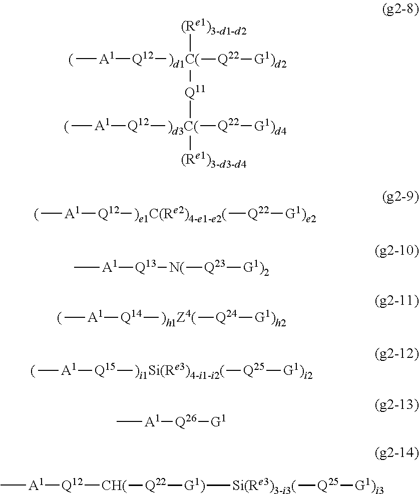

In the formulae (g2-8) to (g2-14), the A¹ side is bonded to Si(R³)₂, Si(R^{d})₂, or B¹¹ and the G¹ side is bonded to [—Si(R²)ₙL₃₋ₙ].
G¹ represents the following group (g3). Two or more G¹s present in A may be the same or different. Reference signs other than G¹ are the same as the reference signs in the formulae (g2-1) to (g2-7).

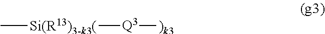

In group (g3), the Si side is bonded to Q²², Q²³, Q²⁴, Q²⁵, or Q²⁶, and the Q³ side is bonded to [—Si(R²)ₙL₃₋ₙ]. R¹³ represents an alkyl group. Q³ represents an alkylene group, a group having —C(O)NR⁶—, —C(O)—, —NR⁶— or —O— between carbon atoms of an alkylene group having two or more carbon atoms, or (OSi(R)₂)ₚ—O—. Two or more Q³s may be the same or different. k3 represents 2 or 3. R⁶ represents a hydrogen atom, an alkyl group having from 1 to 6 carbon atoms, or a phenyl group. R⁹ represents an alkyl group, a phenyl group, or an alkoxy group. Two R⁹s may be the same or different. p represents an integer from 0 to 5. When p is 2 or more, the two or more instances of (OSi(R⁹)₂) may be the same or different.

The number of carbon atoms in the alkylene group represented by Q³ is preferably from 1 to 30, more preferably from 1 to 20, still more preferably from 2 to 20, and may be from 2 to 10, and may be from 2 to 6, from the viewpoint of ease of production of the compound and superior abrasion resistance of the surface treatment layer. The number may be, for example, 2, 3, 8, 9, or 11. The number of carbon atoms may also be from 1 to 10, and may be from 1 to 6, or may be from 1 to 4. When a specific linkage is present between carbon atoms, the lower limit value of the number of carbon atoms in the alkylene group is 2.

The number of carbon atoms in the alkyl group represented by R¹³ is preferably from 1 to 6, more preferably from 1 to 3, and particularly preferably 1 or 2, from the viewpoint of ease of production of the compound.

The number of carbon atoms in the alkyl group represented by R⁹ is preferably from 1 to 6, more preferably from 1 to 3, and particularly preferably 1 or 2, from the viewpoint of ease of production of the compound.

The number of carbon atoms in the alkoxy group represented by R⁹ is preferably from 1 to 6, more preferably from 1 to 3, and particularly preferably 1 or 2, from the viewpoint of excellent shelf stability of the compound.
p is preferably 0 or 1.

### [Examples of First Compound and Second Compound]

Hereinafter, specific examples of the first compound and the second compound will be described in detail.

Specific examples of the first compound include the following compounds (1) to (3), (4A), and (5).

Specific examples of the second compound include the following compound (4B).

### Compound (1)

A compound that contains the following group 1a, a chain organo(poly)siloxane residue, a partial structure that is an alkylene chain having three or more carbon atoms or a polyalkylene oxide chain, and the following group 1b.

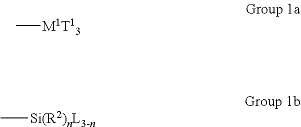

M¹ represents Si, Sn, or Ge,
each T¹ independently represents a hydrocarbon group or a trialkylsilyloxy group,
each R² independently represents a monovalent hydrocarbon group,
each L independently represents a hydrolyzable group, a group having a hydrolyzable group, or a hydroxy group, and
each n independently represents an integer from 0 to 2.
R², L, and n are the same as R², L, and n in formula (S1) above.

Details of the group 1a are the same as the details of T¹₃M¹-discussed in relation to T¹¹ in formula (C).

### Compound (2)

A compound that contains an alkyl group having two or more carbon atoms, a chain organo(poly)siloxane residue, and a reactive silyl group.

### Compound (3)

A compound that contains the following group 3a, a partial structure that contains a divalent chain organo(poly)siloxane residue, and the following group 3b, wherein the partial structure is a divalent chain organo(poly)siloxane residue, or a combination of a divalent chain organo(poly)siloxane residue with at least one of an alkylene chain or a polyalkylene oxide chain.

Group 3a: a monovalent cyclic polysiloxane residue or a monovalent cage-structured polysiloxane residue

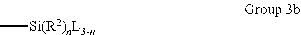

Each R² independently represents a monovalent hydrocarbon group;
each L independently represents a hydrolyzable group, a group having a hydrolyzable group, or a hydroxy group; and
each n independently represents an integer from 0 to 2.
R², L, and n are the same as R², L, and n in formula (S1) above.

### Compounds (4A) and (4B)

Compounds represented by the following formula (4A) or (4B).

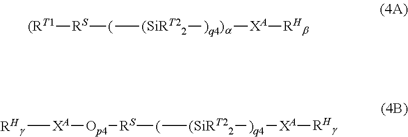

In formulae (4A) and (4B),
each R^{S} independently represents a divalent linear organosiloxane group,
each R^{T1} independently represents a hydrocarbon group,
each R^{T2} independently represents a hydrocarbon group,
p4 represents 0 or 1,
each q4 independently represents 0 or 1,
R^{H} is a group represented by any one of the following formulae (W1) to (W4),
R^{H} contains two or more Si atoms to each of which a hydroxy group or a hydrolyzable group is bonded,
each X^{A} independently represents a single bond or a group represented by the following formula (W5),
α represents an integer from 1 to 9,
β represents an integer from 1 to 9, and
each γ independently represents an integer from 1 to 9.

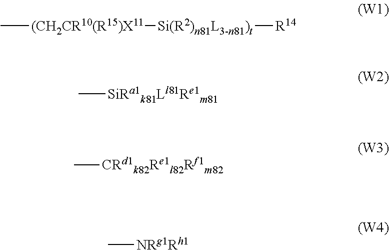

In formulae (W1) to (W4),
each L independently represents a hydrolyzable group, a group having a hydrolyzable group, or a hydroxy group,
each R² independently represents a monovalent hydrocarbon group,
each n₈₁ independently represents an integer from 0 to 3 for each (SiR²ₙ₈₁L₃₋ₙ₈₁) unit,
each X¹¹ independently represents a single bond or a divalent organic group,
each R¹⁰ independently represents a hydrogen atom or a monovalent organic group,
each t independently represents an integer that is 2 or higher,
each R¹⁴ independently represents a hydrogen atom, a halogen atom, or —X¹¹—Si(R²)ₙ₈₁L₃₋ₙ₈₁,
each R¹⁵ independently represents a single bond, an oxygen atom, an alkylene group having from 1 to 6 carbon atoms, or an alkyleneoxy group having from 1 to 6 carbon atoms,
each R^{a1} independently represents —Z⁸¹—SiR²¹ₚ₈₁L_{q81}R²³ᵣ₈₁,
each Z⁸¹ independently represents a divalent organic group,
each R²¹ independently represents —Z^{1′}—SiR^{21′}_{p1′}L_{q1′}R^{23′}_{r1′},
each R²³ independently represents a monovalent organic group,
each p81 independently represents an integer from 0 to 3,
each q81 independently represents an integer from 0 to 3,
each r81 independently represents an integer from 0 to 3,
p81+q81+r81 is 3,
each Z^{1′} independently represents a divalent organic group,
each R^{21′} independently represents —Z^{1″}-SiL_{q1″}R^{23″}_{r1″},
each R^{23′} independently represents a monovalent organic group,
each p1′ independently represents an integer from 0 to 3,
each q1′ independently represents an integer from 0 to 3,
each r1′ independently represents an integer from 0 to 3,
p1′+q1′+r1′ is 3,
each Z^{1″} independently represents a divalent organic group,
each R^{23″} independently represents a monovalent organic group,
each q1″ independently represents an integer from 0 to 3,
each r1″ independently represents an integer from 0 to 3,
q1″+r1″ represents 3,
each R^{c1} independently represents a monovalent organic group,
each k81 independently represents an integer from 0 to 3,
each l81 independently represents an integer from 0 to 3,
each m81 independently represents an integer from 0 to 3,
k81+l81+m81 is 3,
each R^{d1} independently represents —Z⁸²—CR⁷¹ₚ₈₂R⁷²_{q82}R⁷³ᵣ₈₂,
each Z⁸² independently represents a single bond, an oxygen atom, or a divalent organic group,
each R⁷¹ independently represents —Z^{2′}—CR^{32′}_{q2′}R^{33′}_{r2′},
each R⁷² independently represents —Z⁸³—SiLₙ₈₂R³⁵₃₋ₙ₈₂,
each R⁷³ independently represents a hydrogen atom, a hydroxy group, or a monovalent organic group,
each p82 independently represents an integer from 0 to 3,
each q82 independently represents an integer from 0 to 3,
each r82 independently represents an integer from 0 to 3,
p82+q82+r82 is 3,
each Z^{2′} independently represents a single bond, an oxygen atom, or a divalent organic group,
each R^{32′} independently represents —Z⁸³—SiLₙ₈₂R³⁵₃₋ₙ₈₂.
each R^{33′} independently represents a hydrogen atom, a hydroxy group, or a monovalent organic group,
each q2′ independently represents an integer from 0 to 3,
each r2′ independently represents an integer from 0 to 3,
q2′+r2′ is 3,
each Z⁸³ independently represents a single bond, an oxygen atom, or a divalent organic group,
each R³⁵ independently represents a monovalent organic group,
each n82 independently represents an integer from 0 to 3,
each R^{c1} independently represents —Z⁸³—SiLₙ₈₂R³⁵₃₋ₙ₈₂,
each R^{f1} independently represents a hydrogen atom, a hydroxy group, or a monovalent organic group,
each k82 independently represents an integer from 0 to 3,
each l82 independently represents an integer from 0 to 3, and
each m82 independently represents an integer from 0 to 3.
k82+l82+m82 is 3,
each of R^{g1} and R^{h1} independently represents —Z⁸⁴—SiLₙ₈₁R²₃₋ₙ₈₁, —Z⁸⁴. SiR^{a1}ₖ₈₁Lₗ₈₁R^{c1}ₘ₈₁, or —Z⁸⁴—CR^{d1}ₖ₈₂R^{c1}ₗ₈₂R^{f1}ₘ₈₂,
each Z⁸⁴ independently represents a single bond, an oxygen atom, or a divalent organic group,
with the proviso that, in formulae (W1), (W2), (W3), and (W4), at least two Si atoms to each of which a hydrolyzable group, a group having a hydrolyzable group, or a hydroxy group is bonded are present.
R² and L are the same as R² and L in the formula (S1) above.

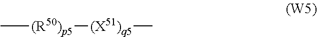

In formula (W5),
R⁵⁰ represents a single bond, —(CH₂)ₛ₅— or an o-, m- or p-phenylene group,
s5 represents an integer from 1 to 20,
X⁵¹ represents —(X⁵²)ₗ₅—,
X⁵² for each occurrence independently represents a group selected from the group consisting of —O—, —S—, an o-, m-, or p-phenylene group, —CO—, —C(O)O—, —CONR⁵⁴—, —O—CONR⁵⁴—, —NR⁵⁴— and —(CH₂)ₙ₅—,
R⁵⁴ for each occurrence independently represents a hydrogen atom or a monovalent organic group,
n5 for each occurrence independently represents an integer from 1 to 20,
l5 represents an integer from 1 to 10,
p5 represents 0 or 1,
q5 represents 0 or 1,
at least either p5 or q5 represents 1, and the order of occurrence of (R⁵⁰)ₚ₅ and (X⁵¹)_{q5} is freely selectable.

It is preferred that each X^{A} independently represents a single bond, an alkylene group having from 1 to 20 carbon atoms, —(CH₂)ₛ₅—X⁵³—, —X⁵³—(CH₂)ₜ₅—, or —(CH₂)ₛ₅—X³³—(CH₂)ₜ₅—.

It is preferred that X⁵³ represents a single bond, —O—, —CO—, —CONR⁵⁴—, —O—CONR⁵⁴—, —O—(CH₂)ᵤ₅—CONR⁵⁴—, or —O—(CH₂)ᵤ₅—CO—;
R⁵⁴ for each occurrence independently represents a hydrogen atom, a phenyl group, an alkyl group having from 1 to 6 carbon atoms, or an oxyalkylene-containing group having from 1 to 10 carbon atoms,
s5 represents an integer from 1 to 20,
t5 represents an integer from 1 to 20, and
u5 represents an integer from 1 to 20.

### Compound (5)

A compound represented by the following formula (5).

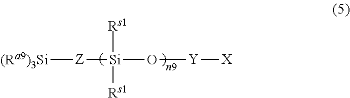

In formula (5),
Y represents a single bond or *—Si(R^{s2})₂-L^{s1}-. * indicates a bonding site with the oxygen atom.
Z represents an oxygen atom, or a divalent hydrocarbon group having from 1 to 10 carbon atoms.

Each R^{a9} independently represents a hydrocarbon group or a trialkylsilyloxy group. When all of R^{a9}s represent hydrocarbon groups, the hydrocarbon group represented by R^{a9} is an alkyl group.

Each of R^{s1} and R^{s2} independently represents an alkyl group having from 1 to 10 carbon atoms.
L^{s1} represents a divalent hydrocarbon group having from 1 to 10 carbon atoms.
X represents a group represented by any of the following formulae (X-1) to (X-3).
n9 represents a number from 1 to 150.

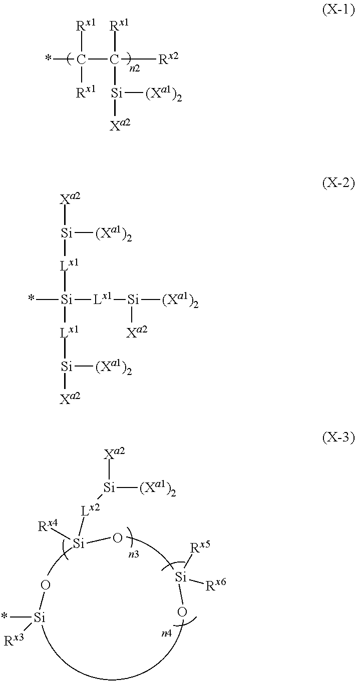

In formulae (X-1) to (X-3),
each of L^{x1} and L^{x2} independently represents a divalent hydrocarbon group having from 1 to 20 carbon atoms. A methylene group (—CH₂—) contained in the divalent hydrocarbon group may be substituted with —O— or —O—Si(R^{x7})₂—.

Each of R^{x1} to R^{x7} independently represents a hydrogen atom, or a hydrocarbon group having from 1 to 10 carbon atoms.

Each X^{a1} independently represents a hydrolyzable group, a group having a hydrolyzable group, or a trialkoxysilyloxy group.

Each X^{a2} independently represents a trialkylsilyl-containing group, a hydrocarbon chain-containing group, a siloxane skeleton-containing group, a hydrolyzable group, a group having a hydrolyzable group, or a trialkoxysilyloxy group. When X^{a2} represents a hydrolyzable group, X^{a2} and X^{a1} may be the same or different.
n2 represents an integer from 1 to 50.
n3 represents a number from 2 to 5.
n4 represents a number from 0 to 5.

In formula (X-3), the sequential order of the units represented by (Si(R^{x4})(-L^{x2}-Si(X^{a2})(X^{a1})₂)—O—) and (Si(R^{x5})(R^{x6})—O—) is freely selectable.

Hereinafter, the compounds (1) to (5) will be described.

### (Compound (1))

The compound (1) is preferably represented by the following formula (1A):

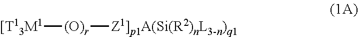

In formula (1A),
M¹ represents Si, Sn, or Ge,
each T¹ independently represents a hydrocarbon group or a trialkylsilyloxy group,
r represents 0 or 1,
each Z¹ independently represents an alkylene chain or a polyalkylene oxide chain, or a combination of an alkylene chain with a divalent chain organo(poly)siloxane residue; A represents a single bond or a (p1+q1)-valent linking group,
each R² independently represents a monovalent hydrocarbon group,
each L independently represents a hydrolyzable group, a group having a hydrolyzable group, or a hydroxy group,
each n independently represents an integer from 0 to 2, and
each of p1 and q1 independently represents an integer that is 1 or higher.

Here, when each Z¹ independently represents an alkylene chain or a polyalkylene oxide chain, A represents a (p1+q1)-valent linking group that contains a chain organo(poly)siloxane residue.
T¹ and M¹ are the same as T¹ and M¹ in the group 1a, and therefore, description thereof is omitted.
M¹ is preferably Si.
T¹ is preferably a trialkylsilyloxy group, and more preferably a butyldimethylsilyloxy group, a trimethylsilyloxy group, or a triethylsilyloxy group.
R², L, and n are the same as R², L, and n in formula (S1) above.

The combination of an alkylene chain and a divalent chain organo(poly)siloxane residue represented by Z¹ is preferably represented by the following formula (D3), (D4), or (D5).

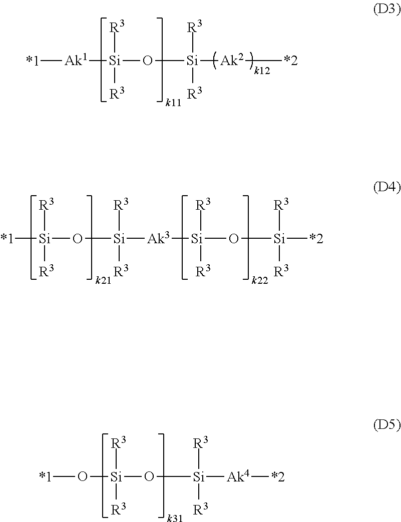

In formula (D3), each of Ak¹ and Ak² independently represents an alkylene chain. R³ is the same as R³ in formula (B1). k11 represents a number that is 1 or higher. k12 represents 0 or 1.

In formula (D4), Ak³ represents an alkylene chain. R³ is the same as R³ in formula (B1). Each of k21 and k22 independently represents a number that is 1 or higher.

In formula (D5), Ak⁴ represents an alkylene chain. R³ is the same as R³ in formula (B1), k31 represents a number that is 1 or higher.

In formula (D3), (D4), or (D5), *1 is bonded to the side of group 1a, and *2 is bonded to the side of group 1b.

A may be any group that does not impair the effects of the present disclosure, and examples thereof include an alkylene group optionally having an etheric oxygen atom or a divalent chain organo(poly)siloxane residue, a carbon atom, a nitrogen atom, a silicon atom, a 2- to 8-valent organo(poly)siloxane residue, and a group that remains after removing Si(R²)ₙL₃₋ₙ from group (3-1A), group (3-1B), and groups (3-1A-1) to (3-1A-7).

A may contain a triptycene structure. A triptycene structure refers to a partial structure that remains after removing two or more hydrogen atoms from triptycene.

A may also be any of groups (g2-1) to (g2-14).
p1 represents an integer that is 1 or higher. From the viewpoint of superior water repellency of the surface treatment layer, p1 is preferably from 1 to 6, and more preferably from 2 to 4. p1 may be 1.

When p1 represents 2 or more, the multiple instances of [T¹₃M¹-(O)ᵣ—Z¹] may be the same or different.
q1 represents an integer that is 1 or higher. From the viewpoint of superior abrasion resistance of the surface treatment layer, q1 is preferably from 1 to 15, more preferably from 1 to 6, further preferably from 2 to 6, particularly preferably from 2 to 4, and highly preferably 2 or 3. q1 may be 1.

When q1 is 2 or more, the multiple instances of [Si(R²)ₙL₃₋ₙ] may be the same or different.

Preferred aspects of the group A(Si(R²)ₙL₃₋ₙ)_{q1} in formula (1A) are the same as the preferred aspects of the group A(Si(R²)ₙL₃₋ₙ)_{q1} described above in the section titled “Partial Structures of First Compound, Second Compound, and Compound (E)”. Here, A in the group A(Si(R²)ₙL₃₋ₙ)_{q1} is bonded to [T¹₃M¹-(O)ᵣ—Z¹]ₚ₁ in formula (1A). When the terminal of Z¹ on the side bonded to A is an alkylene chain, the terminal of A on the side bonded to Z¹ is not an alkylene chain. When the terminal of Z¹ on the side bonded to A is a polyalkylene oxide chain, the terminal of A on the side bonded to Z¹ is not a polyalkylene oxide chain.

The compound (1) is preferably a compound represented by the following formula (1B).

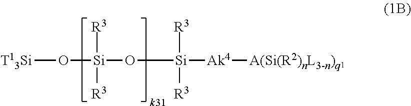

In formula (1B), T¹ is the same as T¹ in the group 1a.
R³ is the same as R³ in formula (B1). k31 is the same as k31 in formula (D5).

The group represented by A(Si(R²)ₙL₃₋ₙ)_{q1} is the same as the group represented by A(Si(R²)ₙL₃₋ₙ)_{q1} in formula (1A).
Ak⁴ is the same as Ak⁴ in formula (D5).

The compound (1) is preferably a compound represented by the following formula (1C), formula (1D), or formula (1E).

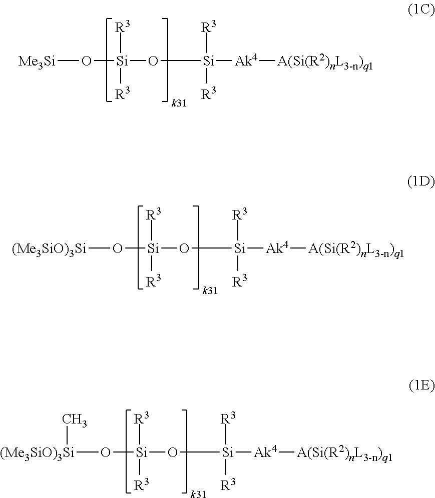

R³ in formula (1C), formula (1D), and formula (1E) is the same as R³ in formula (B¹). k31 is the same as k31 in formula (D5).

The group represented by A(Si(R²)ₙL₃₋ₙ)_{q1} is the same as the group represented by A(Si(R²)ₙL₃₋ₙ)_{q1} in formula (1A).
Ak⁴ is the same as Ak⁴ in formula (D5).

Specific examples of the compound (1) include the following compounds.

In the following formulae, n10 represents a number that is 1 or higher, preferably a number from 1 to 60, and may be a number from 3 to 50, a number from 5 to 30, or a number from 7 to 25.

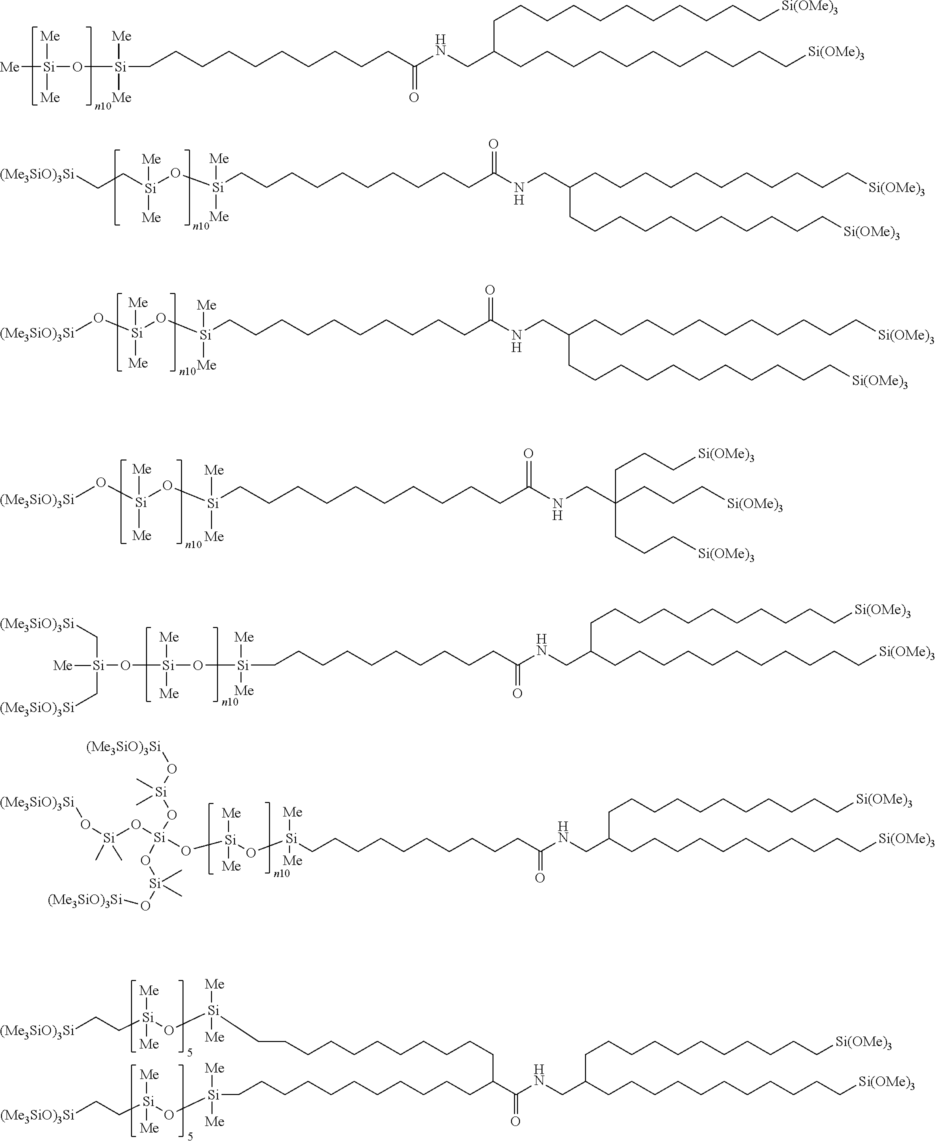

In the formula below, k is preferably from 1 to 80, more preferably from 3 to 50, and still more preferably from 3 to 30. m is preferably from 1 to 30, more preferably from 3 to 20, and still more preferably from 3 to 10. t is preferably from 1 to 30, more preferably from 3 to 20, and still more preferably from 3 to 10.

In the following formulae, n10 represents a number that is 1 or higher, preferably a number from 1 to 60, and may be a number from 3 to 50, a number from 5 to 30, or a number from 7 to 25.

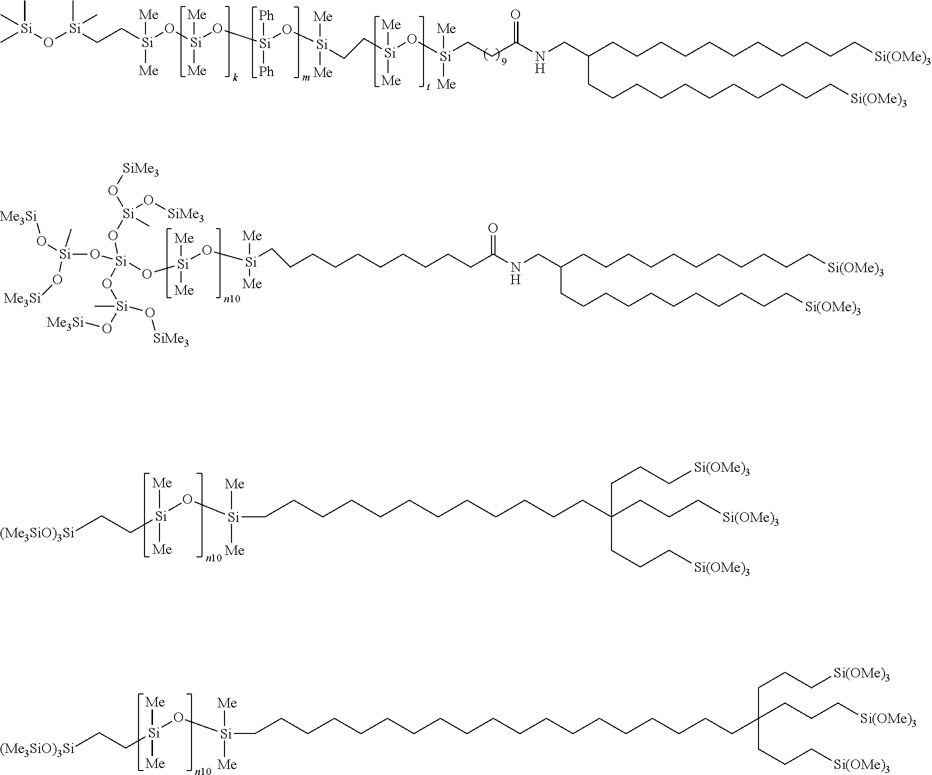

In the following formulae, n10 represents a number that is 1 or higher, preferably a number from 1 to 60, and may be a number from 3 to 50, a number from 5 to 30, or a number from 7 to 25.

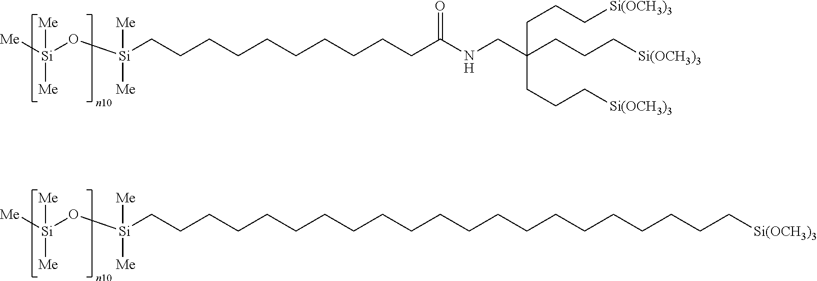

### (Compound (2))

In the compound (2), the alkyl group means an unsubstituted alkyl group. The alkyl group may be any of a linear alkyl group, a branched alkyl group, or a cyclic alkyl group, and a linear alkyl group or a branched alkyl group is preferred. The number of carbon atoms in the alkyl group is preferably from 2 to 30, more preferably from 3 to 28, and still more preferably from 4 to 22.

The compound may contain only one alkyl group, or two or more alkyl groups.

Since an alkyl group is a monovalent group, the alkyl group is located at a terminal of the compound.

The compound (2) is preferably a compound represented by the following formula (2A):

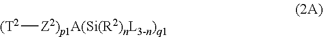

In formula (2A),
T² represents an alkyl group having two or more carbon atoms,
Z² represents a divalent chain organo(poly)siloxane residue,
A represents a single bond or a (p1+q1)-valent linking group,
each R² independently represents a monovalent hydrocarbon group,
each L independently represents a hydrolyzable group, a group having a hydrolyzable group, or a hydroxy group,
n represents an integer from 0 to 2, and
each of p1 and q1 independently represents an integer that is 1 or higher.

Preferred aspects of the alkyl group having two or more carbon atoms represented by T² are as described above.

The divalent chain organo(poly)siloxane residue represented by Z² is preferably the group represented by formula (B1) described above.
R², L, and n are the same as R², L, and n in formula (S1) above.

The group represented by A(Si(R²)ₙL₃₋ₙ)_{q1} is the same as the group represented by A(Si(R²)ₙL₃₋ₙ)_{q1} in formula (1A), except for details given below.
p1 and q1 are the same as p1 and q1 in formula (1A) above.

The group represented by A(Si(R²)ₙL₃₋ₙ)_{q1} is preferably group (3-1A) or group (3-1B), and more preferably group (3-1A).

In formula (3-1A), Q^{a} represents a single bond or a divalent linking group.

Here, the terminal of Q^{a} on the side bonded to Z² is not an oxysilyl group.

In formula (3-1A), X³¹ represents a single bond, an alkylene group, a carbon atom, a nitrogen atom, a silicon atom, a 2- to 8-valent organo(poly)siloxane residue, or a group having a (h+i+1)-valent ring.

When Q^{a} represents a single bond, the terminal of X³¹ on the side bonded to Z² is not an oxysilyl group. In other cases, the terminal of X³¹ may be an oxysilyl group.

In formula (3-1A), Q^{b} represents a single bond or a divalent linking group.

When each of Q^{a} and X³¹ represents a single bond, the terminal of Q^{b} on the side bonded to Z² is not an oxysilyl group. In other cases, the terminal of Q^{b} may be an oxysilyl group.

When his 1, and Q^{b} is an alkylene group, the terminal of Q^{a}-X³¹ on the Q^{b} side is not an alkylene group.

In formula (3-1B), Q^{c} represents a single bond or a divalent linking group.

The terminal of Q^{c} on the side bonded to Z² is not an oxysilyl group.

Group (3-1A) is preferably any of groups (3-1A-1) to (3-1A-7).

Here, each of the terminals of groups (3-1A-1) to (3-1A-7) on the side bonded to Z² is not an oxysilyl group.

In group (3-1A-1), X³² is preferably —O—, —S—, —N(R^{d})—, —C(O)O—, —C(O)S—, —N(R^{d})C(O)N(R^{d})—, —OC(O)N(R^{d})—, or —C(O)N(R^{d})—, and more preferably —C(O)O— or —C(O)N(R^{d})—.
s1 is preferably 0, and Q^{b1} is preferably an alkylene group having from 2 to 6 carbon atoms.

In group (3-1A-2), X³³ is preferably —O—, —C(O)O—, or —C(O)N(R^{d})—.
A in formula (2A) may also be any of groups (g2-1) to (g2-7).

Here, in each of formulae (g2-1) to (g2-7), the A¹ side is bonded to Z², and the Q²², Q²³, Q²⁴, Q²⁵ or Q²⁶ side is bonded to [—Si(R²)ₙL₃₋ₙ].

Examples of other aspects of A include groups (g2-8) to (g2-14).

Here, in each of formulae (g2-8) to (g2-14), the A¹ side is bonded to Z², and the G¹ side is bonded to [—Si(R²)ₙL₃₋ₙ].

The compound (2) is preferably a compound represented by the following formula (2B).

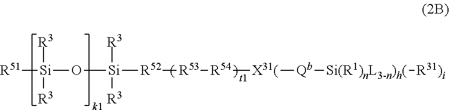

In formula (2B), R⁵¹ represents an alkyl group having two or more carbon atoms.

Each of R⁵² and R⁵⁴ independently represents an alkylene group.
R⁵³ represents —C(O)O—, —SO₂N(R^{d})—, —N(R^{d})SO₂—, —N(R^{d})C(O)—, or —C(O)N(R^{d})—.
R³ is the same as R³ in formula (B1). k1 is the same as k1 in formula (B1).

The group represented by X³¹ (-Q^{b}-Si(R²)ₙL₃₋ₙ)ₕ(—R³¹)ᵢ is the same as the group represented by X³¹ (-Q^{b}-Si(R³)ₙL₃₋ₙ)ₕ(—R³¹)ᵢ in group (3-1A).
t1 is 0 or 1.

Preferred aspects of the alkyl group represented by R⁵¹ are as described above in the section regarding the alkyl group.

The alkylene group represented by R³² may be linear, branched, or cyclic. The number of carbon atoms in the alkylene group is preferably from 1 to 30, more preferably from 1 to 20, still more preferably from 4 to 20, and particularly preferably from 5 to 15.

The alkylene group represented by R⁵⁴ may be linear, branched, or cyclic. The number of carbon atoms in the alkylene group is preferably from 1 to 20, more preferably from 1 to 10, still more preferably from 1 to 6, and particularly preferably from 1 to 3.

Specific examples of the compound (2) include the following compounds. In the following formulae, n10 represents a number that is 1 or higher, preferably a number from 1 to 60, and may be a number from 3 to 50, a number from 5 to 30, or a number from 7 to 25.

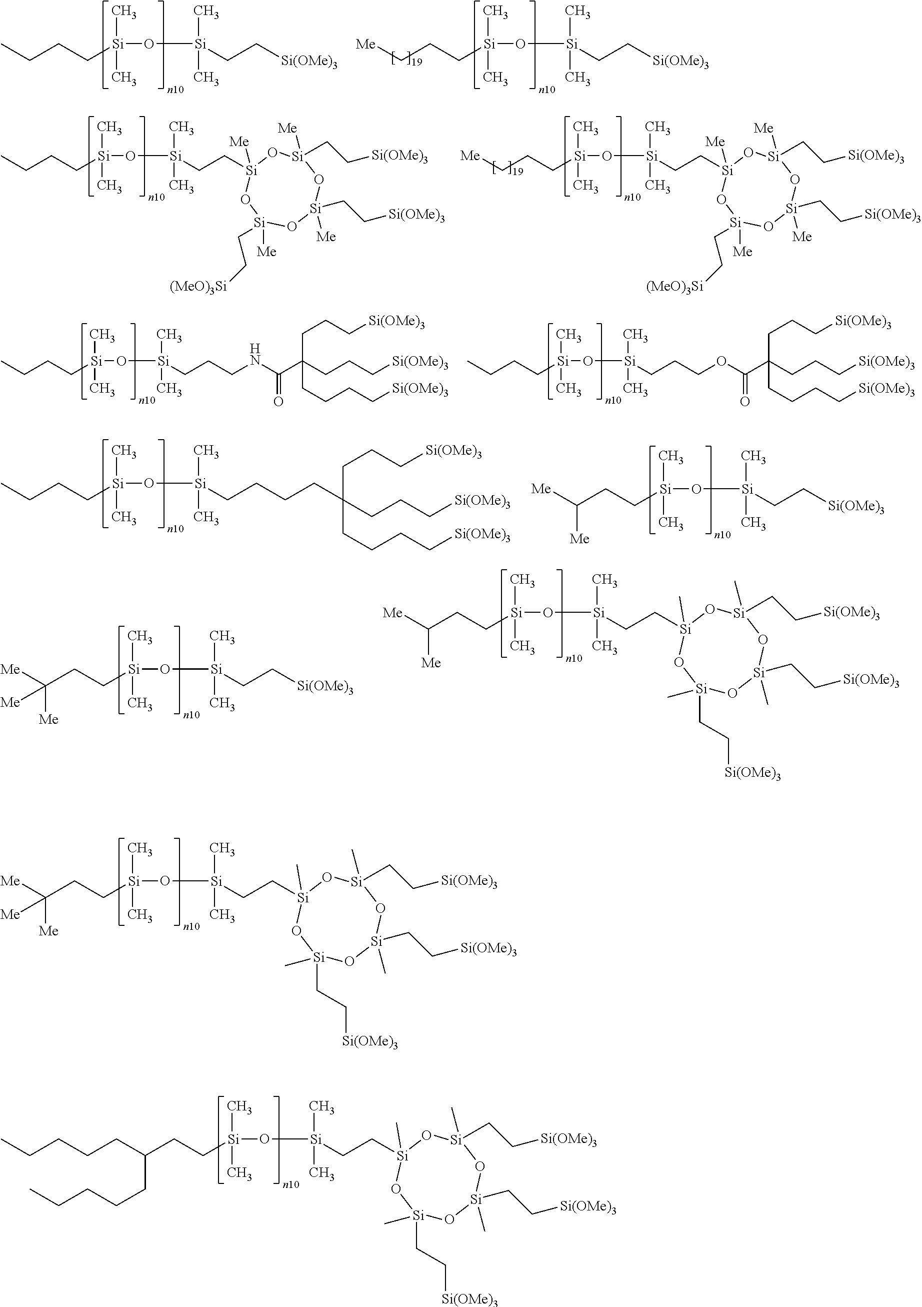

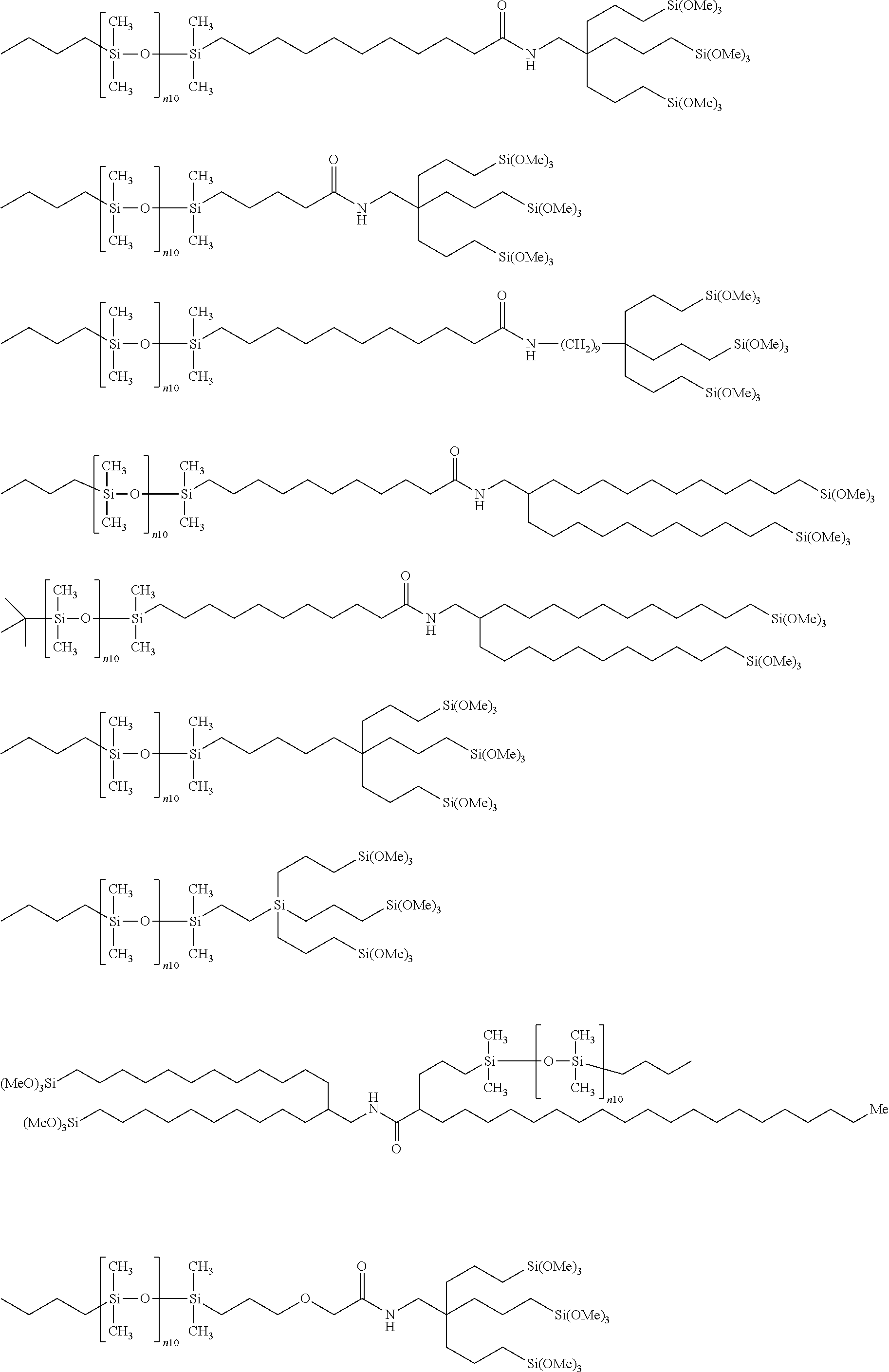

### (Compound (3))

The compound (3) is preferably represented by the following formula (3A):

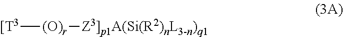

In formula (3A),
T³ represents a monovalent cyclic polysiloxane residue or a monovalent cage-structured polysiloxane residue,
r is 0 or 1,
Z³ represents a divalent chain organo(poly)siloxane residue, or a combination of a divalent chain organo(poly)siloxane residue with at least one of an alkylene chain or a polyalkylene oxide chain,

A represents a single bond or a (p1+q1)-valent linking group,
each R² independently represents a monovalent hydrocarbon group,
each L independently represents a hydrolyzable group, a group having a hydrolyzable group, or a hydroxy group,
n represents an integer from 0 to 2, and
each of p1 and q1 independently represents an integer that is 1 or higher.

R², L, and n are the same as R², L, and n in formula (S1) described above.

The group represented by A(Si(R²)ₙL₃₋ₙ)_{q1} is the same as the group represented by A(Si(R²)ₙL₃₋ₙ)_{q1} in formula (1A), except for the details provided below.
p1 and q1 are the same as p1 and q1 in formula (1A) above.

Details of the monovalent cyclic polysiloxane residue or the monovalent cage-structured polysiloxane residue are as described above in the description regarding T¹¹ in formula (C).

The group represented by A(Si(R²)ₙL₃₋ₙ)_{q1} is preferably group (3-1A) or group (3-1B), and more preferably group (3-1A).

In formula (3-1A), Q^{a} represents a single bond or a divalent linking group.

Here, the terminal of Q^{a} on the side bonded to Z³ is none of an alkylene group, a polyalkylene oxide chain, or a divalent organo(poly)siloxane residue.

When the terminal of Z³ on the A side is an alkylene chain, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—; more preferably —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—; and still more preferably an alkylene group having —C(O)O—, or an alkylene group having —C(O)N(R^{d})—.

When the terminal of Z³ on the A side is a polyalkylene oxide chain, Q^{a} is preferably a divalent hydrocarbon group other than an alkylene group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, or an alkylene group having —SO₂N(R^{d})—, and more preferably —C(O)—.

When the terminal of Z³ on the A side is a divalent chain organo(poly)siloxane residue, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—.

In formula (3-1A), X³¹ represents a single bond, an alkylene group, a carbon atom, a nitrogen atom, a silicon atom, a 2- to 8-valent organo(poly)siloxane residue, or a group having a (h+i+1)-valent ring.

Here, when Q^{a} represents a single bond, the terminal of X³¹ on the side bonded to Z³ is none of an alkylene group, a polyalkylene oxide chain, or a divalent organo(poly)siloxane residue. In other cases, the terminal of X³¹ may be any of an alkylene group, a polyalkylene oxide chain, or a divalent organo(poly)siloxane residue.

In formula (3-1A), Q^{b} represents a single bond or a divalent linking group.

Here, when each of Q^{a} and X³¹ represents a single bond, the terminal of Q^{b} on the side bonded to Z³ is none of an alkylene group, a polyalkylene oxide chain, or a divalent organo(poly)siloxane residue. In other cases, the terminal of Q^{b} may be any of an alkylene group, a polyalkylene oxide chain, or a divalent organo(poly)siloxane residue.

When each of Q^{a}, X³¹, and Q^{b} in formula (3-1A) represents a single bond, [Si(R²)ₙL₃₋ₙ] is directly bonded to Z³, and Z³ represents an alkylene chain.

In formula (3-1B), Q^{c} represents a single bond or a divalent linking group.

Here, the terminal of Q^{e} on the side bonded to Z³ is none of an alkylene group, a polyalkylene oxide chain, or a divalent organo(poly)siloxane residue.

Group (3-1A) is preferably any of groups (3-1A-1) to (3-1A-7).

Here, each of the terminals of groups (3-1A-1) to (3-1A-7) on the side bonded to Z³ is none of an alkylene group, a polyalkylene oxide chain, or a divalent organo(poly)siloxane residue.

When the terminal of Z³ on the A side in group (3-1A-1) is an alkylene chain, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; more preferably —O—, —S—, —N(R^{d})—, —C(O)O—, —C(O)S—, —N(R^{d})C(O)—, —N(R^{d})C(O)N(R^{d})—, —OC(O)N(R^{d})—, or —C(O)N(R^{d})—; and still more preferably —C(O)O— or —N(R^{d})C(O)—.

When the terminal of Z³ on the A side is a polyalkylene oxide chain, X³² is preferably —C(O)—, —C(O)O—, —C(O)S—, —SO₂N(R^{d})—, or —C(O)N(R^{d})—; and more preferably —C(O)—.

When the terminal of Z³ on the A side is a divalent chain organo(poly)siloxane residue, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; and more preferably —O—.

When the terminal of Z³ on the A side is an alkylene chain, it is preferred that s1 is 0 and Q^{b1} is a single bond, or that s1 is 1 and Q^{b1} is an alkylene group having from 2 to 6 carbon atoms.

When the terminal of Z³ on the A side is a polyalkylene oxide chain, it is preferred that s1 is 1 and Q^{b1} is an alkylene group having from 2 to 6 carbon atoms.

When the terminal of Z³ on the A side is a divalent chain organo(poly)siloxane residue, it is preferred that s1 is 1 and Q^{b1} is a single bond.

When the terminal of Z³ on the A side in group (3-1A-2) is an alkylene chain or a divalent chain organo(poly)siloxane residue, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

When the terminal of Z³ on the A side is a polyalkylene oxide chain, X³³ is preferably —C(O)O—, —C(O)S—, —SO₂N(R^{d})—, or —C(O)N(R^{d})—.

A in formula (3A) may also be any of groups (g2-1) to (g2-7).

Here, in each of formulae (g2-1) to (g2-7), the A¹ side is bonded to Z³, and the Q²², Q²³, Q²⁴, Q²⁵ or Q²⁶ side is bonded to [—Si(R²)ₙL₃₋ₙ].

Examples of other aspects of A include groups (g2-8) to (g2-14).

Here, in each of formulae (g2-8) to (g2-14), the A¹ side is bonded to Z³, and the G¹ side is bonded to [—Si(R²)ₙL₃₋ₙ].

Specific examples of the compound (3) include the following compound. In the following formula, n10 represents a number that is 1 or higher, preferably a number from 1 to 60, and may be a number from 3 to 50, a number from 5 to 30, or a number from 7 to 25.

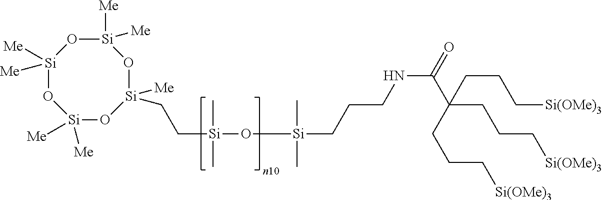

### (Compounds (4A) and (4B))

In the compounds (4A) and (4B), it is more preferred that
each X^{A} independently represents:

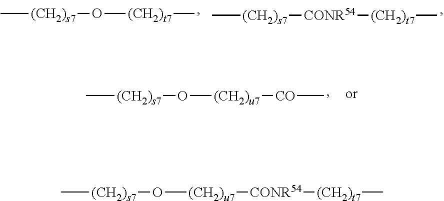

Each R⁵⁴ independently represents a hydrogen atom, a phenyl group, an alkyl group having from 1 to 6 carbon atoms, or an oxyalkylene-containing group having from 1 to 10 carbon atoms,
s7 represents an integer from 1 to 20,
t7 represents an integer from 1 to 20, and
u7 represents an integer from 1 to 20.

Each X^{A} preferably independently represents a group represented by the following formula (W6).

In formula (W6), each X^{a} independently represents a single bond, or a divalent organic group.

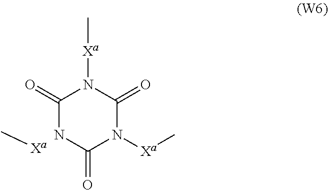

Specific examples of the compound (4A) include the following compound.

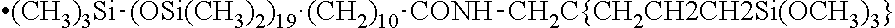

### (Compound (5))

Specific examples of the compound (5) include the following compounds. In the following formulae, n10 is a number that is 1 or higher, preferably a number from 1 to 60, and may be a number from 3 to 50, a number from 5 to 30, or a number from 7 to 25.

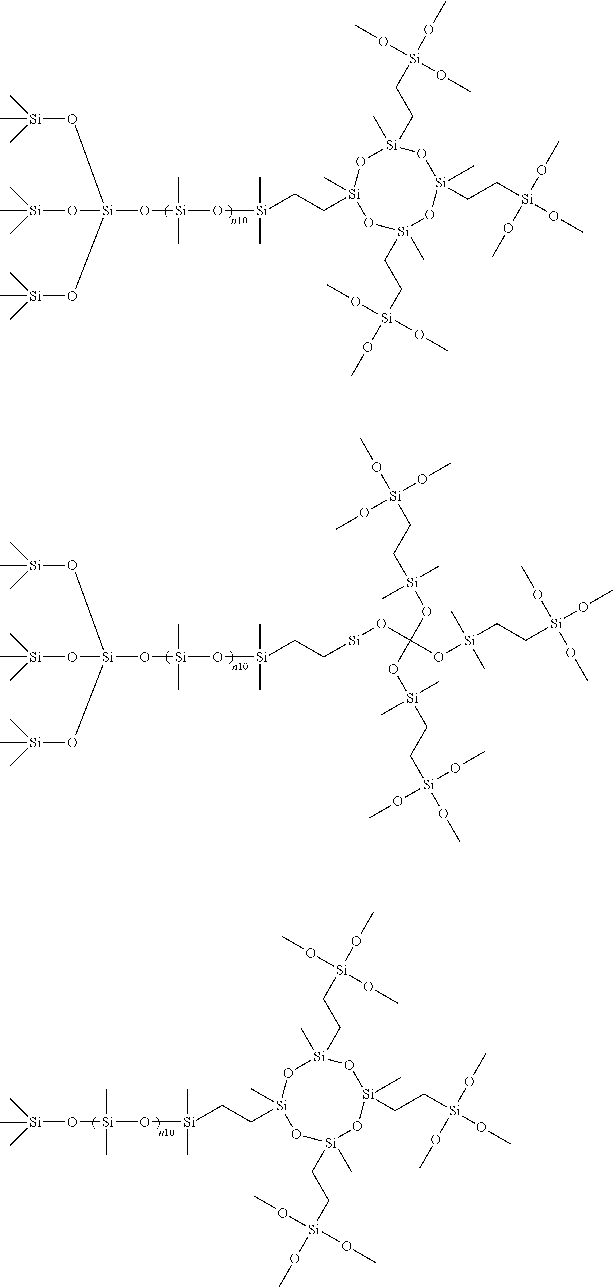

### <Metal Atom>

The composition according to the present disclosure contains a metal atom.

In an aspect, the metal atom preferably includes a transition metal (i.e., any of Groups 3 to 12 elements).

In an aspect, the metal atom preferably includes at least one selected from the group consisting of Al, Ti, V, Cr, Mn, Fe, Co, Ni, Zr, Nb, Mo, Ru, Rh, Pd, Sn, Hf, Ta, W, Ir, Pt, Zn, and Cu; more preferably includes at least one selected from the group consisting of Ti, Cr, Mn, Fe, Co, Ni, Zr, Ru, Rh, Pd, Ir, Pt, Zn, and Cu; may include at least one selected from the group consisting of Mn, Fe, Co, Ru, Rh, Pd, Ir, Pt, Zn, and Cu; may contain at least one selected from the group consisting of Ti, Cr, Mn, Fe, Co, Ni, Zr, Pd, Ir, Zn, and Cu; may contain at least one selected from the group consisting of Mn, Fe, Co, Pd, Ir, Zn, and Cu; may contain at least one selected from the group consisting of Cr, Mn, Fe, Co, Ru, Rh, Pd, Ir, Pt, Zn, and Cu; may contain at least one selected from the group consisting of Cr, Mn, Co, Ni, Ru, Rh, Pd, Ir, Pt, Zn, and Cu; may contain at least one selected from the group consisting of Cr, Mn, Co, Ru, Rh, Pd, Ir, Pt, Zn, and Cu; or may contain at least one selected from the group consisting of Mn, Co, Pd, Ir, Zn, and Cu.

One kind of metal atom may be used singly, or two or more kinds thereof may be used in combination. In an aspect, the composition preferably contains two or more kinds of metal atoms. The composition may contain 2 to 5 kinds, 2 or 3 kinds, or 2 kinds of metal atoms.

In an aspect, when the composition contains two or more kinds of metal atoms, one or more kinds of the metal atoms may be selected from transition metals, two or more kinds of the metal atoms may be selected from transition metals, or all of the metal atoms may be selected from transition metals.

In an aspect, the composition may contain only two kinds of metal atoms, of which one is a transition metal and the other is a metal other than a transition metal. In an aspect, the composition may contain three or more kinds of metal atoms, of which one, two, or three or more may be transition metals.

In an aspect, the composition preferably contains Pt and a metal atom other than Pt. When the composition contains Pt and a metal atom other than Pt, the mass ratio of Pt to the metal atom other than Pt (Pt: metal atom other than Pt) may be 1:1 to 1:1000, 1:5 to 1:500, or 1:10 to 1:200.

The metal atom may be contained as a simple metal in the composition, or as a metal compound (including a metal complex) in the composition. When the metal atom is contained as a metal compound in the composition, the “amount of the metal atom” refers to the amount in ppm by mass in terms of the metal atom. The metal atom is preferably a zero-valent and stable metal atom. Examples of the zero-valent stable metal atom include metal atoms having a lower ionization tendency than Al.

Examples of the metal compound include TiCl₄, Cr(CO)₆, Mn₂(CO)₁₀, Fe(C₅H₅)₂, Co(C₅H₅)₂, bis(1,5-cyclooctadiene) nickel (0) (Ni(COD)₂), zirconium (IV) acetylacetonate (Zr(acac)), Ru₃(CO)₁₂, RhCl₃, tris(dibenzylideneacetone) dipalladium, Ir₄(CO)₁₂, platinum (0)-1,3-divinyl-1,1,3,3-tetramethyldisiloxane complex, and chloroplatinic acid (H₂PtCl₆).

The metal compound may have a hydrolyzable group. Examples of the metal compound having a hydrolyzable group include compounds in which the Si atom of a compound represented by the formula (M1) described later is replaced with the metal atom exemplified above.

In an aspect, the composition preferably contains a simple metal and/or, a metal compound free of a hydrolyzable group.

In an aspect, when the composition contains a metal compound having a hydrolyzable group, the amount of the metal compound having a hydrolyzable group with respect to the total amount of the metal atom contained in the composition is, in terms of the metal, preferably 50% by mass or less, more preferably 20% by mass or less, still more preferably 10% by mass or less, and particularly preferably 5% by mass or less. The composition does not necessarily contain the metal compound having a hydrolyzable group.

The amount of the metal atom is from 10 to 10,000 ppm by mass with respect to the amount of the specific silane compound.

From the viewpoint of obtaining a surface treatment layer excellent in abrasion resistance, the amount of the metal atom is preferably 50 ppm by mass or more, more preferably 100 ppm by mass or more, and may be 200 ppm by mass or more, with respect to the amount of the specific silane compound.

From the viewpoint of obtaining a surface treatment layer excellent in appearance, the amount of the metal atom is preferably 5,000 ppm by mass or less, more preferably 1,000 ppm by mass or less, and may be 500 ppm by mass or less, with respect to the amount of the specific silane compound.

When the composition contains two or more kinds of metal atoms, the amount of each metal atom with respect to the amount of the specific silane compound may be 1 ppm by mass or more, 5 ppm by mass or more, or 10 ppm by mass or more. Alternatively when the composition contains two or more kinds of metal atoms, the amount of each metal atom with respect to the amount of the specific silane compound may be 9,999 ppm by mass or less, may be 5,000 ppm by mass or less, may be 1,000 ppm by mass or less, or may be 500 ppm by mass or less.

In an aspect, in the case in which the composition contains Pt and a metal atom other than Pt, the amount of Pt may be from 1 to 100 ppm by mass, with the amount of the metal atom other than Pt being preferably from 9 to 9,900 ppm by mass, more preferably from 50 to 5,000 ppm by mass, still more preferably from 100 to 1,000 ppm by mass, and particularly preferably from 200 to 500 ppm by mass.

When synthesizing the specific silane compound, the metal atom may coexist in the synthesis process. For example, a hydrosilylation catalyst that contains a metal atom is occasionally used, usually in an amount of approximately from 0.1 to 5 ppm by mass, in terms of metal, with respect to a target compound. In this case, while leaving the coexisting metal atom as it is, a metal atom may be added so as to adjust the total amount of the metal atom to 10 to 10,000 ppm by mass with respect to the specific silane compound. This can reduce the number of steps for removing the metal atom added in the synthesis process. Alternatively, after removing the coexisting metal atom, 10 to 10,000 ppm by mass of a metal atom may be added. The coexisting metal atom may be removed by, for example, adsorption to activated carbon.

### <Liquid Medium>

The composition according to the present disclosure may contain a liquid medium.

The liquid medium may be used singly, or two or more kinds thereof may be used.

The liquid medium is preferably an organic solvent.

Examples of the organic solvent include compounds composed only of hydrogen atom(s) and carbon atom(s), and compounds composed only of hydrogen atom(s), carbon atom(s), and oxygen atom(s). Specific examples thereof include a hydrocarbon-based organic solvent, a ketone-based organic solvent, an ether-based organic solvent, an ester-based organic solvent, a glycol-based organic solvent, and an alcohol-based organic solvent.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,6-hexanediol diacetate, y-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono-tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvent include a halogen-containing organic solvent, a nitrogen-containing compound, a sulfur-containing compound, a siloxane compound, and a fluorine-containing organic solvent.

Specific examples of the halogen-containing organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of the fluorine-containing organic solvent include a polyfluoroaromatic hydrocarbon (e.g., 1,3-bis(trifluoromethyl)benzene); a polyfluoroaliphatic hydrocarbon (e.g., C₆F₁₃CH₂CH₃ (e.g., ASAHIKLIN (registered trademark) AC-6000 from AGC Inc.), 1,1,2,2,3,3,4-heptafluorocyclopentane (e.g., ZEORORA (registered trademark) H from Zeon Corporation); a hydrofluoroether (HFE) (e.g., an alkyl perfluoroalkyl ether (the perfluoroalkyl group and the alkyl group may be linear or branched), such as perfluoropropyl methyl ether (C₃F₇OCH₃) (e.g., NOVEC (trademark) 7000 from Sumitomo 3M Limited), perfluorobutyl methyl ether (C₄F₉OCH₃) (e.g., NOVEC (trademark) 7100 from Sumitomo 3M Limited), perfluorobutyl ethyl ether (C₄F₉OC₂H₅) (e.g., NOVEC (trademark) 7200 from Sumitomo 3M Limited), and perfluorohexyl methyl ether (C₂F₅CF(OCH₃) C₃F₇) (e.g., NOVEC (trademark) 7300 from Sumitomo 3M Limited), and CF₃CH₂OCF₂CHF₂ (e.g., ASAHIKLIN (registered trademark) AE-3000 from AGC Inc.)); a hydrofluoroolefin (HFO) (e.g., 1-chloro-2,3,3-trifluoro-1-propene (HCFO-1233 yd) (e.g., AMOLEA (registered trademark) AS-300 from AGC Inc.), and OPTEON (registered trademark) SF01, SF05, SF10, SF30, SF33, SF70, SF79, and SF80 from The Chemours Company).

The content of the liquid medium with respect to the total amount of the composition according to the present disclosure is preferably from 50% to 99.999% by mass, more preferably from 80% to 99.99% by mass, and still more preferably from 90% to 99.9% by mass. For the composition according to the present disclosure intended for use in wet coating, the content of the liquid medium with respect to the total amount of the composition according to the present disclosure may be from 90% to 99.99% by mass, may be from 95% to 99.98% by mass, may be from 97% to 99.97% by mass, and may be from 98% to 99.95% by mass.

### <Other Components>

The composition according to the present disclosure may contain other components besides the liquid medium, as long as the effects of the present disclosure are not impaired.

Examples of such other components include known additives such as an acid catalyst and a basic catalyst that promote hydrolysis and condensation reaction of the reactive silyl groups.

Examples of the catalyst that can be used include any appropriate acid or base, a sulfur-containing compound having a lone pair in the molecular structure, and a nitrogen-containing compound (e.g., a sulfoxide compound, an aliphatic amine compound, an aromatic amine compound, a phosphoric acid amide compound, an amide compound, and a urea compound).

Examples of the acid catalyst include acetic acid, formic acid, trifluoroacetic acid, hydrochloric acid, nitric acid, sulfuric acid, phosphoric acid, sulfonic acid, methanesulfonic acid, and p-toluenesulfonic acid.

Examples of the base catalyst include ammonia, sodium hydroxide, and potassium hydroxide; and organic amines such as triethylamine and diethylamine.

Examples of such other components also include a compound having a hydrolyzable group represented by the following formulae (M1) to (M3).

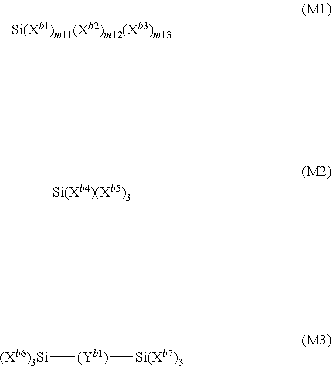

In formula (M1),
Each X^{b1} independently represents a hydrolyzable group.
Each X^{b2} independently represents a siloxane skeleton-containing group.
Each X^{b3} independently represents a hydrocarbon chain-containing group.
m11 represents an integer from 2 to 4,
each of m12 and m13 independently represents an integer from 0 to 2, and
m11+m12+m13 is 4.

In formula (M2),
X^{b4} represents a hydrolyzable silane oligomer residue.
Each X^{b5} independently represents a hydrolyzable group or an alkyl group having from 1 to 4 carbon atoms.

In formula (M3),
each of X^{b6} and X^{b7} independently represents a hydrolyzable group or a hydroxy group.
Y^{b1} represents a divalent organic group.

Examples of the hydrolyzable group represented by X^{b1} in formula (M1) include those of the hydrolyzable group represented by L in [—Si(R²)ₙL₃₋ₙ] in the reactive silyl group.

The siloxane skeleton-containing group represented by X^{b2} has a siloxane unit (—Si—O—), and may be linear or branched. The siloxane unit is preferably a dialkylsilyloxy group, and examples thereof include a dimethylsilyloxy group and a diethylsilyloxy group. The number of repetitions of the siloxane unit in the siloxane skeleton-containing group is 1 or more, preferably from 1 to 5, more preferably from 1 to 4, and still more preferably from 1 to 3.

The siloxane skeleton-containing group may contain a divalent hydrocarbon group in a part of the siloxane skeleton. More specifically, a part of oxygen atoms in the siloxane skeleton may be substituted with a divalent hydrocarbon group. Examples of the divalent hydrocarbon group include an alkylene group such as a methylene group, an ethylene group, a propylene group, or a butylene group.

The silicon atom at the terminal of the siloxane skeleton-containing group may have a hydrolyzable group, a hydrocarbon group (preferably an alkyl group), or the like bonded thereto.

The number of atoms in the siloxane skeleton-containing group is preferably 100 or less, more preferably 50 or less, and still more preferably 30 or less. The number of atoms is preferably 10 or more.

The siloxane skeleton-containing group is preferably a group represented by *—(O—Si(CH₃)₂)ₙCH₃, in which n represents an integer from 1 to 5, and * indicates a bonding site with an adjacent atom.

The hydrocarbon chain-containing group represented by X⁵³ may be composed only of a hydrocarbon chain, or may have an etheric oxygen atom between carbon atoms of the hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably from 1 to 3, more preferably 1 or 2, and still more preferably 1. The hydrocarbon chain-containing group is preferably an alkyl group, and more preferably a methyl group, an ethyl group, or a propyl group.
ml is preferably 3 or 4.

The compound represented by formula (M1) is preferably a compound represented by any of the following formulae (M1-1) to (M1-5), and more preferably a compound represented by formula (M1-1). The compound represented by formula (M1-1) is preferably tetraethoxysilane, tetramethoxysilane, or triethoxymethylsilane.

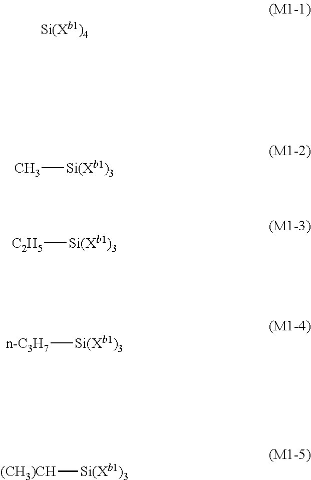

In formula (M2), the number of silicon atoms contained in the hydrolyzable silane oligomer residue represented by X³⁴ is preferably 3 or more, more preferably 5 or more, and still more preferably 7 or more. The number of silicon atoms is preferably 15 or less, more preferably 13 or less, and still more preferably 10 or less.

The hydrolyzable silane oligomer residue may have an alkoxy group bonded to a silicon atom. Examples of the alkoxy group include a methoxy group, an ethoxy group, a propoxy group, and a butoxy group, and a methoxy group and an ethoxy group are preferred. The hydrolyzable silane oligomer residue may have one kind, or two or more kinds of these alkoxy groups, and preferably has one kind of these alkoxy groups.

Examples of the hydrolyzable silane oligomer residue include (C₂H50)₃Si—(OSi(OCH₅)₂)₄O—*. Here, * indicates a bonding site with an adjacent atom.

Examples of the hydrolyzable group represented by X^{b5} in formula (M2) include those of the hydrolyzable group represented by Lin [—Si(R²)ₙL₃₋ₙ] in the reactive silyl group, a cyano group, a hydrogen atom, and an allyl group, and an alkoxy group or an isocyanato group is preferred. The alkoxy group preferably has from 1 to 4 carbon atoms.
X^{b5} is preferably a hydrolyzable group.

Examples of the compound represented by formula (M2) include (H₅C₂O)₃—Si—(OSi(OC₂H₅)₂)₄OC₂H₅.

The compound represented by formula (M3) is a compound having a reactive silyl group at each of respective terminals of a divalent organic group, that is, a bissilane.

Examples of the hydrolyzable group represented by X^{b6} and X^{b7} in formula (M3) include an alkoxy group, an acyloxy group, a ketoxime group, an alkenyloxy group, an amino group, an aminoxy group, an amide group, an isocyanato group, and a halogen atom, and an alkoxy group and an isocyanato group are preferred. The alkoxy group is preferably an alkoxy group having from 1 to 4 carbon atoms, and more preferably a methoxy group or an ethoxy group.

In formula (M3), X^{b6} and X^{b7} may be the same group or different groups. From the viewpoint of availability, X^{b6} and X^{b7} are preferably the same group.

In formula (M3), Y^{b1} represents a divalent organic group that links the reactive silyl groups at both terminals. The number of carbon atoms in the divalent organic group Y^{b1} is preferably from 1 to 8, and more preferably from 1 to 3.

Examples of Y^{b1} include an alkylene group, a phenylene group, and an alkylene group having an etheric oxygen atom between carbon atoms. Examples thereof include-CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃) CH₂OCH₂CH(CH₃)—, and —C₆H₄—.

Examples of the compound represented by formula (M3) include (CH₃O)₃Si(CH₂)₂Si(OCH₃)₃, (C₂H₅O)₃Si(CH₂)₂Si(OCH₅)₃, (OCN)₃Si(CH₂)₂Si(NCO)₃, Cl₃Si(CH₂)₂SiCl, (CH₃O)₃Si(CH₂)₆Si(OCH₃)₃, and (C₂H₅O)₃Si(CH₂)₆Si(OC₂H5)₃.

The content of the “other components” optionally contained in the composition according to the present disclosure with respect to the total amount of the composition according to the present disclosure is preferably 10% by mass or less, and more preferably 1% by mass or less. The content of the compounds represented by formulae (M1) to (M3), when present in the composition according to the present disclosure, is preferably from 0.01% to 30% by mass, more preferably from 0.01% to 10% by mass, and still more preferably from 0.05% to 5% by mass, with respect to the total amount of the composition according to the present disclosure.

The total content of the specific silane compound and the “other components” (hereinafter also referred to as “solid content concentration”) with respect to the total amount of the composition according to the present disclosure is preferably from 0.001% to 40% by mass, more preferably from 0.01% to 20% by mass, and still more preferably from 0.1% to 10% by mass. The solid content concentration of the composition according to the present disclosure is a value calculated from the mass before heating, and the mass after heating in a convection dryer at 120° C. for 4 hours.

### [Surface Treatment Agent]

The surface treatment agent according to the present disclosure consists of the composition according to the present disclosure described above. The surface treatment agent according to the present disclosure is applied to the surface of a substrate and is used as a surface treatment agent. Details of each component contained in the surface treatment agent are the same as the details of each component contained in the aforementioned composition. The surface treatment agent according to the present disclosure may contain one kind of the specific silane compound, or two or more kinds thereof. For example, the surface treatment agent may contain only the aforementioned first compound or may contain both the first compound and the second compound. In either case, one kind of the first compound may be used singly, or two or more kinds thereof may be used in combination, and one kind of the second compound may be used singly, or two or more kinds thereof may be used in combination.

### [Article]

In an aspect, the article according to the present disclosure includes a substrate; and a surface treatment layer disposed on the substrate and having been surface-treated using the surface treatment agent according to the present disclosure.

The surface treatment layer may be formed on a part of the surface of the substrate, or over the entire surface of the substrate. The surface treatment layer may be spread like a film over the surface of the substrate, or may be scattered like dots.

In the surface treatment layer, the compounds according to the present disclosure are contained, with the reactive silyl groups partially or entirely hydrolyzed, and with the silanol groups having undergone dehydration condensation.

The thickness of the surface treatment layer is preferably from 1 to 100 nm, and more preferably from 1 to 50 nm. When the thickness of the surface treatment layer is 1 nm or more, a sufficient effect of the surface treatment tends to be obtained. When the thickness of the surface treatment layer is 100 nm or smaller, a high utilization efficiency can be achieved. The thickness of the surface treatment layer can be calculated based on an oscillation period of an interference pattern of the reflected X-ray, obtained by X-ray reflectivity using an X-ray diffractometer for thin film analysis (model “ATX-G” from Rigaku Corporation).

The type of the substrate is not particularly limited, and examples thereof include a substrate for which impartation of water repellency is desired. Examples of the substrate include a substrate that may be brought into contact with another article (e.g., a stylus) or fingers of a human; a substrate that may be held by fingers of a human during operation; and a substrate that may be placed on another article (e.g., a stage).

Examples of the material of the substrate include metal, resin, glass, sapphire, ceramic, semiconductor, stone, fiber, nonwoven fabric, paper, wood, fur, natural leather, artificial leather, chinaware, and composite materials thereof. The glass may be chemically strengthened.

Examples of the substrate include a building material, a decorative building material, interior goods, transportation equipment (e.g., an automobile), a signboard, a bulletin board, drinkware, tableware, a water tank, an ornamental good (e.g., a frame, a box), a laboratory instrument, furniture, a textile product, and a packaging container; glass or resin used for art, sporting goods, games and the like; and glass or resin used for an exterior portion (excluding the display unit) of a device such as a mobile phone (e.g., a smartphone), a personal digital assistant, a game machine, or a remote controller. The shape of the substrate may be a plate or a film.

The substrate is preferably any of a substrate for a touch panel, a substrate for a display, and spectacle lenses, and a substrate for a touch panel is particularly preferred. The material of the substrate for a touch panel is preferably glass or transparent resin.

The substrate may have one or both surfaces that have been subjected to surface treatment such as corona discharge treatment, plasma treatment, or plasma graft polymerization treatment. The substrate that has been subjected to surface treatment has improved adhesion with the surface treatment layer, whereby the surface treatment layer has improved abrasion resistance. Therefore, the substrate has preferably been subjected to surface treatment on the surface on the side in contact with the surface treatment layer. When an underlayer described later is provided, the substrate has improved adhesion with the underlayer, whereby the surface treatment layer will have improved abrasion resistance. Therefore, when an underlayer is provided, the substrate is preferably subjected to the surface treatment on the surface on the side in contact with the underlayer.

The surface treatment layer may be provided directly on the surface of the substrate, or an underlayer may be provided between the substrate and the surface treatment layer. From the viewpoint of further improving the water repellency and the abrasion resistance of the surface treatment layer, the article according to the present disclosure preferably includes the substrate, an underlayer disposed on the substrate, and the surface treatment layer disposed on the underlayer and having been surface-treated using the surface treatment agent according to the present disclosure.

The underlayer preferably contains an oxide that contains silicon and at least one specific element selected from the group consisting of a Group 1 element, a Group 2 element, a Group 4 element, a Group 5 element, a Group 13 element, and a Group 15 element in the periodic table.

The Group 1 element in the periodic table (hereinafter also referred to as “Group 1 element”) refers to lithium, sodium, potassium, rubidium, and cesium. From the viewpoint that the surface treatment layer can be formed on the underlayer more uniformly without defects, or that compositional variation of the underlayer among samples can be further suppressed, the Group 1 element is preferably lithium, sodium, or potassium, and is more preferably sodium or potassium. The underlayer may contain two or more kinds of Group 1 elements.

The Group 2 element in the periodic table (hereinafter also referred to as “Group 2 element”) refers to beryllium, magnesium, calcium, strontium, and barium. From the viewpoint that the surface treatment layer can be formed on the underlayer more uniformly without defects, or that compositional variation of the underlayer among samples can be further suppressed, the Group 2 element is preferably magnesium, calcium, or barium, and is more preferably magnesium or calcium. The underlayer may contain two or more kinds of Group 2 elements.

The Group 4 element in the periodic table (hereinafter also referred to as “Group 4 element”) means titanium, zirconium, and hafnium. From the viewpoint that the surface treatment layer can be formed on the underlayer more uniformly without defects, or that compositional variation of the underlayer among samples can be further suppressed, the Group 4 element is preferably titanium or zirconium, and is more preferably titanium. The underlayer may contain two or more kinds of Group 4 elements.

The Group 5 element in the periodic table (hereinafter also referred to as “Group 5 element”) refers to vanadium, niobium, and tantalum. From the viewpoint of superior abrasion resistance of the surface treatment layer, vanadium is particularly preferred as the Group 5 element. The underlayer may contain two or more kinds of Group 5 elements.

The Group 13 element in the periodic table (hereinafter also referred to as “Group 13 element”) refers to boron, aluminum, gallium, and indium. From the viewpoint that the surface treatment layer can be formed on the underlayer more uniformly without defects, or that compositional variation of the underlayer among samples can be further suppressed, the Group 13 element is preferably boron, aluminum or gallium, and is more preferably boron or aluminum. The underlayer may contain two or more kinds of Group 13 elements.

The Group 15 element in the periodic table (hereinafter also referred to as “Group 15 element”) means nitrogen, phosphorus, arsenic, antimony, and bismuth. From the viewpoint that the surface treatment layer can be formed on the underlayer more uniformly without defects, or that compositional variation of the underlayer among samples can be further suppressed, the Group 15 element is preferably phosphorus, antimony or bismuth, and is more preferably phosphorus or bismuth. The underlayer may contain two or more kinds of Group 15 elements.

In view of superior abrasion resistance of the surface treatment layer, the specific element contained in the underlayer is preferably a Group 1 element, a Group 2 element, or a Group 13 element, more preferably a Group 1 element or a Group 2 element, and still more preferably a Group 1 element.

The underlayer may contain only one kind of element or two or more kinds of elements as the specific element.

The oxide contained in the underlayer may be a mixture of single oxides of the aforementioned elements (silicon and the specific element) (e.g., a mixture of silicon oxide and an oxide of a specific element), may be a composite oxide that contains two or more of the aforementioned elements, or may be a mixture of a single oxide of the aforementioned elements and a composite oxide.

The ratio of the total molar concentration of the specific elements in the underlayer to the molar concentration of silicon in the underlayer (specific element/silicon) is preferably from 0.02 to 2.90, more preferably from 0.10 to 2.00, and still more preferably from 0.20 to 1.80, from the viewpoint of superior abrasion resistance of the surface treatment layer.

The molar concentration (mol %) of each element in the underlayer can be measured by, for example, depth profiling using X-ray photoelectron spectroscopy (XPS) combined with ion sputtering.

The underlayer may be a single layer or a multilayer. The underlayer may have surface irregularities.

The thickness of the underlayer is preferably from 1 to 100 nm, more preferably from 1 to 50 nm, and still more preferably from 2 to 20 nm. When the thickness of the underlayer is equal to or greater than the aforementioned lower limit value, the adhesion of the underlayer to the surface treatment layer is further improved, whereby the surface treatment layer has superior abrasion resistance. When the thickness of the underlayer is equal to or less than the aforementioned upper limit value, the underlayer itself has excellent abrasion resistance.

The thickness of the underlayer is measured by observing a cross-section of the underlayer using a transmission electron microscope (TEM).

The underlayer can be formed, for example, by vapor deposition using a vapor deposition material, or by wet coating.

The vapor deposition material used for vapor deposition preferably contains an oxide that contains silicon and a specific element.

Specific examples of the form of the vapor deposition material include powder, molten material, sintered material, granules, and crushed material. From the viewpoint of ease of handling, molten material, sintered material, and granules are preferred.

The molten material means a solid material obtained by melting powder of the vapor deposition material at high temperatures, followed by solidification by cooling. The sintered material means a solid material obtained by firing powder of the vapor deposition material. Instead of the powder of the vapor deposition material, a molded material formed by press-forming the powder may be used as necessary. The granules are solid materials obtained by kneading powder of a vapor deposition material and a liquid medium (e.g., water, an organic solvent), followed by drying of the obtained particles.

The vapor deposition material can be produced, for example, by the following methods:
a method in which silicon oxide powder and powder of an oxide of a specific element are mixed to obtain a powder of the vapor deposition material;
a method in which the powder of the vapor deposition material and water are kneaded to obtain particles, and the particles are then dried to obtain granules of the vapor deposition material;
a method in which silicon-containing powder (e.g., powder composed of silicon oxide, silica sand, or silica gel), powder that contains a specific element (e.g., powder of an oxide of a specific element, or a carbonate, a sulfate, a nitrate, an oxalate, or a hydroxide thereof), and water are mixed, the mixture is dried, and the dried mixture or a press-formed molded body thereof is then fired to obtain a sintered material; and
a method in which silicon-containing powder (e.g., powder composed of silicon oxide, silica sand, or silica gel), and powder that contains a specific element (e.g., powder of an oxide of a specific element, or a carbonate, a sulfate, a nitrate, an oxalate, or a hydroxide thereof) are melted at high temperatures, and the melt is then cooled and solidified to obtain a molten material.

Specific examples of the vapor deposition method using the vapor deposition material include vacuum vapor deposition. The vacuum vapor deposition is a method in which the vapor deposition material is evaporated in a vacuum chamber and attached to the surface of the substrate.

The temperature of the vapor deposition (in a case of using a vacuum vapor deposition apparatus, for example, the temperature of the boat on which the vapor deposition material is placed) is preferably from 100 to 3,000° C., and more preferably from 500 to 3,000° C.

The pressure of the vapor deposition (in a case of using a vacuum vapor deposition apparatus, for example, the pressure in the chamber in which the vapor deposition material is placed) is preferably 1 Pa or lower, and more preferably 0.1 Pa or lower.

When the underlayer is formed using a vapor deposition material, one kind of vapor deposition material may be used, or two or more kinds of vapor deposition materials containing different elements may be used.

Specific examples of the evaporation method of the vapor deposition material include resistance heating, in which the vapor deposition material is melted on a resistance heating boat made of a high-melting-point metal and thereby evaporated; and an electron gun method, in which the surface of the vapor deposition material is directly heated and melted by electron beam irradiation and thereby evaporated. The method of evaporating the vapor deposition material is preferably the electron gun method, from the viewpoint that such local heating can also evaporate high-melting-point substances, and that portions not irradiated with the electron beam remain at low temperatures, thereby reducing the risk of reaction with the container and contamination with impurities.

The evaporation method of the vapor deposition material may use multiple boats, or a single boat on which all the vapor deposition materials are placed. The vapor deposition method may employ co-deposition, alternate deposition, or the like. More specifically, examples include a case of using silica and a specific source in a mixed manner in the same boat; a case of co-deposition of silica and a specific element source placed on separate boats; and a case of alternate deposition by similarly placing them on separate boats. The conditions, the order or the like of vapor deposition are appropriately selected depending on the structure of the underlayer.

In wet coating, it is preferred to form the underlayer on the substrate by wet coating using a coating liquid that contains a silicon-containing compound, a specific element-containing compound, and a liquid medium.

Specific examples of the silicon compound include silicon oxide, silicic acid, a partial condensate of silicic acid, an alkoxysilane, and a partial hydrolysis condensate of an alkoxysilane.

Specific examples of the specific element-containing compound include an oxide of the specific element, an alkoxide of the specific element, a carbonate of the specific element, a sulfate of the specific element, a nitrate of the specific element, an oxalate of the specific element, and a hydroxide of the specific element.

Examples of the liquid medium include those of the liquid medium that may be contained in the surface treatment agent according to the present disclosure.

The content of the liquid medium with respect to the total amount of the coating liquid used for forming the underlayer is preferably from 80% to 99.99% by mass, and more preferably from 90% to 99.9% by mass.

Specific examples of the wet coating for forming the underlayer include spin coating, wipe coating, spray coating, squeegee coating, dip coating, die coating, an inkjet method, flow coating, roll coating, casting, the Langmuir-Blodgett method, and gravure coating.

The wet coating of the coating liquid is preferably followed by drying of the coated film. The drying temperature of the coated film is preferably from 20 to 200° C., and more preferably from 80 to 160° C.

The article according to the present disclosure may be an optical material having a surface treatment layer as the outermost layer.

Preferred examples of the optical material include those related to a display and the like, as well as a wide variety of optical materials.

Examples of the optical material include displays such as a cathode ray tube (CRT; e.g., a personal computer monitor), a liquid crystal display, a plasma display, an organic EL display, an inorganic thin film EL dot matrix display, a rear projection-type display, a vacuum fluorescent display (VFD), and a field emission display (FED); a protective plate for these displays; and those having an antireflection film formed on the surfaces of the displays or the protective plates thereof.

The article according to the present disclosure is preferably an optical component. Examples of the optical component include a car navigation system, a mobile phone, a smartphone, a digital camera, a digital video camera, a PDA, a portable audio player, a car audio system, a game machine, spectacle lenses, a camera lens, a lens filter, sunglasses, a medical instrument such as a gastroscope, a copying machine, a PC, a display (e.g., a liquid crystal display, an organic EL display, a plasma display, and a touch panel display), a touch panel, a protective film, and an antireflection film.

Examples of the optical component also include a front protective plate, an antireflection plate, a polarizing plate, and an anti-glare plate for displays such as a PDP, an LCD, and the like; a disc face of an optical disk such as a Blu-ray (registered trademark) disc, a DVD disc, a CD-R, or an MO; an optical fiber; and a display face of a clock.

In particular, the article according to the present disclosure is preferably a display or a touch panel.

The article according to the present disclosure may be a medical device or a medical material. The article according to the present disclosure may also be an automotive interior or exterior material. Examples of the exterior material include a window, a light cover, and an external camera cover. Examples of the interior material include an instrument panel cover, a navigation system touch panel, and a decorative interior material.

When the article according to the present disclosure is an optical component, the material constituting the surface of the substrate is a material for an optical component, such as glass or transparent plastic. When the article according to the present disclosure is an optical component, the substrate may have a functional layer such as a hard coat layer or an antireflection layer formed on the surface (outermost layer) thereof. The antireflection layer may be either a single-layer antireflection layer or a multi-layer antireflection layer.

Examples of the inorganic substance that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used singly, or two or more kinds thereof may be used in combination (e.g., as a mixture). In the case of forming a multi-layered antireflection layer, it is preferred to use SiO₂ and/or SiO for the outermost layer. When the article according to the present disclosure is an optical glass component for a touch panel, the article may have a transparent electrode, such as a thin film containing indium tin oxide (ITO), indium zinc oxide, or the like, on a part of the surface of the substrate (glass). The substrate may have an insulating layer, an adhesive layer, a protective layer, a decorative frame layer (I—CON), an atomizing film layer, a hard coating film layer, a polarizing film, a phase difference film, a liquid crystal display module, and the like, depending on the specific specification and the like.

### [Method for Producing Article]

A method for producing an article according to the present disclosure is, for example, a method including subjecting a substrate to surface treatment using the surface treatment agent according to the present disclosure to produce an article having the substrate and a surface treatment layer formed thereon. Examples of the surface treatment include dry coating and wet coating.

Examples of the dry coating include techniques such as vacuum deposition, CVD, and sputtering. The dry coating is preferably carried out by vacuum deposition, from the viewpoints of suppressing decomposition of the compound and convenience of the apparatus. The vacuum deposition may employ a pellet-like material in which a porous metal material made of iron, steel, or the like is impregnated with the compound according to the present disclosure. The pellet-like material obtained by impregnating a porous metal material made of iron, steel, or the like with a composition containing the compound according to the present disclosure and a liquid medium, and drying off the liquid medium, may be used.

Examples of the wet coating include spin coating, wipe coating, spray coating, squeegee coating, dip coating, die coating, an inkjet method, flow coating, roll coating, casting, the Langmuir-Blodgett method, and gravure coating.

To improve the abrasion resistance of the surface treatment layer, an operation for promoting the reaction between the compound according to the present disclosure and the substrate may be carried out. Examples of such an operation include heating, humidification, and light irradiation.

For example, a substrate having formed thereon a surface treatment layer may be heated in a moist atmosphere to promote reactions such as the hydrolysis reaction of the hydrolyzable groups, the reaction between hydroxy groups or the like on the surface of the substrate and the silanol groups, and the generation of siloxane bonds as a result of the condensation reaction of the silanol groups.

After the surface treatment, any compound present in the surface treatment layer and chemically unbound to other compounds or to the substrate may be removed as necessary. Examples of the method for the removal include a method of flooding a solvent over the surface treatment layer and a method of wiping the surface treatment layer with a cloth soaked with a solvent.

### EXAMPLES

Next, embodiments of the present disclosure will be specifically described with reference to Examples. However, the embodiments of the present disclosure are by no means limited to these Examples. Examples 2 to 6, 8 to 31, 32 to 39, and 41 are working examples, and Examples 1, 7, 40, and 42 are comparative examples.

### (Preparation of Compounds)

The following compounds were prepared.

### Experimental Example 1

(CH₃)₃Si—(OSi(CH₃)₂)ₙ₁₀—(CH₂)₁₀—CONH—CH₂C(CH₂CH═CH₂)₃ (2 g) obtained by the method described in Synthesis Example 1 of WO 2023/017830 A, toluene (10 mL), a xylene solution of Karstedt's catalyst (platinum (0)-1,3-divinyl-1,1,3,3-tetramethyldisiloxane complex) (3% by mass, amount listed in Table 1), aniline (46 mg), and trimethoxysilane (1.43 mL) were mixed. The mixture was stirred at 40° C. for 24 hours, and the rate of conversion of CH═CH₂ was then confirmed by NMR. The mixture was then concentrated under reduced pressure to obtain 2.2 g of a specific silane compound represented by formula (A). The average value of n10 is 10.

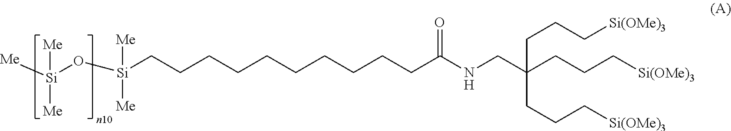

### Experimental Example 2

(CH₃)₃Si—(OSi(CH₃)₂)ₙ₁₀—(CH₂)₁₀—CONH—CH₂C(CH₂CH═CH₂)₃ (2 g) obtained by the method described in Synthesis Example 1 of WO 2023/017830 A, toluene (10 mL), a xylene solution of Karstedt's catalyst (3% by mass, 0.0003 g), aniline (46 mg), and trimethoxysilane (1.43 mL) were mixed. The mixture was stirred at 40° C. for 24 hours, and the rate of conversion of CH═CH₂ was then confirmed by NMR. Thereafter, the metal compound listed in Table 2 was mixed, so as to adjust the amount of the metal atom with respect to the specific silane compound to the amount (ppm by mass) listed in Table 2. The mixture was then concentrated under reduced pressure to obtain 2.2 g of a specific silane compound represented by formula (A). The average value of n10 is 10.

### Experimental Example 3

(CH₃)₃Si—(OSi(CH₃)₂)ₙ₁₀—(CH₂)₁₀—CONH—CH₂C(CH₂CH═CH₂)₃ (2 g) obtained by the method described in Synthesis Example 1 of WO 2023/017830 A, toluene (10 mL), a xylene solution of Karstedt's catalyst (3% by mass, 0.33 g), aniline (46 mg), and trimethoxysilane (1.43 mL) were mixed. The mixture was stirred at 40° C. for 24 hours, and the rate of conversion of CH═CH₂ was then confirmed by NMR. The mixture was then concentrated under reduced pressure, to obtain 2.2 g of a specific silane compound represented by formula (A). The average value of n10 is 10.

2.0 g of the thus obtained compound was dissolved in 20 g of SR solvent (1,3-bistrifluoromethylbenzene), and the solution was treated with 2 g of activated carbon, followed by additional washing with SR solvent and recovery of the treatment liquid. The liquid was concentrated under reduced pressure to obtain 1.7 g of a colorless clear compound from which platinum had been removed. Each of the metal compounds listed in Table 3 was mixed and dissolved in SR solvent such that the amount of the metal atom would be 100 ppm by mass with respect to 1 g of the specific silane compound, and then the solution was concentrated under reduced pressure.

The concentration of the metal with respect to the specific silane compound can be measured by the following method. 0.2 g of the compound is sampled, heated to 500° C. on a hot plate, and further washed over a burner, and the ash is dissolved using aqua regia while heating at 150° C. The solution is then diluted up to a volume of 20 mL with nitric acid, and quantified using an ICP-MS apparatus (Agilent 8800, Agilent Technologies).

### [Preparation of Surface Treatment Agent, and Manufacture of Article]

Each of the compounds obtained in Experimental Examples 1 to 3 was mixed with heptane, to obtain a surface treatment agent having a solid concentration of 0.2% by mass. A substrate was subjected to surface treatment using the surface treatment agent. Wet coating was employed as the surface treatment method.

### (Wet Coating)

On a copper hearth in a vacuum vapor deposition apparatus (VTR-350M, manufactured by ULVAC KIKO, Inc.), 30 g of silicon oxide was placed as a deposition source. A glass substrate was placed in the vacuum vapor deposition apparatus, and the interior of the vacuum vapor deposition apparatus was evacuated to a pressure of 5×10⁻³ Pa or less. The hearth was heated up to approximately 2,000° C., whereby silicon oxide was vacuum-deposited on the surface of the substrate. A silicon oxide layer having a thickness of approximately 20 nm was thereby formed on the substrate.

The substrate having the silicon oxide layer thus formed was placed on a sample stage of a spray coater (API-90RS, from Apeiros Co., Ltd.), with the silicon oxide layer facing upward. Next, 13 g of the prepared surface treatment agent was injected into a syringe of the spray coater, and sprayed at an atomization pressure of 130 kPa, a nozzle-sample face distance of 50 mm, and a scanning speed of 300 mm/sec. The substrate thus coated was then heated at 140° C. for 30 minutes. An article having a surface treatment layer formed on the surface of the silicon oxide layer was thus obtained.

Next, the surface treatment layer of the obtained article was evaluated as follows.

### [Evaluation]

### <Abrasion Resistance>

On the thus formed surface treatment layer, a rubbing tester (manufactured by Imoto machinery Co., LTD) was used to reciprocate a rubbing element 100 times under the following conditions, and thereafter, the water contact angle of the surface treatment layer was measured to evaluate the number of times that a water contact angle of 100° or more was maintained.
Rubbing element: BEMCOT M-311 (product name, manufactured by Asahi Kasei Corporation)
Travel distance (one way): 60 mm
Travel speed: 8,400 mm/min
Load: 100 g/3 cm²

The water contact angle was evaluated as follows. On the surface treatment layer of the article, approximately 2 μL of distilled water was dropped, and the water contact angle was measured using a contact angle meter (product name: “DM-500”, manufactured by Kyowa Interface Science Co., Ltd.). Measurement values from five locations on the surface treatment layer were averaged to determine the water contact angle. The water contact angle was calculated by the 20 method.

### <Evaluation of Appearance>

The appearance (color) of the substrate having the surface treatment layer formed thereon was visually observed.

The conditions and the results of the evaluations of Experimental Example 1 are summarized in Table 1. In the table, the “Pt content” refers to a concentration (ppm by mass in terms of the metal atom) with respect to the specific silane compound. As shown in Table 1, surface treatment layers having excellent appearance and abrasion resistance can be obtained using the surface treatment agents that contain from 10 to 10,000 ppm by mass of Pt with respect to the specific silane compound.

TABLE 1

| | | Amount of | | Abrasion |
|---|---|---|---|---|
| | Pt content | catalyst solution | | resistance |
| Example | (ppm by mass) | (g) | Appearance | (times) |
| 1 | 5 | 0.0003 | Colorless | 100 |
| 2 | 10 | 0.0007 | Colorless | 200 |
| 3 | 50 | 0.0033 | Colorless | 400 |
| 4 | 500 | 0.0333 | Colorless | 500 |
| 5 | 5,000 | 0.3333 | Pale yellow | 300 |
| 6 | 10,000 | 0.6667 | Pale yellow | 400 |
| 7 | 15,000 | 1.0000 | Yellow | 300 |

The conditions and the results of the evaluations of Experimental Example 2 are summarized in Table 2. In the table, the “Metal content” refers to the concentration of the metal atom (ppm by mass, in terms of metal atom) with respect to the specific silane compound. The compositions prepared in Experimental Example 2 contain 5 ppm by mass of Pt and each metal atom at the concentration indicated in Table 2 with respect to the specific silane compound. As shown in Table 2, surface treatment layers having excellent appearance and abrasion resistance can be obtained using the surface treatment agents of Examples 8 to 19.

TABLE 2

| | | | Metal | | |
|---|---|---|---|---|---|
| | | | content | | Abrasion |
| Exam- | | Metal | (ppm by | | resistance |
| ple | Metal compound | type | mass) | Appearance | (times) |
| 8 | TiCl₄ | Ti | 50 | Pale yellow | 300 |
| 9 | Cr(CO)₆ | Cr | 100 | Colorless | 300 |
| 10 | Mn₂(CO)₁₀ | Mn | 500 | Pale yellow | 200 |
| 11 | Fe(C₅H₅)₂ | Fe | 100 | Colorless | 300 |
| 12 | Co(C₅H₅)₂ | Co | 200 | Colorless | 300 |
| 13 | Ni(COD)₂ | Ni | 1,000 | Pale yellow | 400 |
| 14 | Zr(acac)₄ | Zr | 50 | Pale yellow | 300 |
| 15 | Ru₃(CO)₁₂ | Ru | 50 | Colorless | 300 |
| 16 | RhCl₃ | Rh | 300 | Colorless | 400 |
| 17 | Tris(dibenzylidene- | Pd | 300 | Colorless | 500 |
| | acetone) | | | | |
| | dipalladium | | | | |
| 18 | Ir₄(CO)₁₂ | Ir | 200 | Colorless | 200 |
| 19 | Karstedt's catalyst | Pt | 500 | Pale yellow | 500 |

The conditions and the results of the evaluations of Experimental Example 3 are summarized in Table 3. In the table, the “Metal content” refers to the concentration of the metal atom (ppm by mass, in terms of metal atom) with respect to the specific silane compound. The compositions prepared in Experimental Example 3 contain each metal atom at the concentration indicated in the following table, and the concentration of Pt is below the detection limit by ICP-MS. As shown in Table 3, surface treatment layers having excellent appearance and abrasion resistance can be obtained using the surface treatment agents of Examples 20 to 31.

TABLE 3

| | | | Metal | | |
|---|---|---|---|---|---|
| | | | content | | Abrasion |
| Exam- | | Metal | (ppm by | | resistance |
| ple | Metal compound | type | mass) | Appearance | (times) |
| 20 | TiCl₄ | Ti | 100 | Pale yellow | 300 |
| 21 | Cr(CO)₆ | Cr | 100 | Colorless | 200 |
| 22 | Mn₂(CO)₁₀ | Mn | 100 | Pale yellow | 300 |
| 23 | Fe(C₅H₅)₂ | Fe | 100 | Colorless | 200 |
| 24 | Co(C₅H₅)₂ | Co | 100 | Colorless | 300 |
| 25 | Ni(COD)₂ | Ni | 100 | Colorless | 300 |
| 26 | Zr(acac)₄ | Zr | 100 | Pale yellow | 300 |
| 27 | Ru₃(CO)₁₂ | Ru | 100 | Pale yellow | 300 |
| 28 | RhCl₃ | Rh | 100 | Colorless | 300 |
| 29 | Tris(dibenzylidene- | Pd | 100 | Colorless | 400 |
| | acetone) | | | | |
| | dipalladium | | | | |
| 30 | Ir₄(CO)₁₂ | Ir | 100 | Colorless | 300 |
| 31 | Karstedt's catalyst | Pt | 100 | Colorless | 400 |

These Experimental Examples suggest that a surface treatment layer having excellent appearance and abrasion resistance can be formed using, as a surface treatment agent, a composition that contains a specific silane compound and a metal atom in an amount of from 10 to 10,000 ppm by mass with respect to the amount of the specific silane compound.

### Experimental Example 4

(CH₃)₃Si—(OSi(CH₃)₂)ₙ₁₀—(CH₂)₁₀—CONH—CH₂C(CH₂CH═CH₂)₃ (2 g) obtained by the method described in Synthesis Example 1 of WO 2023/017830 A, toluene (10 mL), a xylene solution of Karstedt's catalyst (3% by mass, 0.0003 g), aniline (46 mg), and trimethoxysilane (1.43 mL) were mixed. The mixture was stirred at 40° C. for 24 hours, and the rate of conversion of CH═CH₂ was then confirmed by NMR. Thereafter, a metal compound indicated in Table 4 was mixed such that the amount of the metal atom with respect to the specific silane compound is as indicated in Table 4 (ppm by mass). The mixture was then concentrated under reduced pressure to obtain 2.2 g of the specific silane compound represented by the aforementioned formula (A). The average value of n10 was 10.

### [Preparation of Surface Treatment Agent and Production of Article]

Each of the compounds obtained in Experimental Example 4 was mixed with ethyl acetate to obtain a surface treatment agent having a solid concentration of 0.2% by mass. A substrate was subjected to surface treatment using the surface treatment agent. The surface treatment was conducted by wet coating in the same manner as in Experimental Examples 1 to 3.

### [Evaluation]

The surface treatment layers of the obtained articles were evaluated for abrasion resistance and appearance in the same manner as in Experimental Examples 1 to 3.

The conditions and the results of the evaluations of Experimental Example 4 are summarized in Table 4. In the table, the “Metal content” refers to the concentration of the metal atom (ppm by mass, in terms of metal atom) with respect to the specific silane compound. The compositions prepared in Experimental Example 4 contain 5 ppm by mass of Pt and each metal atom at the concentration indicated in Table 4 with respect to the specific silane compound. As shown in Table 4, surface treatment layers having excellent appearance and abrasion resistance can be obtained using the surface treatment agents of Examples 32 to 39.

TABLE 4

| | | | | | Abrasion |
|---|---|---|---|---|---|
| | Metal | Metal | Metal content | | resistance |
| Example | compound | type | (ppm by mass) | Appearance | (times) |
| 32 | ZnCl₂ | Zn | 100 | Colorless | 400 |
| 33 | Cucl₂ | Cu | 100 | Colorless | 400 |
| 34 | ZnCl₂ | Zn | 200 | Colorless | 500 |
| 35 | ZnCl₂ | Zn | 400 | Colorless | 400 |
| 36 | ZnCl₂ | Zn | 1000 | Colorless | 300 |
| 37 | ZnCl₂ | Zn | 2000 | Colorless | 500 |
| 38 | ZnCl₂ | Zn | 4000 | Colorless | 400 |
| 39 | ZnCl₂ | Zn | 8000 | Colorless | 300 |

### [Synthesis of Compound (F₁)]

Compound (F1) was obtained in accordance with the method described in WO 2024/034669 A1.

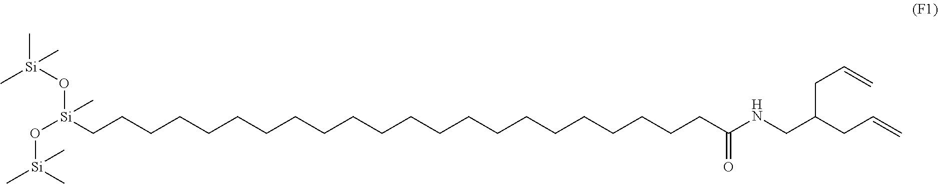 [SMILES: C=CCC(CC=C)CNC(=O)CCCCCCCCCCCCCCCCCCCCCC[Si](C)(O[Si](C)(C)C)O[Si](C)(C)C]

### [Synthesis of Compound (F2)]

Tris(triphenylphosphine) rhodium (I) chloride (0.05 g), toluene (30 g), and Molecular Sieves 5A (20 g) were added to trimethoxysilane (10 g), and the mixture was refluxed under heating at 110° C. for 24 hours. After Molecular Sieves was filtered off, the product was purified by distillation to obtain 2.5 g of Compound (F2). The structure of Compound (F2) was confirmed from the following NMR data.

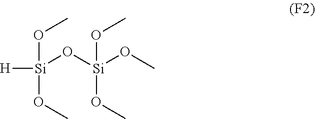

1H-NMR (400 MHZ, CDCl₃) δ 4.31 (s, 1H), 3.68-3.55 (m, 15H).

### [Synthesis of Compound (F3)]

A toluene solution of platinum/1,3-divinyl-1,1,3,3-tetramethyldisiloxane complex (platinum content: 3% by mass, 4.1 mg), aniline (2.6 mg), and Compound (F2) (0.82 g) were added to Compound (F1) (0.68 g) dissolved in dichloromethane (10 g), and the mixture was stirred at 50° C. for 2 hours. The solvent was then evaporated under reduced pressure to obtain 1.13 g of Compound (F3). The structure of Compound (F3) was confirmed from the following NMR data.

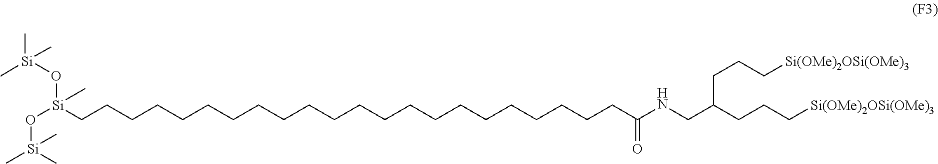

¹H-NMR (400 MHZ, CDCl₃) δ 3.56 (d, J=16.1 Hz, 30H), 3.03 (t, J=5.6 Hz, 2H), 2.19 (t, J=8.5 Hz, 2H), 1.76-0.86 (m, 49H), 0.80-0.47 (m, 6H), 0.05-0.06 (m, 21H).

### Experimental Example 5

1.0 g of Compound (F3) was dissolved in 10 g of SR solvent (1,3-bistrifluoromethylbenzene), and the solution was treated with 1 g of activated carbon, followed by additional washing with SR solvent and recovery of the treatment liquid. The liquid was concentrated under reduced pressure to obtain 0.83 g of a colorless clear compound from which platinum had been removed. The metal compound and the SR solvent were then mixed such that the amount of the Pt atom was 5 ppm by mass, 500 ppm by mass, or 15,000 ppm by mass, with respect to 1 g of the specific silane compound, followed by dissolution, and then the solution was concentrated under reduced pressure.

### [Preparation of Surface Treatment Agent and Production of Article]

Each of the compounds obtained in Experimental Example 5 was mixed with ethyl acetate to obtain a surface treatment agent having a solid concentration of 0.2% by mass. A substrate was subjected to surface treatment using the surface treatment agent. The surface treatment was conducted by wet coating in the same manner as in Experimental Examples 1 to 3.

### [Evaluation]

The surface treatment layers of the obtained articles were evaluated for abrasion resistance and appearance in the same manner as in Experimental Examples 1 to 3.

The conditions and the results of the evaluations of Experimental Example 5 are summarized in Table 5. In the table, the “Metal content” refers to the concentration of the metal atom (ppm by mass in terms of metal atom) with respect to the specific silane compound. The compositions prepared in Experimental Example 5 contain each metal atom at the concentration indicated in the following table, and the concentration of rhodium is below the detection limit by ICP-MS.

TABLE 5

| | | | Metal | | |
|---|---|---|---|---|---|
| | | | content | | Abrasion |
| Exam- | | Metal | (ppm by | | resistance |
| ple | Metal compound | type | mass) | Appearance | (times) |
| 40 | Karstedt's catalyst | Pt | 5 | Colorless | 100 |
| 41 | Karstedt's catalyst | Pt | 500 | Pale yellow | 400 |
| 42 | Karstedt's catalyst | Pt | 15,000 | Yellow | 500 |

These Experimental Examples suggest that a surface treatment layer having excellent appearance and abrasion resistance can be formed using, as a surface treatment agent, a composition that contains a specific silane compound and a metal atom in an amount of from 10 to 10,000 ppm by mass with respect to the amount of the specific silane compound.

The composition and the surface treatment agent according to the present disclosure can be used, for example, for substrates in display devices such as touch panel displays, optical elements, semiconductor elements, building materials, automobile components, nanoimprint technology, and the like. The composition and the surface treatment agent can also be used for bodies, window glasses (windshields, side windows, rear windows), mirrors, bumpers and the like in transportation equipment such as trains, automobiles, ships, and airplanes. The composition and the surface treatment agent can also be used for outdoor articles such as building exterior walls, tents, solar power generation modules, sound insulating panels, and concrete; and for fishing nets, insect nets, and water tanks. The composition and the surface treatment agent can also be used for kitchens, bathrooms, wash basins, mirrors, and toilet parts; chandeliers, ceramics such as tiles; artificial marble, and various indoor facilities such as air conditioners. The composition and the surface treatment agent can also be used for antifouling treatment of jigs, interior walls, pipes, and the like in factories. The composition and the surface treatment agent can also be used for goggles, glasses, helmets, pachinko machines, fibers, umbrellas, playground equipment, and soccer balls. The composition and the surface treatment agent can also be used as an adhesion inhibitor for various packaging materials such as food packaging materials, cosmetic packaging materials, and the inside of pots. The composition and the surface treatment agent can also be used for optical components such as car navigation systems, mobile phones, smartphones, digital cameras, digital video cameras, PDAs, portable audio players, car audio systems, game machines, spectacle lenses, camera lenses, lens filters, sunglasses, medical instruments such as gastroscopes, copying machines, PCs, displays (e.g., liquid crystal displays, organic EL displays, plasma displays, and touch panel displays), touch panels, protective films, and antireflection films.

### (Supplementary Notes)

The present disclosure includes the following aspects.

<1> A composition including:
a compound having a chain organo(poly)siloxane residue and a reactive silyl group; and
a metal atom,
wherein an amount of the metal atom is from 10 to 10,000 ppm by mass with respect to an amount of the compound having a chain organo(poly)siloxane residue and a reactive silyl group.

<2> The composition according to <1>, containing two or more kinds of the metal atom.

<3> The composition according to <1> or <2>, wherein the metal atom includes Pt and a metal atom other than Pt.

<4> The composition according to any one of <1> to <3>, wherein the metal atom includes a transition metal.

<5> The composition according to any one of <1> to <4>, wherein the metal atom includes at least one selected from the group consisting of Al, Ti, V, Cr, Mn, Fe, Co, Ni, Zr, Nb, Mo, Ru, Rh, Pd, Sn, Hf, Ta, W, Ir, and Pt.

<6> The composition according to any one of <1> to <4>, wherein the metal atom includes at least one selected from the group consisting of Ti, Cr, Mn, Fe, Co, Ni, Zr, Ru, Rh, Pd, Ir, and Pt.

<7> The composition according to any one of <1> to <4>, wherein the reactive silyl group is represented by the following formula (S1):

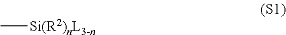

in formula (S1),
each R² independently represents a hydrocarbon group,
each L independently represents a hydrolyzable group, a group having a hydrolyzable group, or a hydroxy group, and
n represents an integer from 0 to 2.

<8> The composition according to any one of <1> to <4>, wherein the chain organo(poly)siloxane residue is represented by the following formula (B1) or (B2):

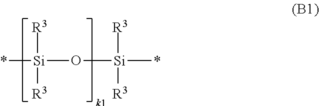

wherein, in formula (B1),
each R³ independently represents a hydrocarbon group,
k1 represents a number that is 1 or higher, and
* indicates a bonding site with an adjacent atom:

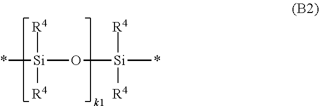

wherein, in formula (B2),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher, and
* indicates a bonding site with an adjacent atom.

<9> The composition according to <8>, wherein k1 in formulae (B1) and (B2) represents an integer from 1 to 600.

<10> The composition according to any one of <1> to <9>, wherein the compound having a chain organo(poly)siloxane residue and a reactive silyl group is represented by the following formula (C) or (D):

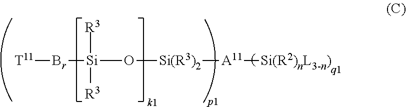

wherein, in formula (C),
T¹¹ represents a monovalent group free of a reactive silyl group,
each B independently represents —O— or —C(═O)—,
each r independently represents 0 or 1,
each R³ independently represents a hydrocarbon group,
each k1 independently represents a number that is 1 or higher,
p1 represents an integer that is 1 or higher,
A¹¹ represents a (p1+q1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2:

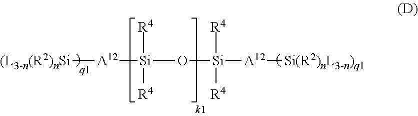

wherein, in formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher,
each A¹² independently represents a (q1+1)-valent linking group,
each q1 independently represents an integer that is 1 or higher,
each R² independently represents a hydrocarbon group,
each L independently represents a hydrolyzable group, a group having a hydrolyzable group, or a hydroxy group, and
each n independently represents an integer from 0 to 2.

<11> The composition according to <10>, wherein:
q1 in formula (C) represents an integer from 1 to 4, and
each q1 in formula (D) independently represents an integer from 1 to 4.

<12> The composition according to any one of <1> to <10>, further containing a liquid medium.

<13> A surface treatment agent consisting of the composition according to any one of <1> to <12>.

<14> A method for producing an article, the method including: subjecting a substrate to surface treatment using the surface treatment agent according to <13>, to manufacture an article having the substrate and a surface treatment layer formed thereon.

<15> An article including: a substrate; and a surface treatment layer disposed on the substrate and having been surface-treated using the surface treatment agent according to <13>.

<16> The article according to <15>, wherein the article is an optical component.

<17> The article according to <15>, wherein the article is a display or a touch panel.

The disclosure of Japanese Patent Application No. 2023-174761 filed on Oct. 6, 2023, is incorporated herein by reference in its entirety. All documents, patent applications, and technical standards described in this specification are incorporated herein by reference to the same extent as if each document, patent application, and technical standard were specifically and individually indicated to be incorporated by reference.

What is claimed is:

1. A composition, comprising:
a compound having a chain group and a reactive silyl group; and
a metal atom,
wherein an amount of the metal atom is from 10 to 10,000 ppm by mass with respect to an amount of the compound having a chain group and a reactive silyl group.

2. The composition according to claim 1, wherein the compound having a chain group and a reactive silyl group is a compound having a chain organo(poly)siloxane residue and a reactive silyl group.

3. The composition according to claim 1, comprising two or more kinds of the metal atom.

4. The composition according to claim 1, wherein the metal atom comprises Pt and a metal atom other than Pt.

5. The composition according to claim 1, wherein the metal atom comprises a transition metal.

6. The composition according to claim 1, wherein the metal atom comprises at least one selected from the group consisting of Al, Ti, V, Cr, Mn, Fe, Co, Ni, Zr, Nb, Mo, Ru, Rh, Pd, Sn, Hf, Ta, W, Ir, Pt, Zn, and Cu.

7. The composition according to claim 1, wherein the metal atom comprises at least one selected from the group consisting of Ti, Cr, Mn, Fe, Co, Ni, Zr, Ru, Rh, Pd, Ir, Pt, Zn, and Cu.

8. The composition according to claim 1, wherein the reactive silyl group is represented by the following formula (S1) or (S3): 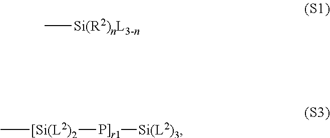
wherein, in formula (S1),
each R² independently represents a hydrocarbon group,
each L independently represents a hydrolyzable group, a group having a hydrolyzable group, or a hydroxy group, and
n represents an integer from 0 to 2; and
wherein, in formula (S3),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms, and
r1 represents an integer from 1 to 3.

9. The composition according to claim 2, wherein the chain organo(poly)siloxane residue is represented by the following formula (B1) or (B2): 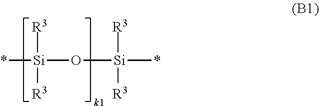
wherein, in formula (B1),
each R³ independently represents a hydrocarbon group,
k1 represents a number that is 1 or higher,
* indicates a bonding site with an adjacent atom: 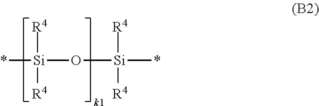
wherein, in formula (B2),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher, and
* indicates a bonding site with an adjacent atom.

10. The composition according to claim 9, wherein k1 in formulae (B1) and (B2) represents an integer from 1 to 600.

11. The composition according to claim 1, wherein the compound having a chain group and a reactive silyl group is represented by the following formula (C), (C2), (D), (D2), (E), or (E2): 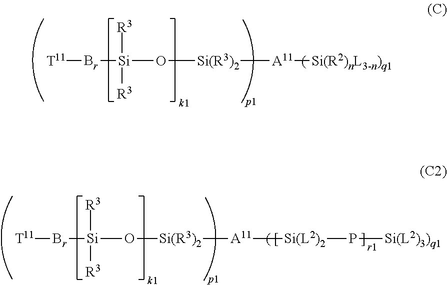
wherein, in formula (C),
T¹¹ represents a monovalent group free of a reactive silyl group,
each B independently represents —O— or —C(═O)—,
each r independently represents 0 or 1,
each R³ independently represents a hydrocarbon group,
each k1 independently represents a number that is 1 or higher,
p1 represents an integer that is 1 or higher,
A¹¹ represents a (p1+q1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2; and
wherein, in formula (C2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
r1 represents an integer from 1 to 3,
T¹¹, B, r, R³, k1, p1, A¹¹, and q1 are as defined in formula (C): 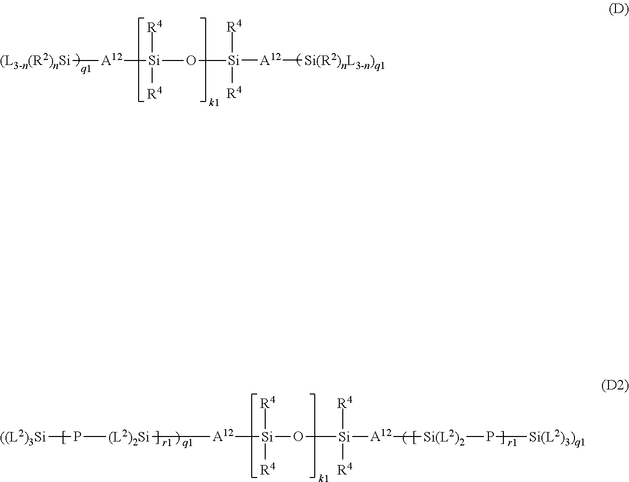
wherein, in formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number that is 1 or higher,
each A¹² independently represents a (q1+1)-valent linking group,
each q1 independently represents an integer that is 1 or higher,
each R² independently represents a hydrocarbon group,
each L independently represents a hydrolyzable group, a group having a hydrolyzable group, or a hydroxy group, and
each n independently represents an integer from 0 to 2; and
wherein, in formula (D2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
each r1 independently represents an integer from 1 to 3, and
R⁴, k1, A¹², and q1 are as defined in formula (D): 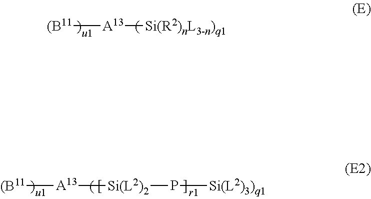
wherein, in formula (E),
B¹¹ represents a monovalent group having at least one selected from the group consisting of Si, Ge, and Sn to which a hydroxy group or a hydrolyzable group is not directly bonded, or a monovalent group having a branched alkyl group,
u1 represents an integer that is 1 or higher,
A¹³ represents a (q1+u1)-valent linking group,
q1 represents an integer that is 1 or higher,
each R² independently represents a hydrocarbon group,
each L independently represents a hydrolyzable group, a group having a hydrolyzable group, or a hydroxy group, and
each n independently represents an integer from 0 to 2; and
wherein, in formula (E2),
each L² independently represents a hydrolyzable group, a group having a hydrolyzable group, a hydroxy group, or a hydrocarbon group,
at least four instances of L² among all L²s represent a hydrolyzable group, a group having a hydrolyzable group, or a hydroxy group,
each P independently represents an oxygen atom, or an organic group having one carbon atom bonded to both adjacent Si atoms,
each r1 independently represents an integer from 1 to 3, and
B¹¹, u1, A¹³, and q1 are as defined in formula (E).

12. The composition according to claim 11, wherein:
q1 in formulae (C), (C2), (E), and (E2) represents an integer from 1 to 4, and
each q1 in formulae (D) and (D2) independently represents an integer from 1 to 4.

13. The composition of claim 1, further comprising a liquid medium.

14. A surface treatment agent, consisting of the composition according to claim 1.

15. A method for producing an article, the method comprising: subjecting a substrate to surface treatment using the surface treatment agent according to claim 14, to manufacture an article having the substrate and a surface treatment layer formed thereon.

16. An article, comprising: a substrate; and a surface treatment layer disposed on the substrate and having been surface-treated using the surface treatment agent according to claim 14.

17. The article of claim 16, wherein the article is an optical component.

18. The article according to claim 16, wherein the article is a display or a touch panel.
